(19) United States
(12) Patent Application Publication
(10) Pub. No.: US 2005/0177408 A1
(43) Pub. Date: Aug. 11, 2005

(54) Skill-ranking method and system for employment applicants

(76) Inventor: Ronald Jay Miller, Marietta, GA (US)

Correspondence Address: GARDNER GROFF, P.C., 2018 POWERS FERRY ROAD, SUITE 800, ATLANTA, GA, 30339, US

(21) Appl. No.: 11/102,333

(22) Filed: Apr. 8, 2005

Related U.S. Application Data
(63) Continuation-in-part of application No. 10/139,574, filed on May 6, 2002.
(60) Provisional application No. 60/289,151, filed on May 7, 2001.

(51) Int. Cl. G06F 17/60

(52) U.S. Cl. 705/8

(57) ABSTRACT

A system and method for matching applicants to job openings. Applicants may apply for posted positions and employers may screen applicants based on various prescribed qualifications. Applicants may be tested using standard or employer-provided test questions. The system and method are suitable for implementation using one or more programmed computers and/or a computer network such as the Internet. Mandatory and secondary skill sets can be input by both the applicant and the employer, and applicants can be ranked by order of qualification based on those skill sets.

### CROSS-REFERENCE TO RELATED APPLICATION

This application is a continuation-in-part of U.S. Non-Provisional patent application Ser. No. 10/139,574 filed May 6, 2002, which claims the benefit of U.S. Provisional Patent Application Ser. No. 60/289,151 filed May 7, 2001. U.S. Non-Provisional patent application Ser. No. 10/139,574 and U.S. Provisional Patent Application Ser. No. 60/289,151 are hereby incorporated herein by reference in their entireties for all purposes.

### FIELD OF THE INVENTION

The present invention relates generally to matching qualified job-hunters to available job openings, and more particularly to a computer network implemented system and method for matching applicants to job openings.

### BACKGROUND OF THE INVENTION

Employers seeking to fill vacant jobs use various resources to find the best-qualified employees. For example, “help-wanted” ads in newspapers, employment agencies, Internet job-postings, and the like are widespread. Job hunters looking for employment use similar resources. Many times, however, the employer is inundated with too many applicants to effectively screen for the best-qualified candidate, and/or the potential employee is unable to effectively communicate their qualifications using standard job applications and resumes.

In addition, certain employers may have special hiring requirements for certain positions. For example, an employer may want to give preferences to existing employees over outside applicants. Other employers may have policies or be under legal directives to preferentially hire employees who have certain characteristics or are members of certain groups, such as military veterans, minorities, college graduates, foreign language fluency, and the like. The employer may or may not wish to consider applicants lacking certain specified qualifications for a position, and/or may wish to maintain records confirming their compliance with their policies or directives.

Previously known resources for matching applicants to available jobs have not proven fully adequate for various needs of job applicants and hiring employers. Thus, it can be seen that needs exist for an improved method and system for matching applicants to job openings.

### SUMMARY OF THE INVENTION

The present invention provides an improved method and system for matching applicants to job openings. In example embodiments of the present invention, the system and method are computer implemented, and are carried out using one or more computers connected to a computer network such as the Internet.

In one aspect, the invention is a method of matching an applicant to a job opening. The method preferably includes the steps of receiving information from an employer regarding a job opening, the information including mandatory and secondary skills relevant to the job opening; receiving data from an applicant including applicant qualifications; comparing the mandatory and secondary skills relevant to the job opening with the applicant qualifications; and ranking the applicant based on the comparison of the mandatory and secondary skills relevant to the job opening with the applicant qualifications.

In another aspect, the invention is a method of matching an applicant to a job opening, the method including the steps of: receiving information from an employer regarding a job opening, and posting that information on a computer network; providing the employer the option to become a member employer; and allowing an applicant to apply for the job opening via the computer network.

In still another aspect, the invention is a method of matching an applicant to a job opening, the method including: receiving data from an applicant including applicant qualifications; providing the applicant the option of becoming a hosting applicant; and making the applicant qualifications available to an employer via a communications network.

In other aspects, the invention is a system for matching an applicant to a job opening. In an embodiment of the invention, the system includes at least one computer for implementing one or more of the above methods. In another embodiment, the system includes a plurality of computers connected by a communications network, for example the Internet or other global computer network, for implementing one or more of the above methods. In still other aspects, the invention is a website for implementing one or more of the above methods; computer software for carrying out one or more of the above methods; and/or computer-readable media comprising software for carrying out one or more of the above methods.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a flowchart schematically outlining a system and method for matching applicants to job openings according to a preferred embodiment of the present invention.

FIG. 2 is a flowchart schematically outlining a portion of the system and method of FIG. 1 in greater detail.

FIG. 3 is a flowchart schematically outlining a portion of the system and method of FIG. 1 in greater detail.

FIG. 4 is a flowchart schematically outlining a portion of the system and method of FIG. 1 in greater detail.

FIG. 5 is a flowchart schematically outlining a portion of the system and method of FIG. 1 in greater detail.

FIG. 6 is a flowchart schematically outlining a portion of the system and method of FIG. 1 in greater detail.

FIG. 7 is a flowchart schematically outlining a portion of the system and method of FIG. 6 in greater detail.

FIG. 8 is a flowchart schematically outlining a portion of the system and method of FIG. 6 in greater detail.

FIG. 9 is a flowchart schematically outlining a portion of the system and method of FIG. 6 in greater detail.

FIG. 10 is a flowchart schematically outlining a portion of the system and method of FIG. 9 in greater detail.

FIG. 11 is a flowchart schematically outlining a portion of the system and method of FIG. 9 in greater detail.

FIG. 12 is a flowchart schematically outlining a portion of the system and method of FIG. 9 in greater detail.

FIG. 13 is a flowchart schematically outlining a portion of the system and method of FIG. 1 in greater detail.

FIG. 14 is a flowchart schematically outlining a portion of the system and method of FIG. 1 in greater detail.

FIG. 15 is a flowchart schematically outlining a portion of the system and method of FIG. 1 in greater detail.

FIG. 16 is a flowchart schematically outlining a portion of the system and method of FIG. 1 in greater detail.

FIGS. 17a-17l show screen displays according to a portion of a system and method for matching applicants to job openings according to a preferred embodiment of the present invention.

FIGS. 18a-18j show screen displays according to another portion of a system and method for matching applicants to job openings according to a preferred embodiment of the present invention.

FIGS. 19a-19k show screen displays according to another portion of a system and method for matching applicants to job openings according to a preferred embodiment of the present invention.

FIG. 20 shows a screen display according to another portion of a system and method for matching applicants to job openings according to a preferred embodiment of the present invention.

FIGS. 21a-21c show screen displays according to another portion of a system and method for matching applicants to job openings according to a preferred embodiment of the present invention.

FIGS. 22a-22b show screen displays according to another portion of a system and method for matching applicants to job openings according to a preferred embodiment of the present invention.

FIGS. 23a-23b show screen displays according to another portion of a system and method for matching applicants to job openings according to a preferred embodiment of the present invention.

FIG. 24 shows a screen display according to another portion of a system and method for matching applicants to job openings according to a preferred embodiment of the present invention.

FIGS. 25a-25d show screen displays according to another portion of a system and method for matching applicants to job openings according to a preferred embodiment of the present invention.

FIGS. 26a-26b show screen displays according to another portion of a system and method for matching applicants to job openings according to a preferred embodiment of the present invention.

FIG. 27 shows a screen display according to another portion of a system and method for matching applicants to job openings according to a preferred embodiment of the present invention.

FIG. 28 shows a screen display according to another portion of a system and method for matching applicants to job openings according to a preferred embodiment of the present invention.

FIGS. 29a-29j show screen displays according to another portion of a system and method for matching applicants to job openings according to a preferred embodiment of the present invention.

FIGS. 30a-30c show screen displays according to another portion of a system and method for matching applicants to job openings according to a preferred embodiment of the present invention.

FIG. 31 shows a screen display for identifying pertinent skills to be included with resume and cover letter files according to an example embodiment of the system and method of the present invention.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the singular and the plural, and a specified numerical value or quantity includes at least that numerical value or quantity, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

In one embodiment, the present invention is a method for matching applicants to job openings. The method is readily adapted to implementation using at least one general and/or specific purpose computer(s). In another embodiment, the present invention is a system for matching applicants to job openings. The system preferably includes at least one general and/or specific purpose computer(s) programmed to carry out the method described herein. In still another embodiment, the invention is software for carrying out the method described herein using one or more general and/or specific purpose computer(s). And in yet another embodiment, the invention is computer-readable media containing software for carrying out the method described herein using one or more general and/or specific purpose computer(s).

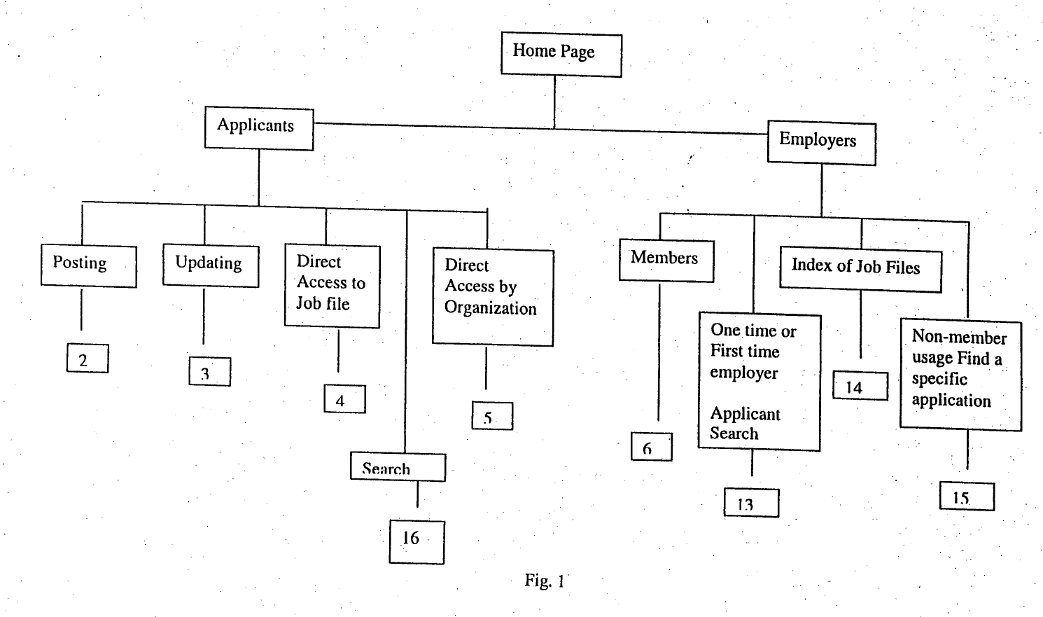

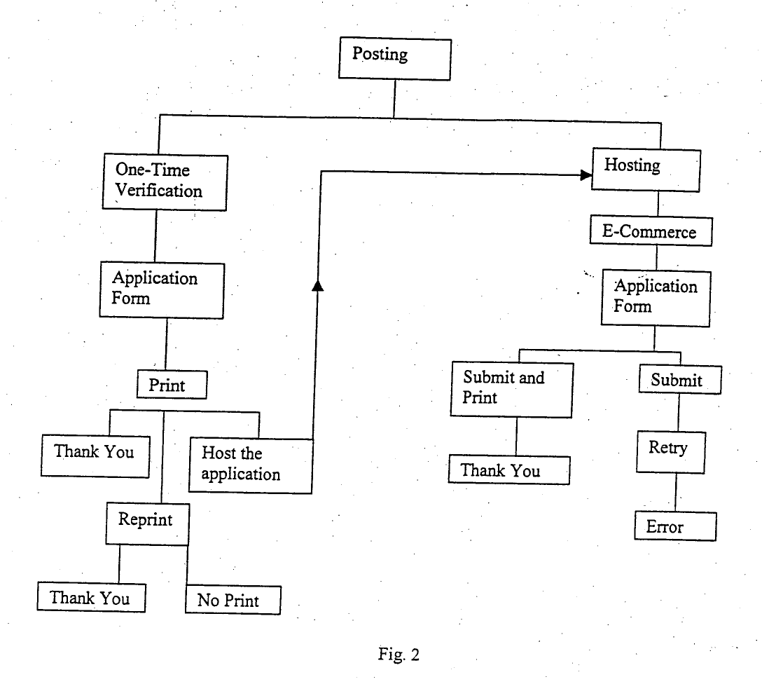

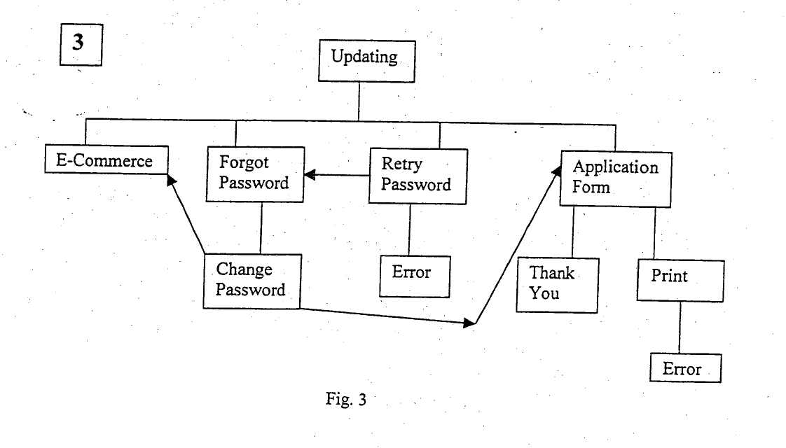

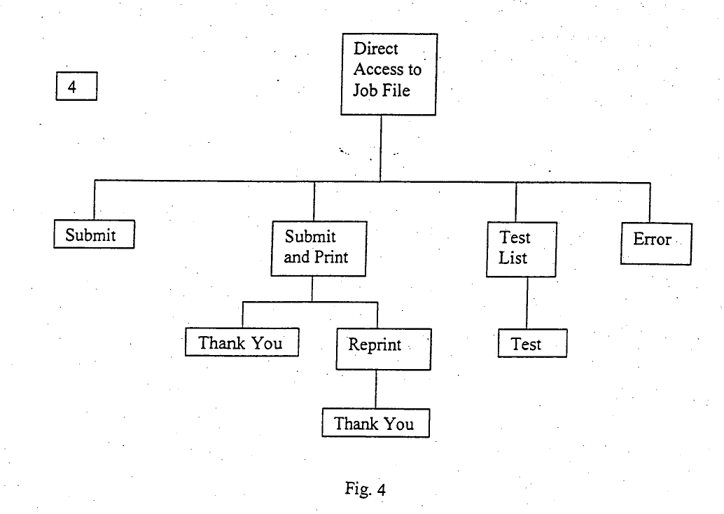

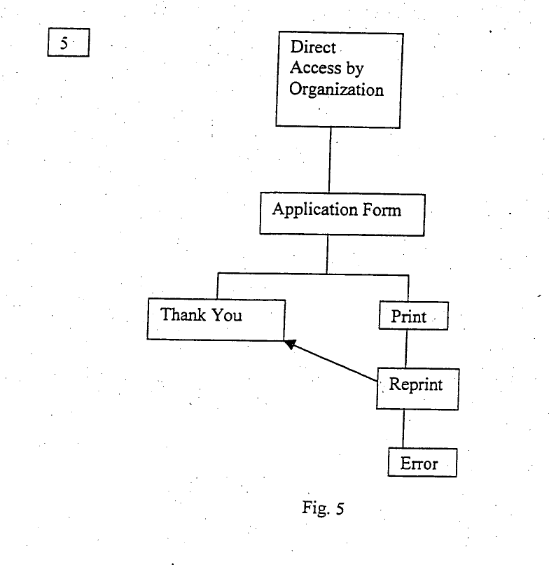

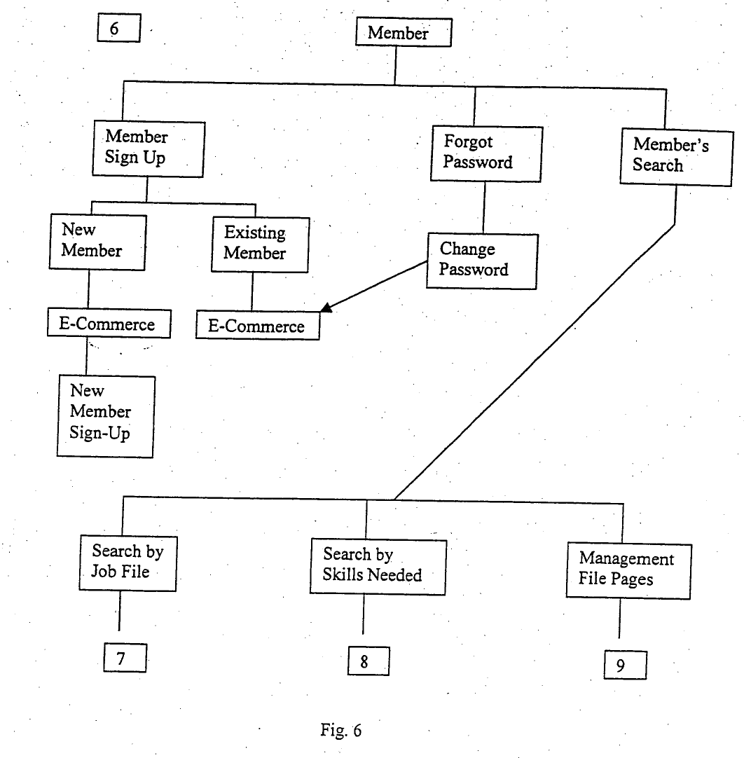

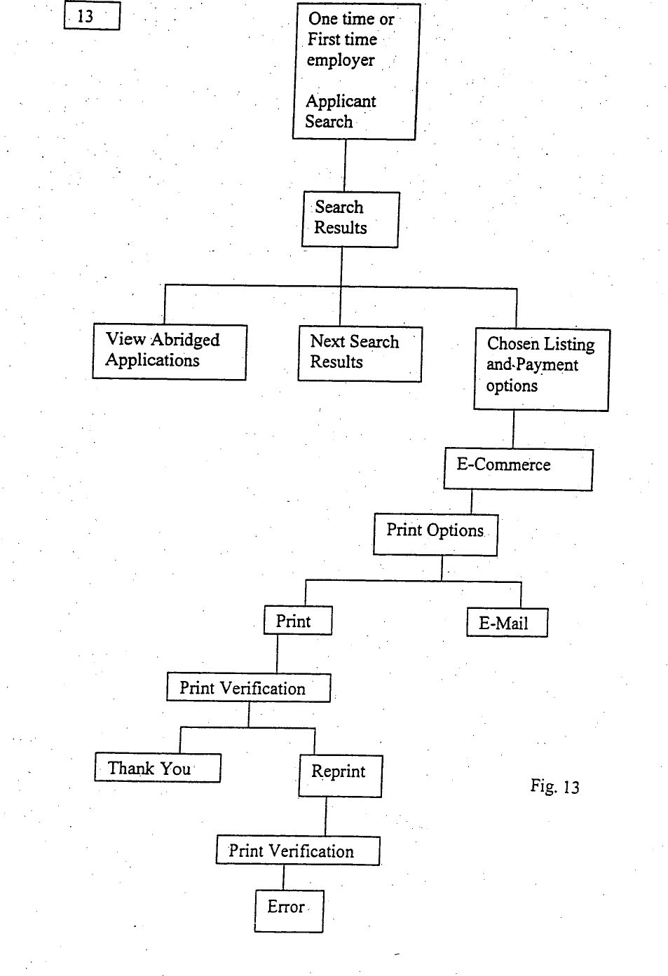

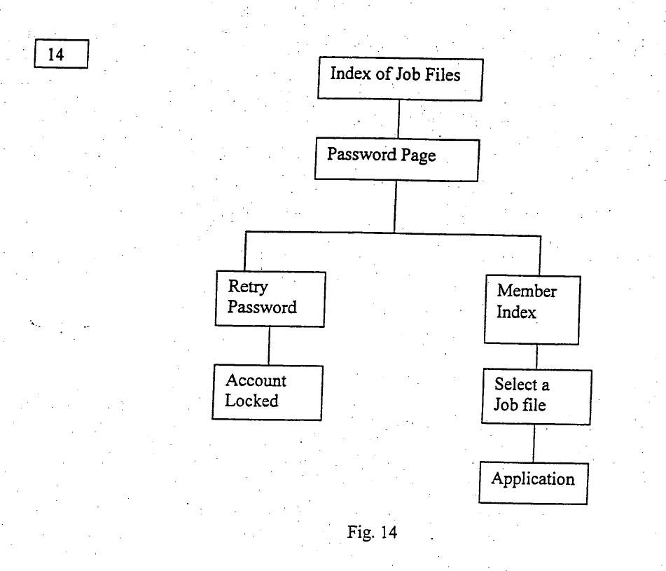

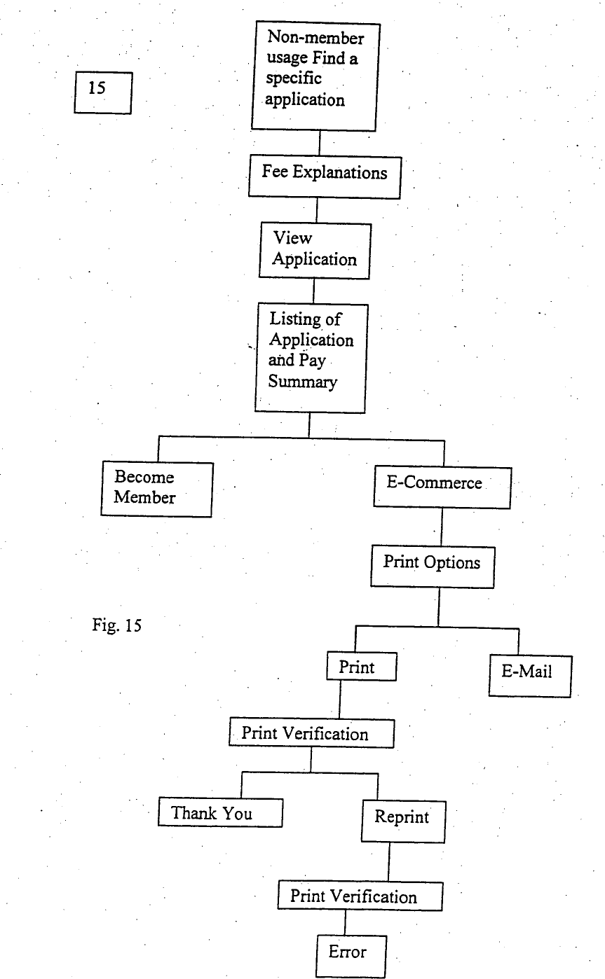

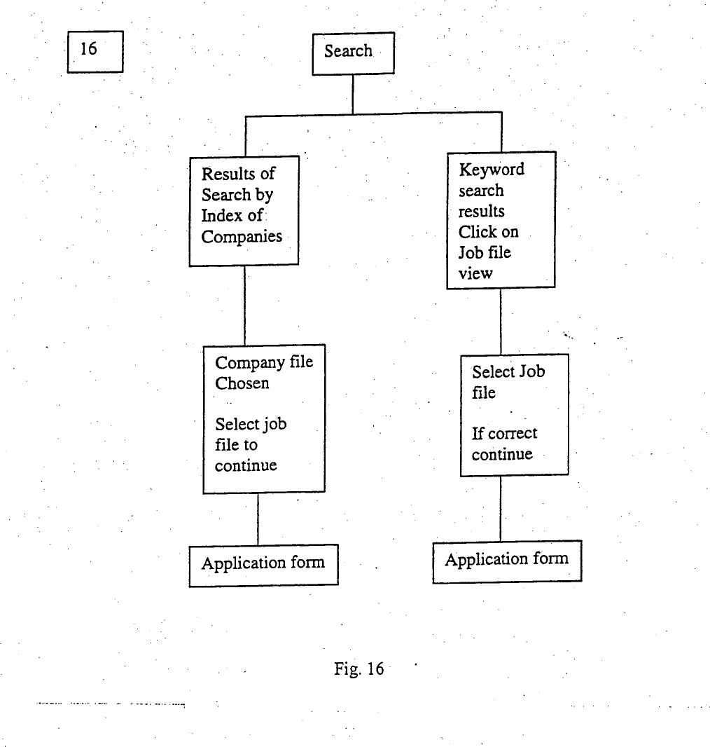

According to an embodiment of the invention, a party (for example, a job applicant, a hiring employer, or an owner/administrator of the system) utilizes the system and method of the present invention via a computer, such as a general-purpose personal computer. Software for implementing the method and system of the present invention may reside on the computer used by the party, and/or the software may reside on a separate computer that is linked to the party's computer via a network such as the Internet. A home page or initial query typically directs or links the party to subsequent pages or queries appropriate to the party's desired activity. For example, and with reference to FIG. 1, a job applicant or a hiring employer preferably accesses the system via a home page maintained by an owner/administrator or by the employer. Options made available to an applicant preferably include posting (see FIG. 2 and discussion below), updating (see FIG. 3 and discussion below), direct access to a job file (see FIG. 4 and discussion below), direct access by organization (see FIG. 5 and discussion below), and searching (see FIG. 16 and discussion below). Options made available to a hiring employer preferably include membership application or verification (see FIG. 6 and discussion below), one-time or first-time applicant search (see FIG. 13 and discussion below), member index access (see FIG. 14 and discussion below), and non-member usage (see FIG. 15 and discussion below).

With reference now to FIG. 2, an applicant preferably fills out an employment application form to be posted. In a typical search, the Applicant fills out the application with information that preferably includes: personal information, education, employment experience and descriptions of duties. In addition, the applicant must make out a list of skills, which, he or she, believe make himself or herself marketable to employers. The applicant preferably may print out a single copy of the application form. Notification will preferably be provided in the instructions that the applicant's information will be maintained on the system for a designated period to disqualify the person from filling out another application. Options to become a hosting applicant preferably will be available. An applicant can choose to have an application hosted and preferably pays for the service. User name and password information are preferably filled out, payment for the service is made, and an identification number is assigned. The application is filled out. Preferably included in the application is a listing to be made by the applicant of skills, which will be used to seek out his or her application by employers. These are the skills that the applicant believes will make him or her the most marketable to employers. The applicant will preferably have an option to access an additional information box to enter data related to fields considered discriminating and illegal for most searches. This data will allow the applicant to have his or her applications available for special searches, which are directed by a legal authority, to seek applicants with any or some of the discriminating qualifications. This data will preferably never be allowed to be viewed by any employer, even after the special searches.

With reference now to FIG. 3, a hosting applicant preferably may update his or her application data at anytime. When entering the secured area the username and password preferably allow access to his or her application. By scrolling down or clicking on the bookmarks at the top or bottom of the page, he or she may jump to an area for editing.

The applicant may receive an automatic e-mail to inform him or her that the time period is almost up for the hosting of the application and an update may be needed. The applicant then goes to the payment pages and reactivates his file and can update it.

With reference now to FIG. 4, an employer may direct an applicant to the site to fill out an application. The applicant preferably enters a job file number and an application appears. The Applicant fills out the application. The application preferably includes: personal information, education, employment experience and descriptions of duties. In addition, the applicant must make out a list of skills, which, he or she feels make himself or herself marketable to employers. Or, if the applicant is a hosting member, he or she may enter his or her identification number on the application form to have the application information placed on the form. Upon completion of the form, clicking the submit button will check the job file for additional questions and/or any test to be administered to the applicant. If a test is associated with the job file, the test preferably must be taken by the applicant before the application may be submitted.

With reference now to FIG. 5, organizations preferably can authorize anyone to access the application form with an access number. The access number can be set up to allow departmental designations as well as a general designation to allow counters to keep up with the applications. Applicants preferably will be allowed to fill out the application and host it on the service for a period of one year or other specified period. At the end of each payment period, an e-mail is preferably sent to the applicant, advising them to get a new access number and/or to pay for continued hosting. The organization preferably will have the ability to access all applications, which it authorizes. Sorts can be done by in a multitude of ways including alphabetical and by department. An organization may also limit the use of the application for internal use only.

Hiring employers preferably access the homepage, and may access membership information as shown in FIG. 6. New members can sign up for the service. Existing members can access their data and change passwords, and/or conduct applicant searches as described below.

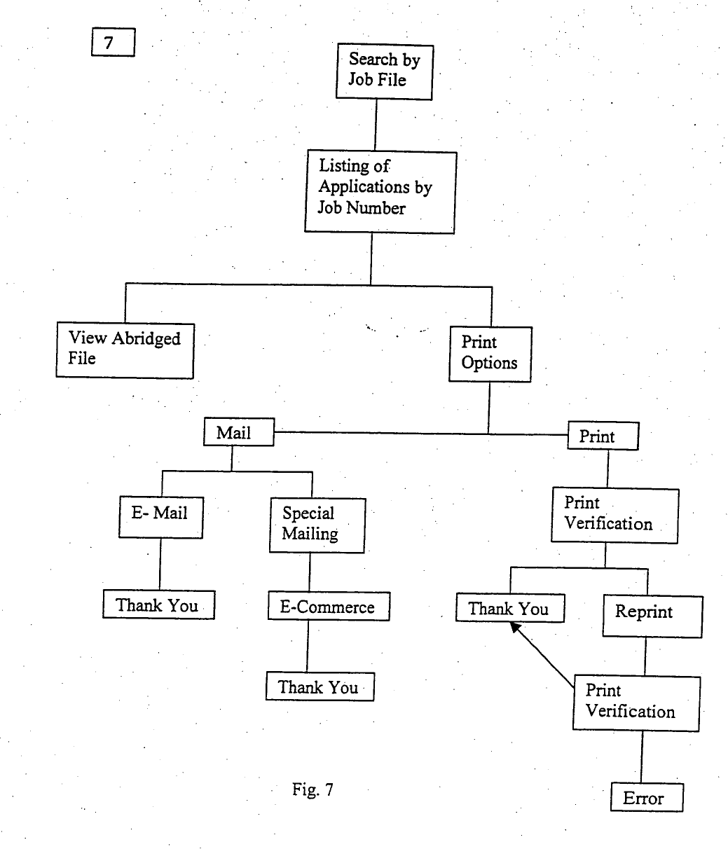

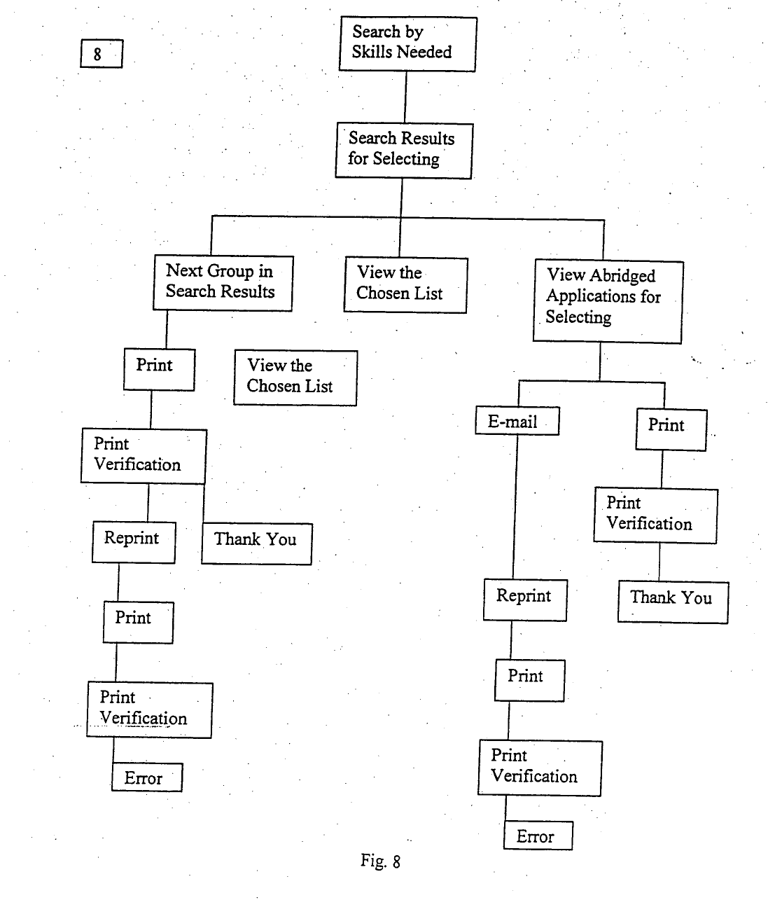

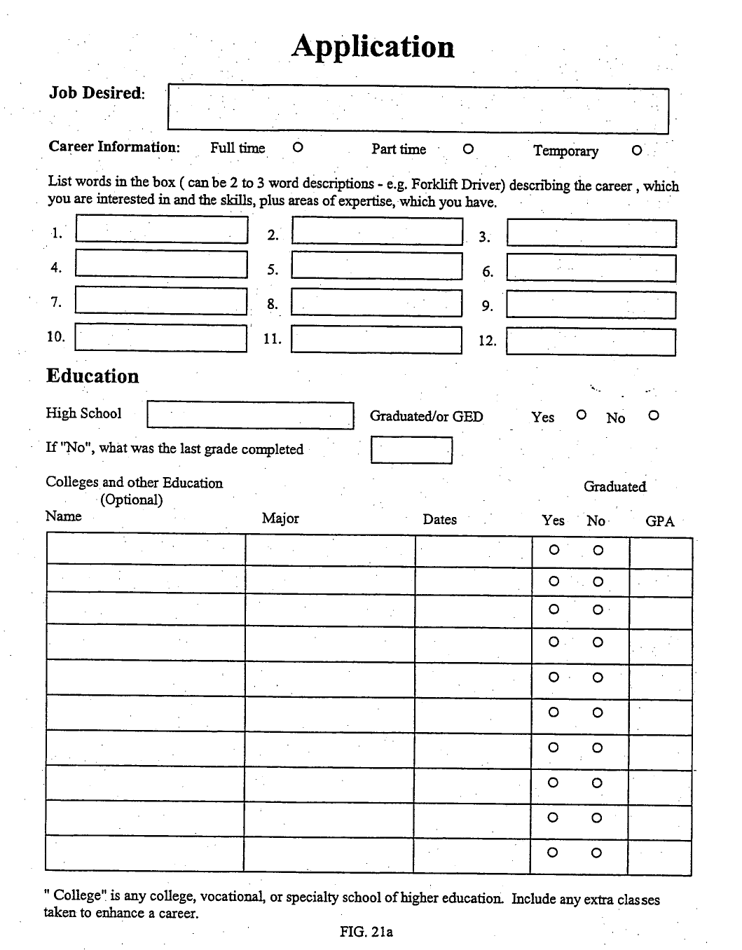

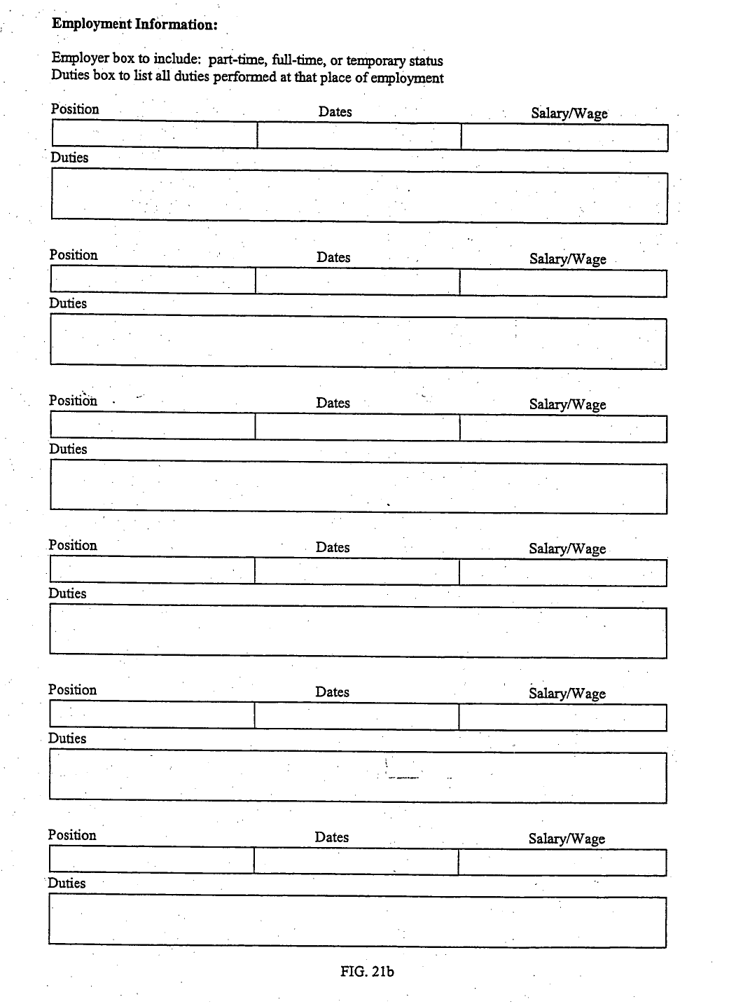

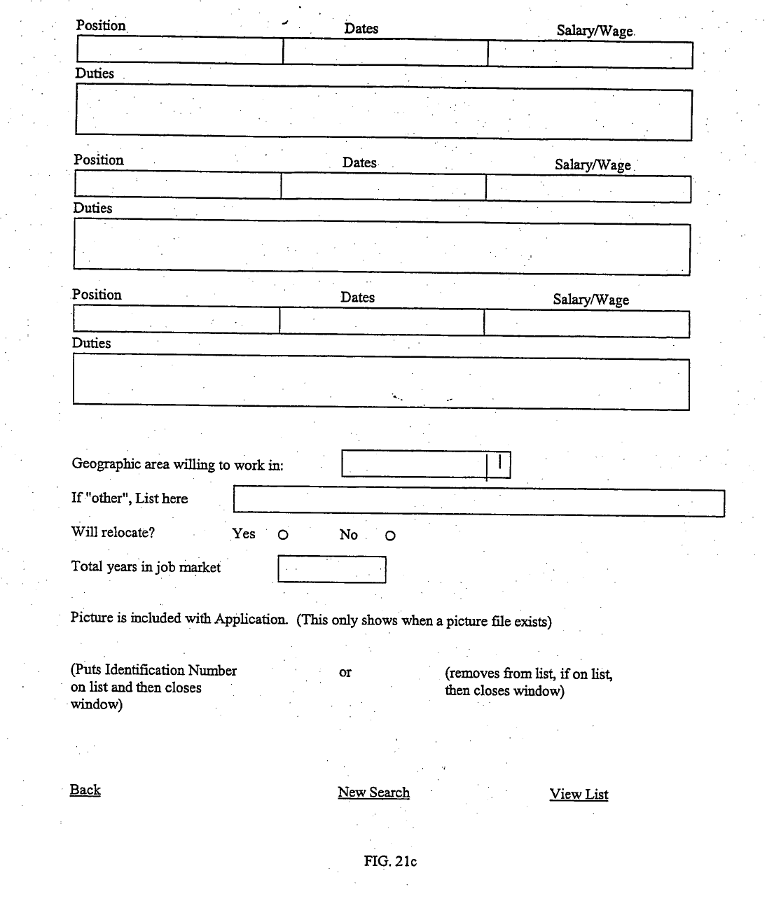

For example, member employers can search for applicants by job file (FIG. 7), or by requisite skills (FIG. 8). To seek out all applicants who applied for a particular job file, an employer may insert job file numbers in the fields marked “Job File Number”. The owner determines the number of job files, which can be searched for at one time. The model, displayed with this program preferably gives a maximum of applications from 10 job files, which can be retrieved. The job files will preferably be placed in the order of the job files listed. A summary page preferably appears with a listing of the applications. The numerical listing preferably is from 1 to the last application. If the employer would like to review the applications prior to printing, they will preferably be shown in the abridged format. (See form E, FIGS. 21a-21c). The member preferably has the opportunity to delete any application, after reviewing or may choose to input a number in the “Total Number of Applications chosen” field, which will count from the first number until the input number is reached. This procedure can preferably be done for each job file chosen. If the employer wants to print the applications from the job file, the print application buttons preferably must be activated. If all the applications are removed from the job file window, no applications will be printed. This procedure preferably will not erase the applications from the job file. Preferably only the administrator for a job file can erase applications from his/her job files, or the first level administrators may delete applications. The deletion process preferably happens in the Management pages of the program and not in this area.

Once all print buttons of all job files chosen are activated, the member preferably proceeds to the print option page. The member preferably will be able to choose to have the applications e-mailed or printed. If the choice is to e-mail the applications, the member may send the applications to the same or different e-mail addresses. Preferably, for an additional fee, hard copies can be mailed to any addresses inputted on the Print Hardcopy section below the e-mail addresses.

If the print applications button is activated, the applications will preferably print to the member's designated printer. Print verification and exit procedures follow the printing. If there is an error in the printing and reprinting does not allow the correct printing, the error page preferably appears. The member preferably writes the activity number and contacts customer service or may send the activity number to customer service by e-mail. Customer service will handle any problems. The member then exits.

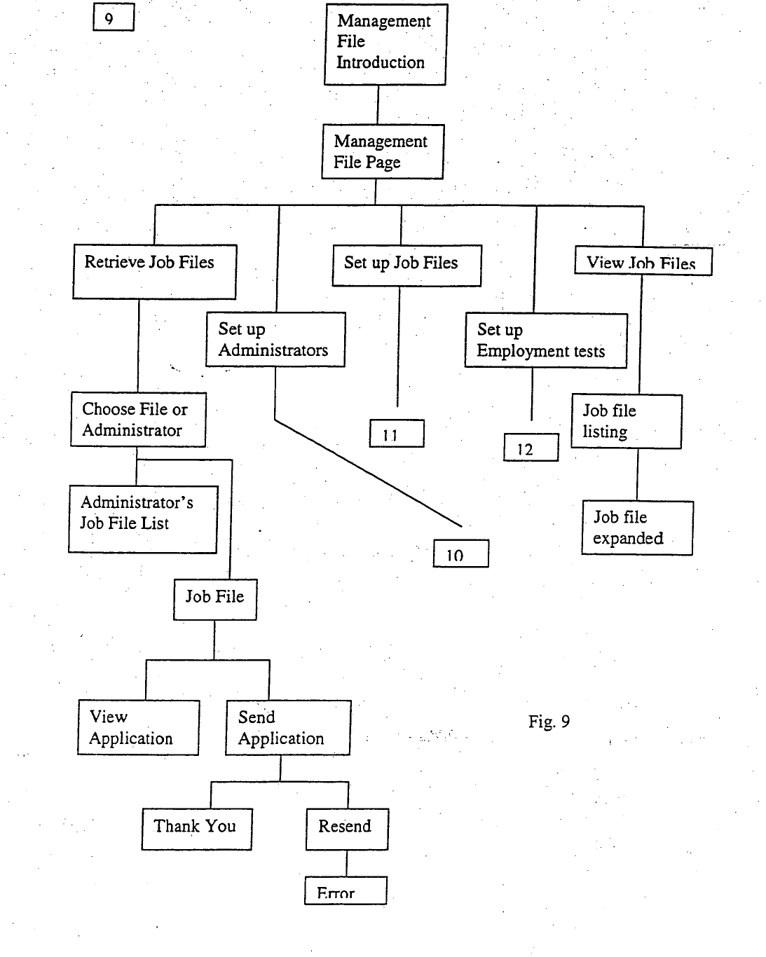

With reference now to FIG. 9, from the member's page, an employer administrator can preferably access the Management Page. This is preferably accomplished by clicking on the “Open Management Page” and entering the correct username and password. The Management Page preferably has a brief description of the types of administrators and links to the following Management functions: Retrieve Job Files, View Job Files, Set up Administrators, Set up Job Files, and, Set up Tests.

By clicking on the Retrieve Job Files link, the administrator preferably goes to a page with a scrolling box with the listing of administrators and a scrolling box with the listing of job files. Level One administrators can select an administrator and see their job files in the scrolling box. By clicking on the job file, a count of the applications in the file are listed. The administrator preferably will be able to review the applications and send the job file to the correct level two administrator. These administrators preferably can also view, in an abridged format (see form E, FIGS. 21a-21c), or send job files. Level two administrators preferably can only review their own job files and retrieve the applications from it. Level two administrators preferably will be able to view, in the abridged format (See form E, FIGS. 21a-21c), or send the job files. The administrator preferably will be able to send one, selected job files, or all job files to their e-mail address or another e-mail address. The default will preferably be the administrator's address. If any problems occur, an activity number is issued and the file is saved for a customer service technician to aid in its printing and receiving. If all is correct, the administrator preferably is sent to a Thank you page and the job file is cleared.

The View Job File link preferably sends the administrator to a page with a scrolling box of all job files for that employer. A job file may be selected and viewed with a listing of how many applications are in the job file.

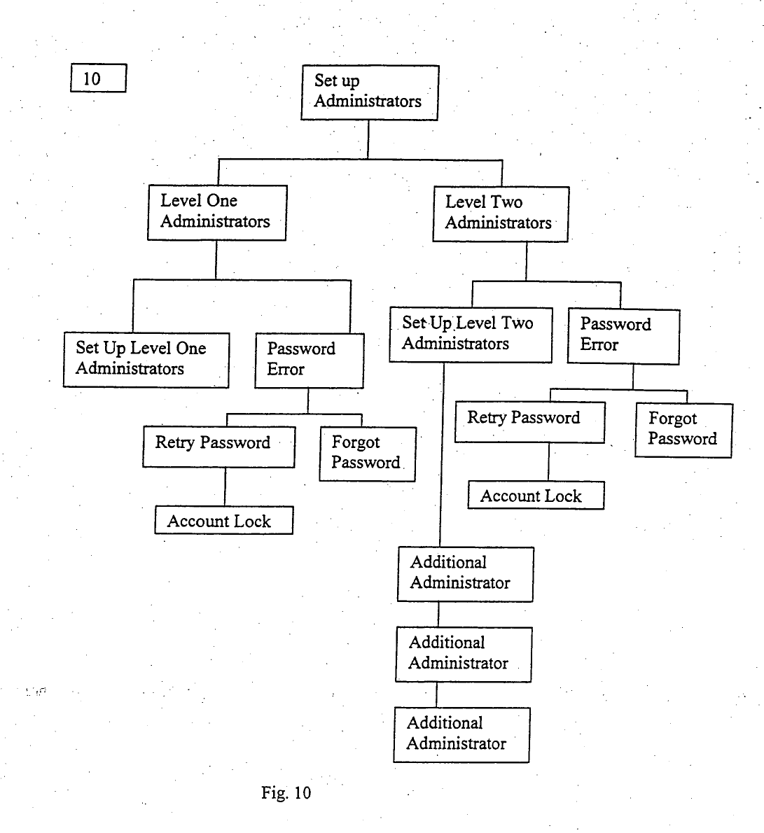

With reference now to FIG. 10, from the Management File page, the option to Set Up Administrator may be selected. The link preferably sends the administrator to the Set up Page. This page preferably has the description of the two types of administrators: Level One administrators and Level Two administrators. To set up Level One administrators, the link preferably is activated and a page to re-input the username and password appears to validate that a level one administrator is accessing this section. A correct username and password preferably will open a page with the ability to enter three administrators. These administrators will preferably have full access to all pages in the employer's files. Warnings on limiting the number of Level One administrators will preferably be shown on the page. If needed, a button can be activated to allow for additional Level One administrators. Once all are done, the administrator exits the section.

If the username or password is entered incorrectly twice, the administrator is preferably locked out and must contact the customer service representative to unlock the administrator and give a new password or username.

When selecting Level Two administrators to set up, the link goes to a username and password entry page to verify the set up. Preferably only Level One administrators can set up administrators. If the username and password are verified, the page to set up administrators preferably opens. The following information preferably must be set up: Name, Username, password, and e-mail address. Job files will preferably be listed here with counters, once they are set up. The program is preferably initially set up to allow up to 5 administrators to be added at a time. If additional administrators are needed, a button preferably will allow the addition of them in blocks of up to 5 administrators at a time.

With reference now to FIG. 14, the Index of Member link from the Employer's start up page preferably allows members to see who is a member of the service. This listing is preferably a full listing of all job files. This preferably is strictly a list and will not allow access to job files or application in the job files. To see the index, the employer preferably activates the link and goes to a username and password page. Once the information is verified, access is allowed. A scrolling box with bookmarks in the form of the alphanumeric letters preferably allows viewing of the job files listed in the service. The listing will preferably have the job description, city, and state where the job is located.

If the username and password is incorrect two times, the person preferably locked out and must reenter the program.

With reference now to FIG. 15, from the Employer starting page, the employer may input an application identification number to find a specific application. Non-members preferably can do this as well as members. If a non-member accesses this search, the Become a Member fee descriptions are preferably shown on the page with a continue button to link to the next page. The first page of the application will preferably show up. With the activating of the continue button, the non-member preferably goes to the page which will list the application and the payment requirement to get the application, or become a member. The guest book preferably is also required to get a printed copy. After payment for the application is made, the application can preferably be printed, or e-mailed. After verification of the print, the employer exits to the home page. If any problems occur, an activity number is issued and the file is saved for a customer service technician to aide in its printing and receiving. Members preferably do not need to pay to find a specific application.

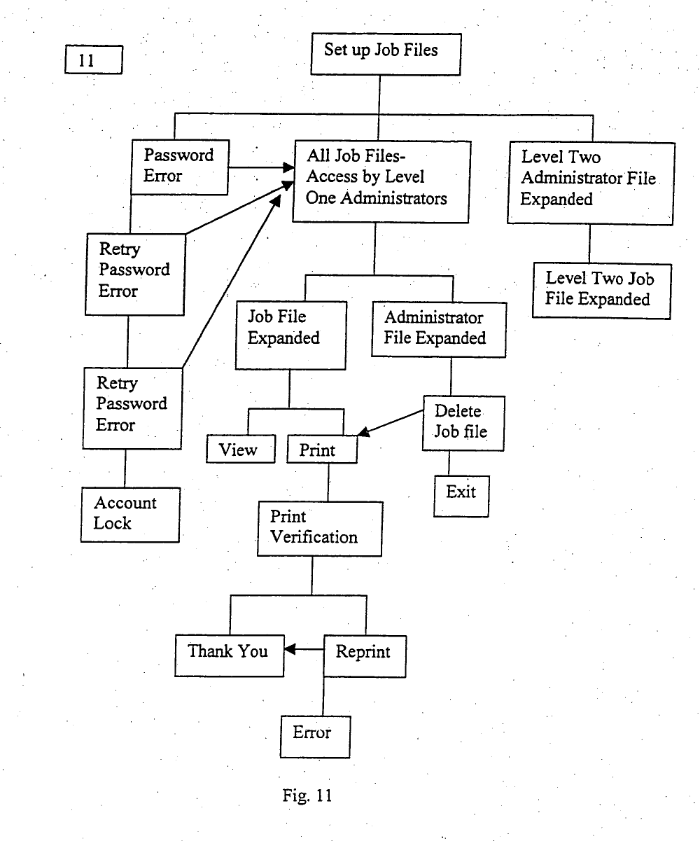

With reference to FIG. 11, the employer preferably has a job file filled out with all descriptive information, administrator for the job file, and indication if a test is associated with the job file. The employer preferably enters the job file number(s) and the files will be able to be printed or e-mailed to the appropriate administrator.

With reference to FIGS. 8 and 13, the Employer preferably makes a list of mandatory and secondary skills that are needed to do a job he or she is seeking employees for. Once the search button is activated, the qualified applications preferably will have a number associated with it in an order with the most mandatory and secondary skills first until the applications with only one secondary skill is placed in the queue. Applications preferably are available for viewing in groups of twenty. Employers can preferably view each application in an abridged format and select the candidates he or she wants. Or, the employer can place a number of applications which will be reviewed and have those automatically placed on the list for purchasing, if not a member; or have them sent to the correct administrator's file if a member.

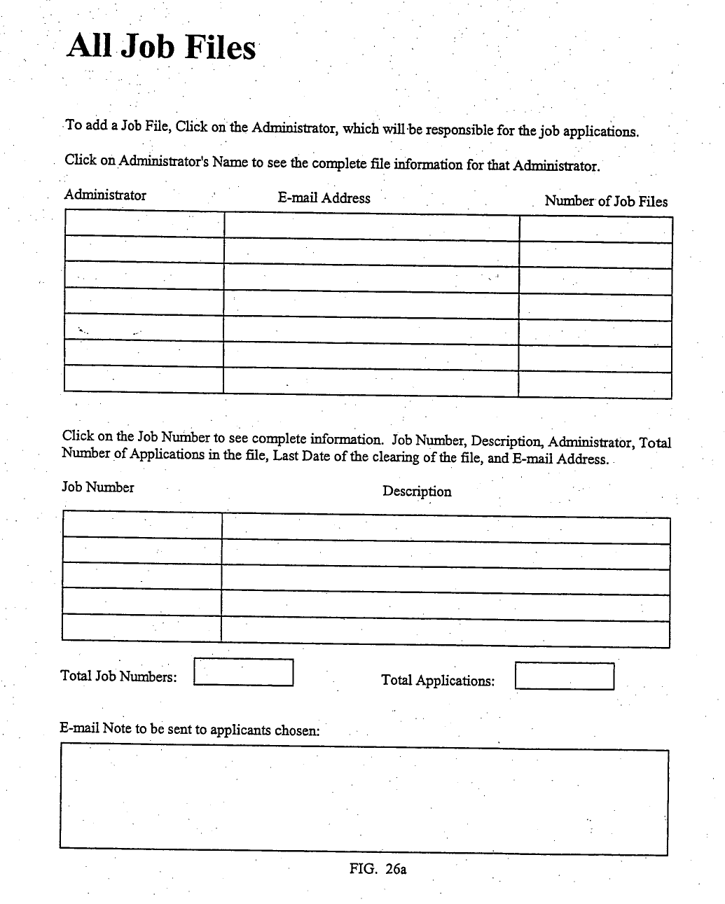

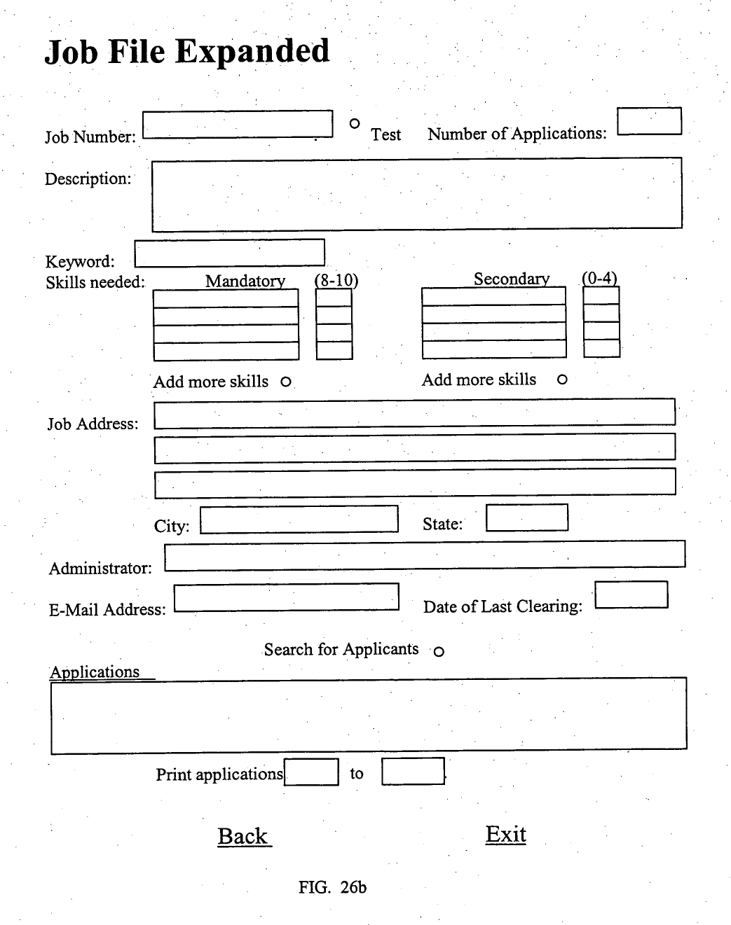

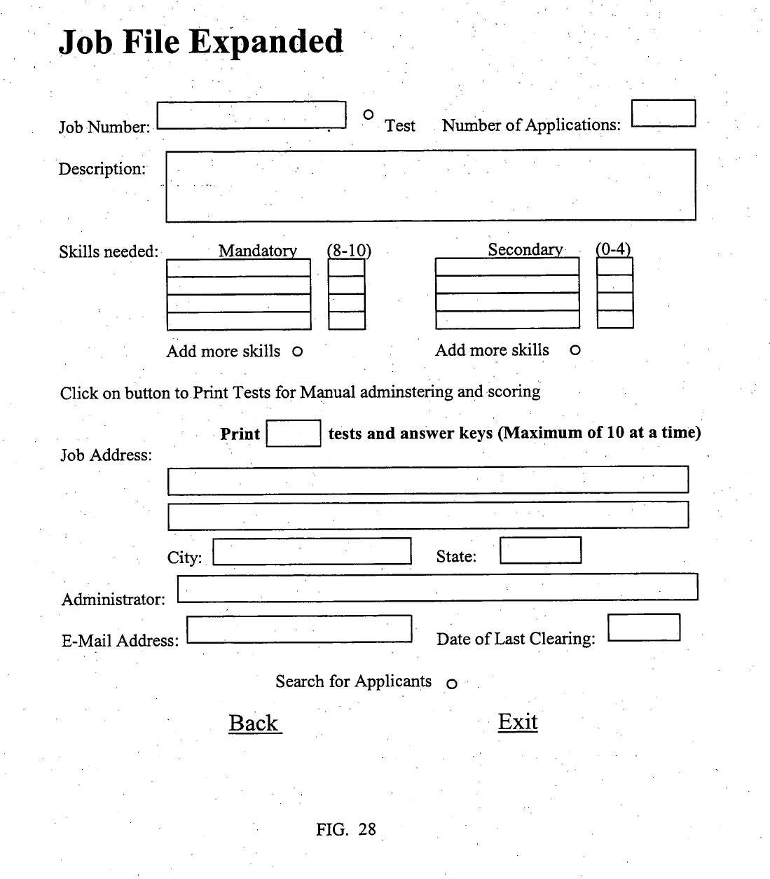

In particular example embodiments of the invention, candidates are screened based on a ranking of the correlation between their skills and those skills identified as “mandatory” and/or “secondary” by the employer for a specified position, using a numerical skills weighting system. For each mandatory skill set listed by the employer, a number rating will be used to quantify the skill set, enabling the employer to give more or less weight to each particular skill. Accordingly, each mandatory skill is given a numerical weighting falling within a mandatory skill weighting range, between a mandatory skill minimum weighting and a mandatory skill maximum weighting; and each secondary skill is given a numerical weighting falling within a secondary skill weighting range between a secondary skill minimum weighting and a secondary skill maximum weighting. Preferably, the mandatory skill minimum weighting is greater than the secondary skill maximum weighting, and optionally is at least twice the secondary skill maximum weighting. For example, in particular embodiments of the invention, the mandatory skills are rated from 8 to 10, with a weighting of “eight” being the least critical mandatory skill needed to perform the job (i.e., the “mandatory skill minimum weighting”) and “ten” being a most essential of the mandatory skills (i.e., the “mandatory skill maximum weighting”); and for each secondary skill set listed by the employer, a number rating of from 0 to 4 is used to weight the skills' criticality relative to the other secondary skills, “zero” being the least critical secondary skill needed to perform the job (i.e., the “secondary skill minimum weighting”) and “four” being a most essential of the secondary skills (i.e., the “secondary skill maximum weighting”). As shown in FIGS. 26b and 28, the employer preferably inputs the desired numerical weightings along with the specified mandatory and secondary skills, using the graphical user interface presented by the system of the present invention. Of course, it will be understood that the scope of the invention comprehends that different numerical ranges can be used for weighting specified skills within each set; and/or that fewer or more than two classifications of skill sets (i.e., “mandatory” and “secondary”) can be categorized.

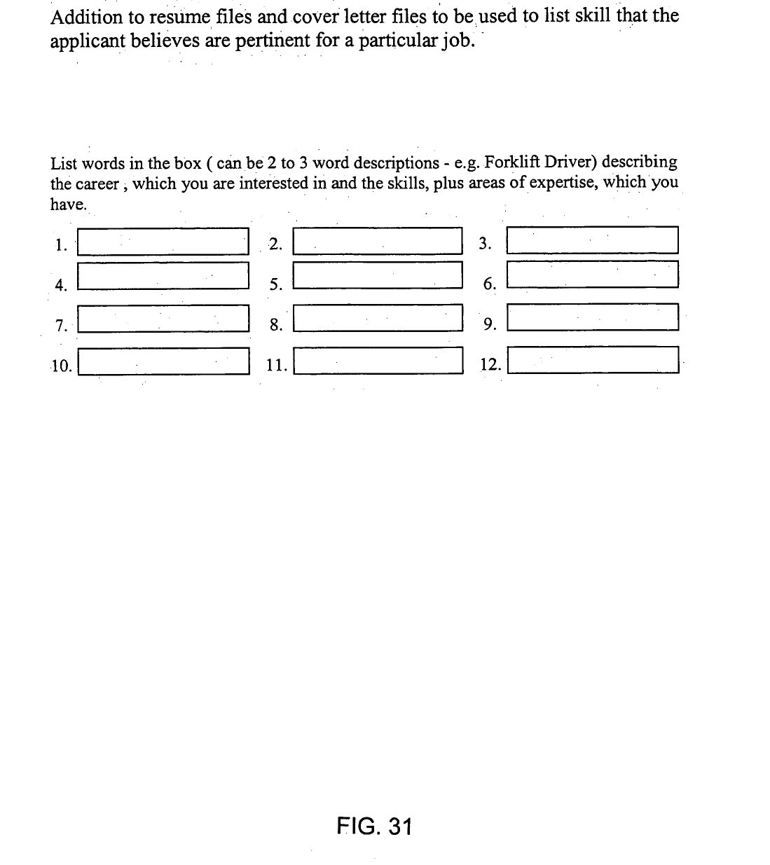

For non-member employer searching, a search form with options for at least 5 each of mandatory and secondary skills with rating boxes allows them to search database. Applicants can search for jobs using a rating system of their skills. They place some of their skills on a mandatory list and a secondary list. When the search is activated, job files are searched by the skills listed in the Job Files and the selections are ranked and listed by most to least mandatory and secondary skills. These quantified numbers are used to score the candidates. Mandatory skills are more valuable than secondary skills. The Program will also be able to activate a secondary search, based on the mandatory skills, only, of the employer to select the correct resume and cover letter for an applicant. Each resume and cover letter will have a skills listing which the applicant believes are associated with that resume, as shown for example by FIG. 31. From this list, matching of the mandatory skills needed will result in the best resume and best cover letter, for the job, to accompany the application.

Special Searches:

With reference to FIG. 8, in the event that an authorized and legal authority allows or mandates a company to use discriminating factors to find qualified candidates for positions in question, a special search can be called for. This is done, for example, by a legal directive or by an accepted request to a legally authorized organization on behalf of a company who is in question of being in non-compliance of the discrimination laws and/or Americans with Disabilities Act.

As shown on FIG. 15, the company preferably will fill out a search form with discriminating search elements. The search form preferably requires an authorization from a legally authorized organization such as an administrative agency (for example the EEOC) or a Judge (if in a lawsuit). A representative may need to oversee the search. Company preferably also fills out form with the skills desired to do the job. Skills can be designated as mandatory or secondary. The company preferably will have the option to search only employee participants or may include hosting applicants, who have voluntarily filled out the discriminating field in order to participate in these types of searches. Payment for this special search will preferably be done by a fee based system based on the number of applicants who fill out a form, preferably with a minimum fee to be paid prior to printing the listing or a per search fee if applicants from existing data base and based on the number of applications chosen.

As shown on FIG. 5, employees of the company may be directed to fill out applications to be used in the search. The discriminating information fields preferably will be made visible for the employees to fill out. They will preferably have the option not to participate. Ones who are participating will have their application available for the search.

With reference now to FIG. 13, the search results will show a numerical listing of the most qualified applicants. A viewing box with a numeric listing associated with the applications preferably appears. The employer preferably can view the application in an abridged format. Preferably, no personal information or names associated with the employment experience will show. The discriminating factors preferably will never show. The employer preferably can choose the application for printing and further review for an interview. Once a list is created of accepted applicants, the applications may be printed. The employer can option to place a number of applications to be printed and the list will begin at the most qualified until the number is reached. The application will then be printed. Payment for this special will preferably be done using a fee based system based on the number of applicants who fill out a form, with a minimum fee to be paid prior to printing the listing.

Applicant's Job File Search

With further reference now to FIG. 13, the applicant can activate the “Search Job Files” button on the “Applicant” page. The form preferably appears to have a keyword search for job files or the scrolling index box is searched for a particular company. If the scrolling box index is used, by clicking on the company name a look at the job files of that company appears in a list form. Further navigating will get the applicant to a particular job file at a particular location. Once the job file is selected, the file is clicked on and an application form appears for completion. If the applicant is a hosting member, he or she may enter his or her identification number on the application form to have the application information placed on the form, otherwise, the form must be filled out.

Testing

As shown on FIG. 11, the administrators can set up tests. A job file is preferably created with information about the job and the administrator. A button is activated to associate a test with the job file. If a test exists, another button will allow all questions in the bank of questions to be printed for review. If the test question evaluation button is activated, next to each question will be a percentage of correct answers to the question.

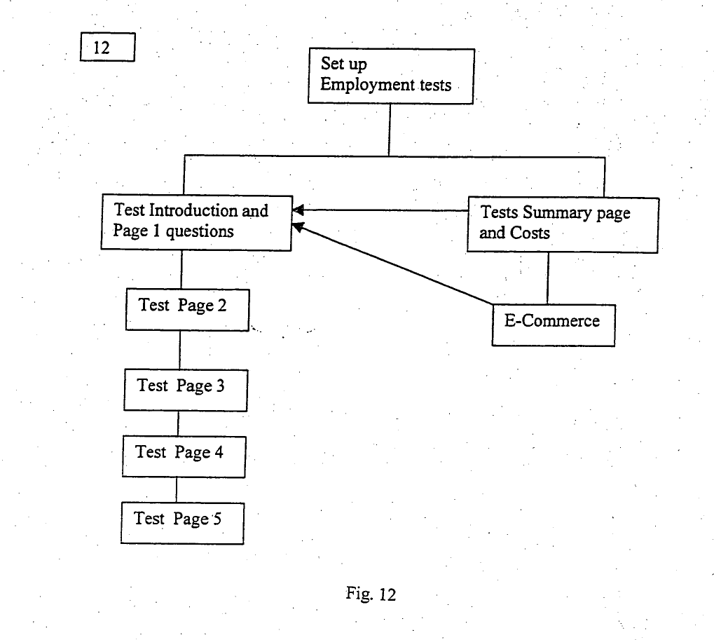

With reference now to FIG. 12, the test set up page preferably includes the setting up of categories, timers, options to have questions evaluated, answers to questions, and mandatory status of questions. The administrator preferably will set up the questions and answers. If the question is a multiple-choice question, a mark will preferably be placed in the radio button next to the correct answer. If the question has a fill in answer, the question and answer will preferably automatically accompany the application to the administrator and not be included in the test scoring. Scoring is preferably done by category and total score. The program owner determines the number of categories. All scoring is a percentage of the total questions divided by the number of correct answers (by category and in total). The scores will preferably be on the top of the application. Mandatory questions are questions which will be on all tests. The test questions are selected when the applicant clicks on the job file number in the testing box. The test questions are selected at random from the bank of questions, using the limits, which were set up on the test set up page for categories and total questions. Mandatory questions are preferably placed randomly on the tests, as are all the other questions. If the bank has more questions than the test requires, some questions will not be on the test.

With reference now to FIGS. 4, 5 and 16, applicants will preferably select a job file. If a test is associated with the job file a mark will be placed next to the job file number. After filling out the application or entering the applicant's identification number, the submit button goes to the first test. (If the applicant is applying for multiple jobs, different tests may be used. If the test is the same as the previous job file, the score for the test will repeat on the submitted application.) The applicant completes the test and submits the application. The test is scored and accompanies the application to the administrator's file. If another test is required, the next test appears with the job file identification. The next test is completed until all are done. If timers are associated with a test, the test will automatically be submitted once time is used up. The score is the correct answers divided into the total number of questions on the test (either by category or whole test).

In other embodiments, the invention provides a system of matching job applicants to employee openings. The system of the invention is preferably computer implemented, and is carried out using one or more computers connected to a computer network such as the Internet, a privately operated intranet, a local area network (LAN) or other data communication system. In further example embodiments of the invention, the one or more computers comprise at least one computer of a job applicant user connected via a network or other communication system to one or more servers or other computer(s) of a provider. In still further example embodiments of the invention, the one or more computers comprise at least one computer of an employer user connected via a network or other communication system to one or more servers or other computer(s) of a provider. The system can, for example, be implemented via a website accessible by applicant users, employer users, and/or the system owner/provider. The website preferably includes a main home page and one or more pages linked to the home page. In an example embodiment, the website of the present invention enables the practice of the above described system and method as described further below.

Home Page (FIG. 1):

An applicant or employer enters the program at the homepage. The homepage has the introduction to the program and is set up in different sections, which are highlighted by titles, which are linked to either the Applicant's section or the Employer's section. The descriptions, in each section, explain the basic premise and benefits for using the program. The legal disclaimer and the Program Owner's Identification are also on the page along with links at the top and bottom of the page to get to the major program sections.

A link to an alphabetical listing of all job files is on the Home Page. Only those who are hosting can send an application to any the participating members. However, non-hosting members can send their applications to an employer if they have a job file number from the employer. They will have to refill out an application for each job file number.

Applicant's Procedure

More precise program description, benefits, and cost of hosting the application are shown on this page with links to “One-time Applicants”, “Hosting Applicants”, “Directed Applicant” or “Special Applicant”, “Updating Application”, “Search Job Files” and “Home”. These links are placed at the top and bottom of the page.

If a person is directed to the site, a “Directed Applicant”, with a specific job number from an employer, he/she will enter the job number in the designated boxes in order to access the specified application(s). The “Directed Applicant” button is a bookmark to the section on the page with the boxes for job file numbers. Up to eight applications will be able to be accessed at one time. Once the job numbers are entered, and the “Done” button is activated, black dots will appear next to any job file, which has a test or special questions associated with it. Applicants who are hosting on this program will be able to enter their ID number and Password and have his/her application information automatically placed on the common part of the form.

The “Done” button will search the database for customized questions or tests associated with any job file. Those job files with special questions or tests will activate the radio button to a colored shade and thus indicate to the applicant that further questions will need to be answered in order to apply for the selected position. Instructions on filling out the test will appear. If the applicant chooses to submit an application, he/she must then click on the job file and go to the test pages. The test should be completed and declared done by the applicant before the test, with the application, will be sent to the employer. Warnings about incomplete forms will be shown and options to clear and exit without sending are offered.

If no test is indicated for any job file, the “Submit” button will send the applications to the employer. If there are some that do have tests and some that don't, only those without tests will be forwarded to the employer. The others will remain listed and a box instructing the applicant to fill out the special questions will show.

Potential applicants can go to an index and search all of the employer members, select and view a job file (the job location and description), and decide to apply. If the person hosts an application, the inputting of his or her ID number will enter the application and allow the applicant to take any test, if needed. Non-hosting applicants must fill out the full application.

Applicants can be directed to this program by entering a member employer's web site and clicking on the job, which they want to apply to. This is if an employer is set up for this type of access. If accessed this way, a logo from the company will show up on all forms and pages accessed by the applicant. Applicants may find a job file to apply to by opening the member's job file listing and selecting a member employer and then viewing the job file which will be set up by state/city/zip code (optional).

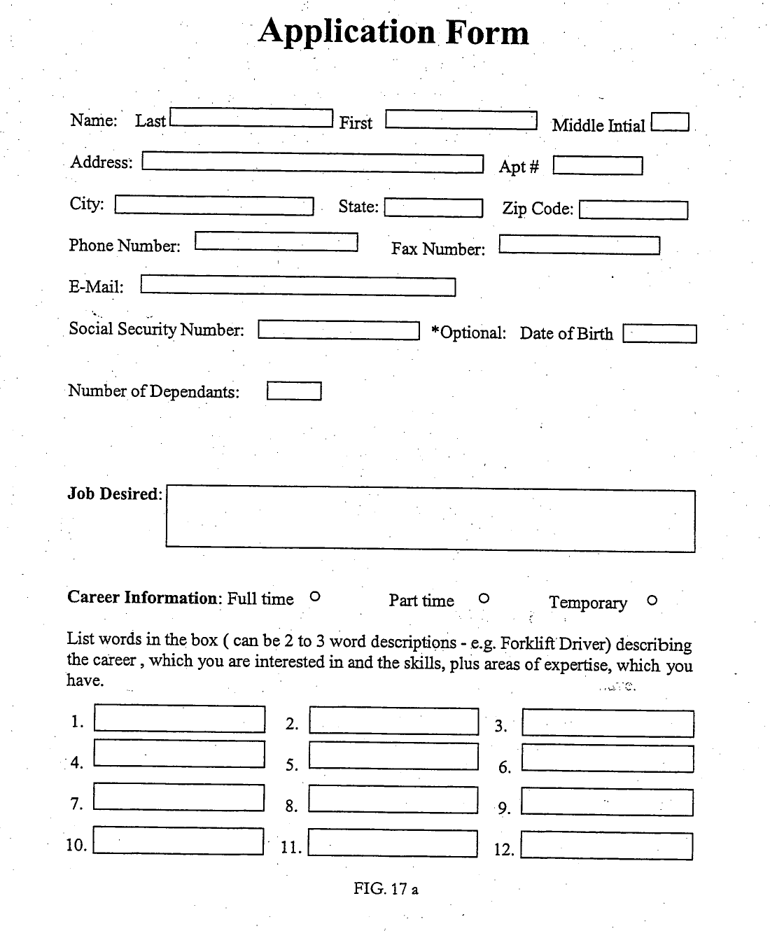

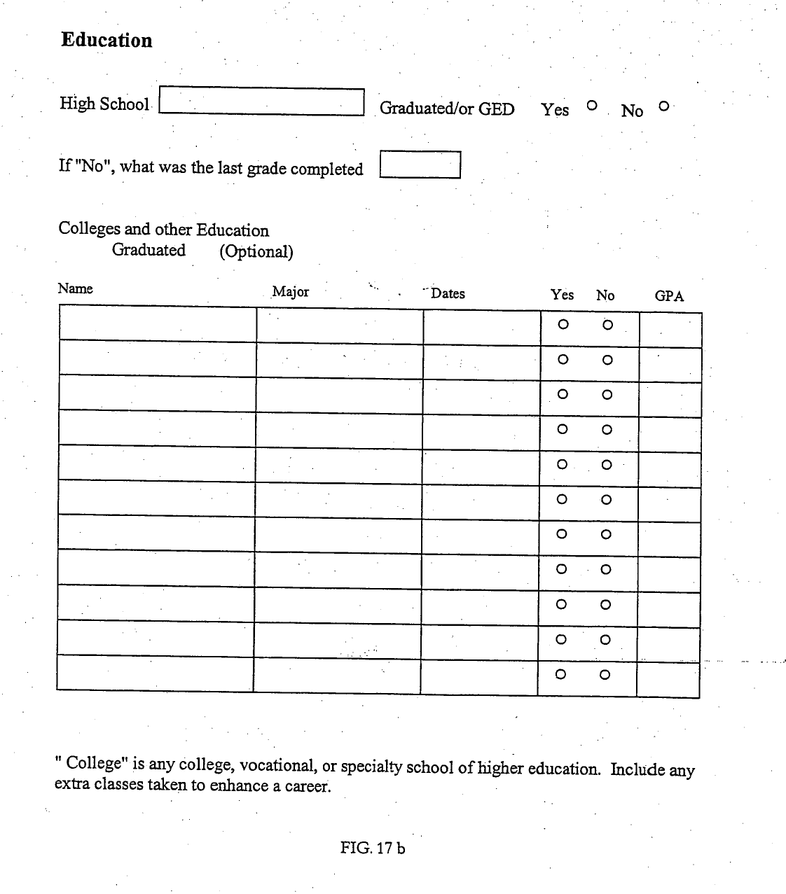

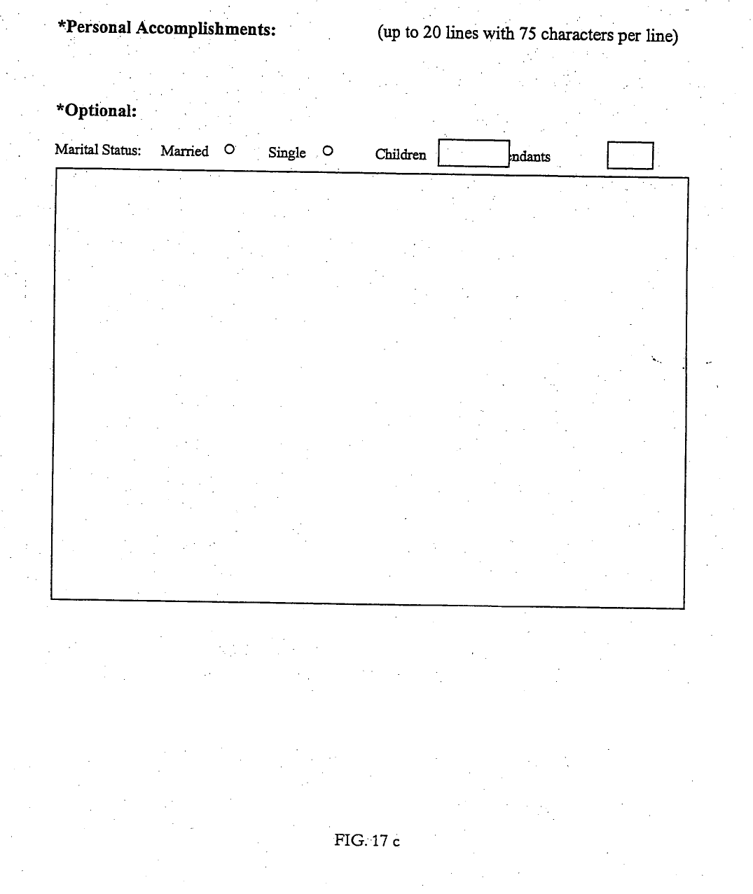

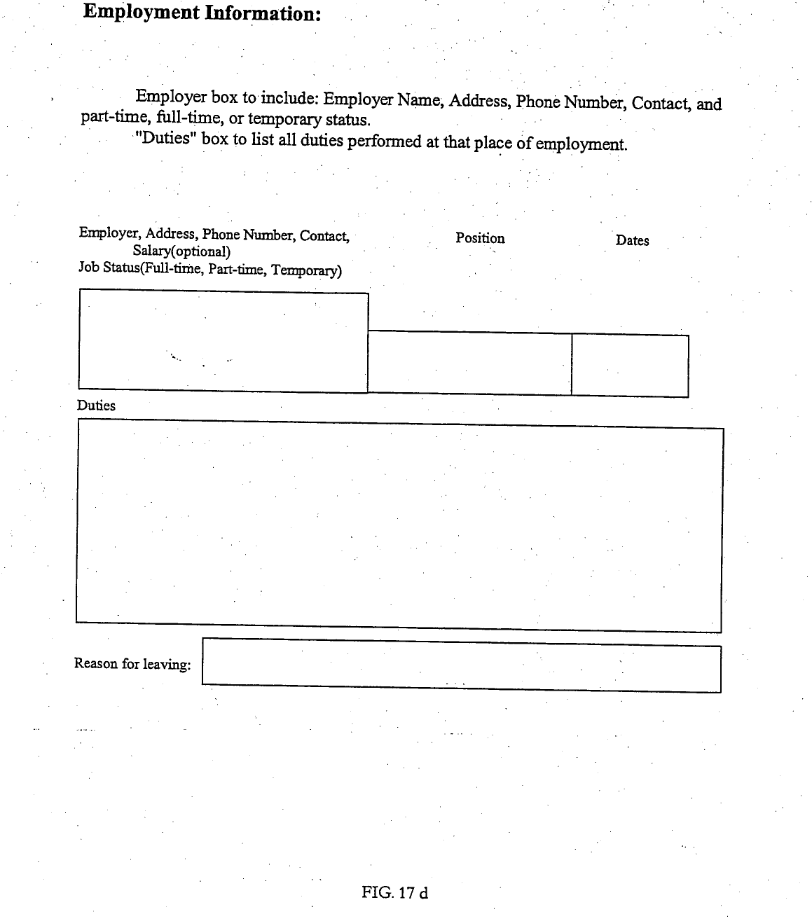

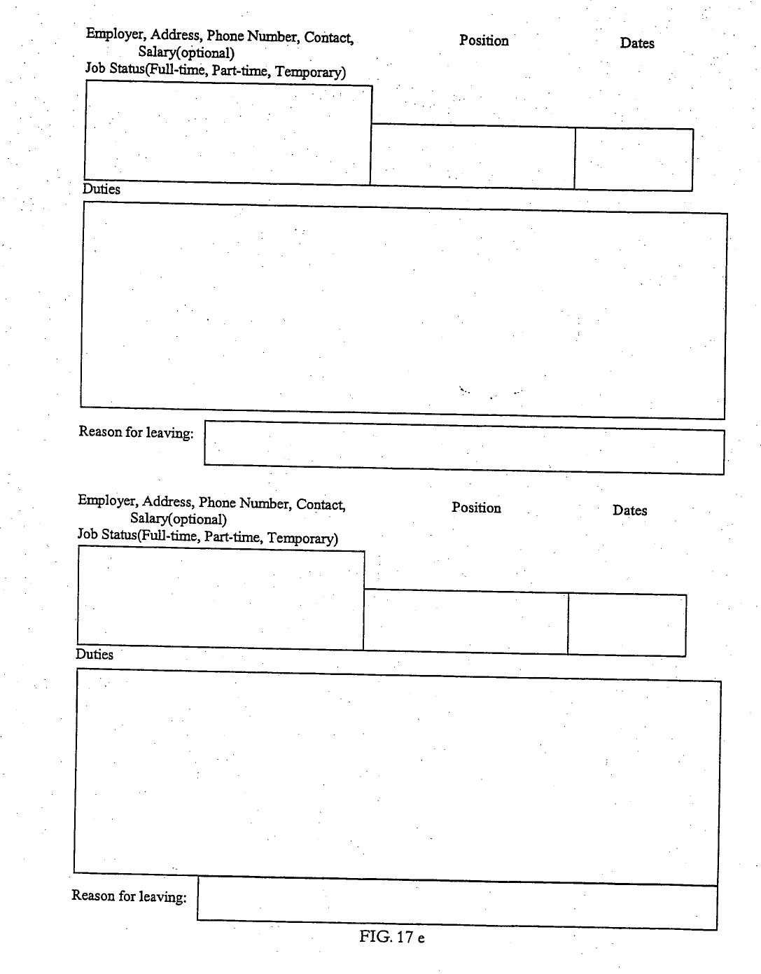

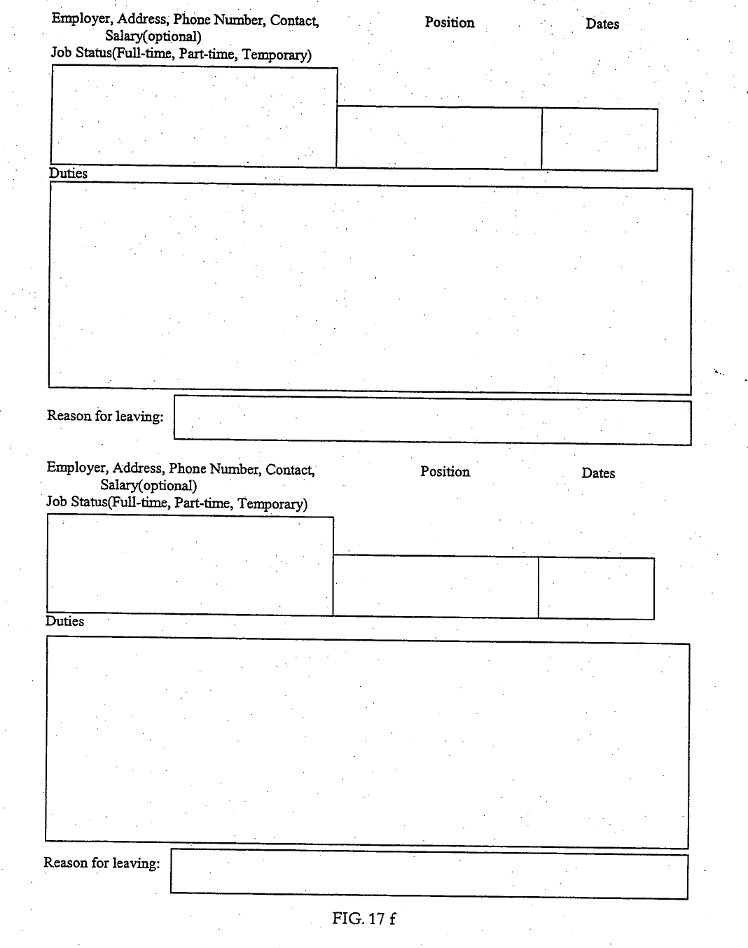

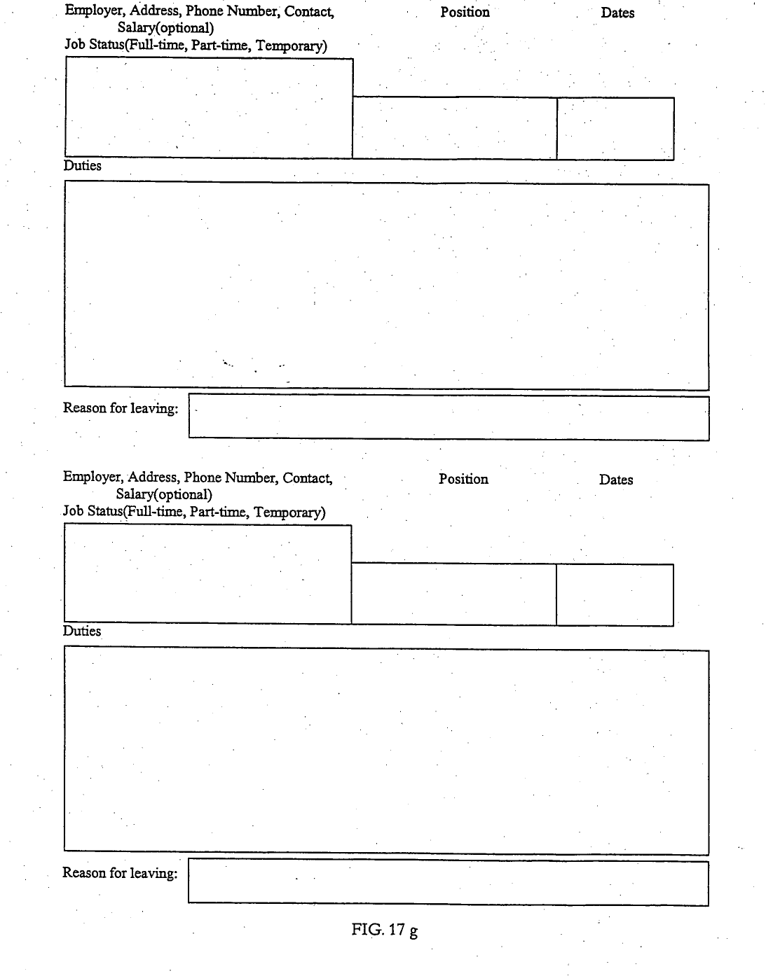

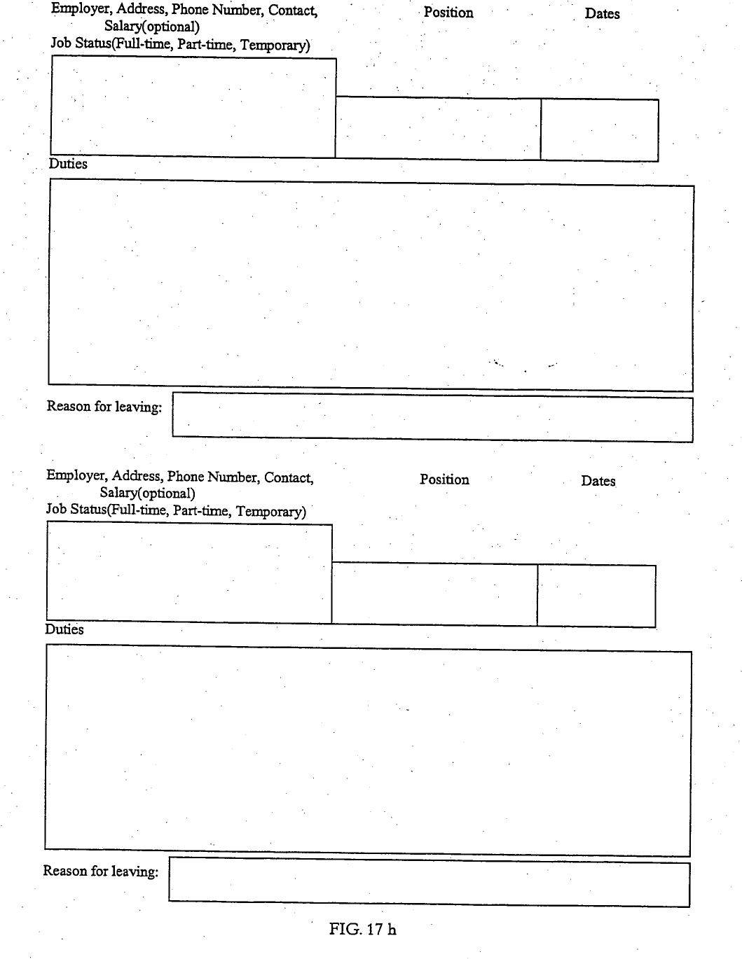

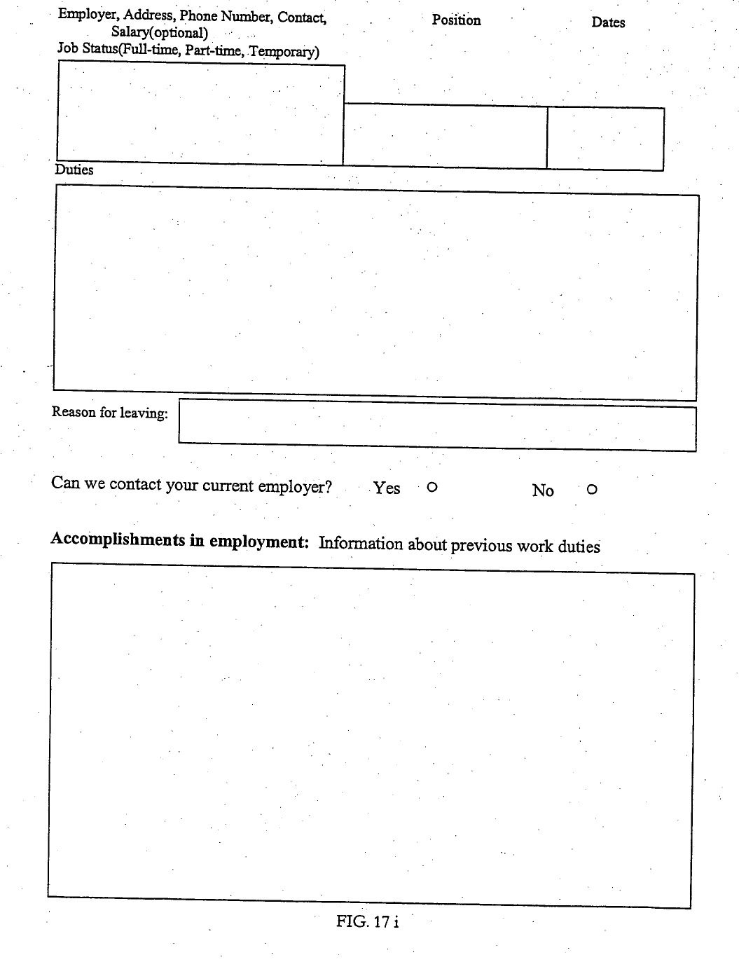

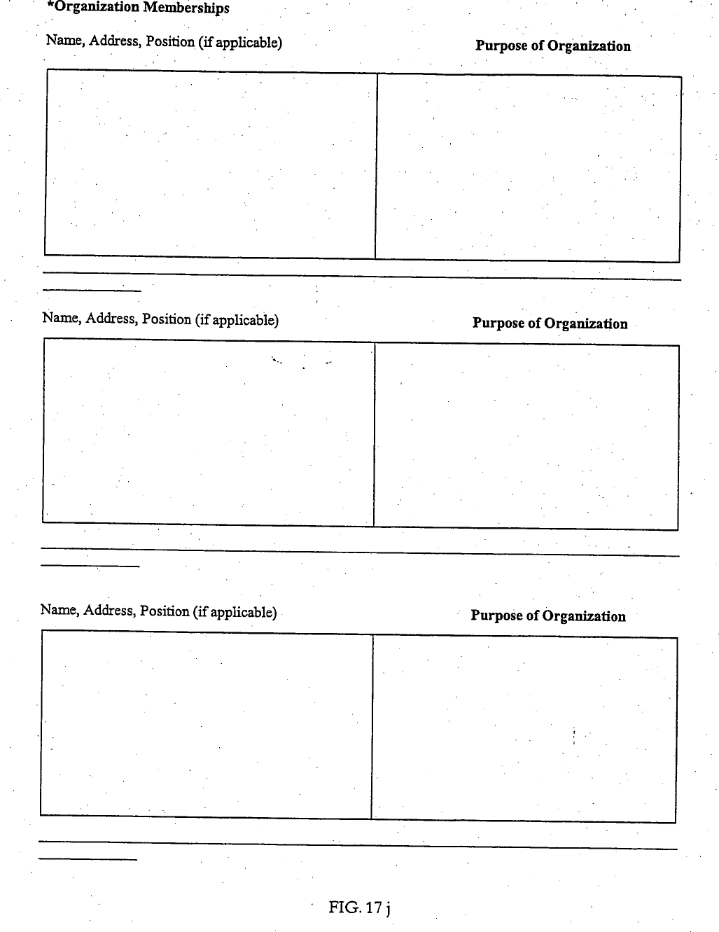

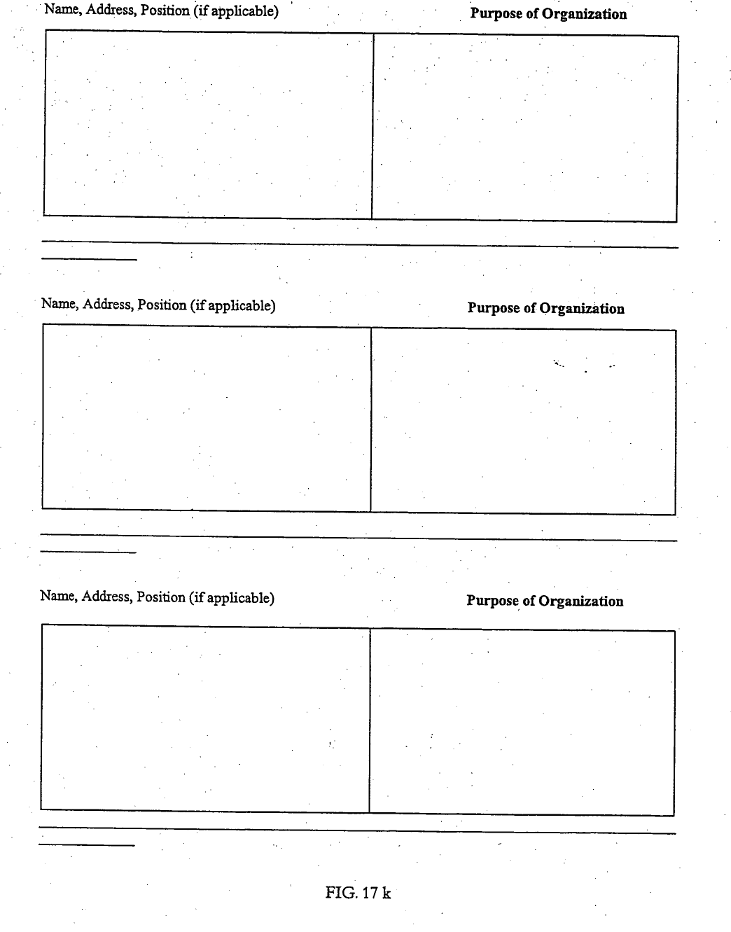

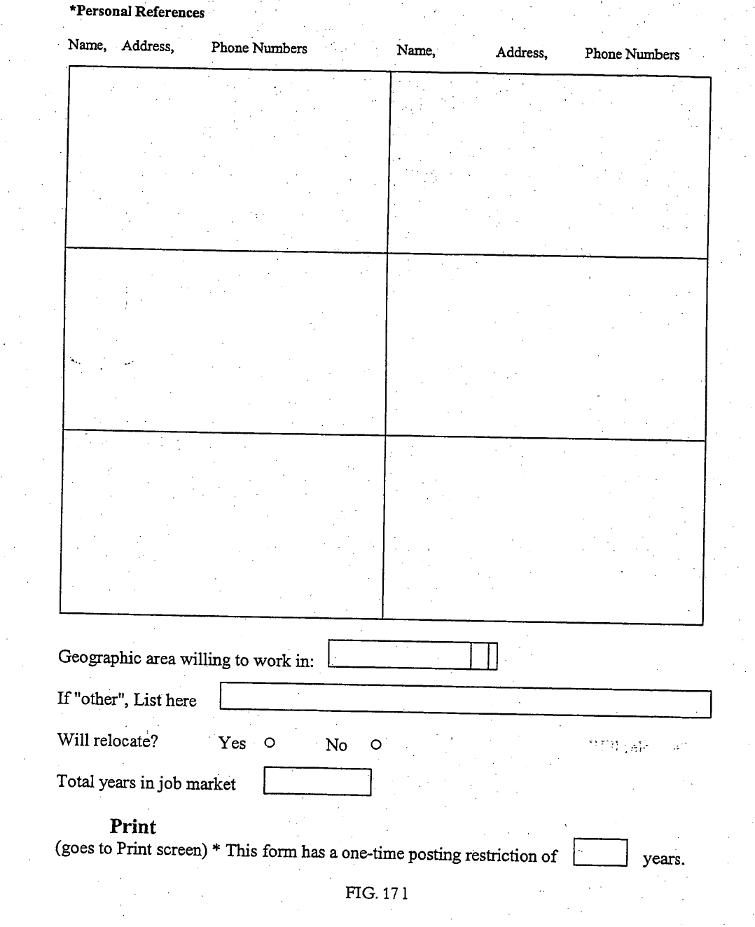

One-Time applicants—See Application marked “Form A”. FIGS. 17a-17l:

One-time applicants are those individuals who will try the program one time. Specified information, unique to the individual, will be saved for a period of time, which will preferably be at least 2 years, but determined by the owner.

By clicking on the link for one-time, the applicant will be sent to a description page on the costs and the rights of one-time users and hosting applicants. After clicking on one-time applicant again, he/she is sent to the application form to be filled out. After completion, the user clicks the “Print” button.

Before printing, a box will allow the applicant to change the application to a hosting application, without having to redo the application. A box to enter a user name and password will appear after payment is made. If the user does not want to host an application, he/she closes the box and “Continues”. The application will then print on the user's computer. The boxes are cleared and the specified information is saved to prevent use unless the user becomes a hosting applicant. All applicants will have an option available for a hard copy of his or her application to be printed by the service and mailed to a directed address. The fee to do this will be set by the owner.

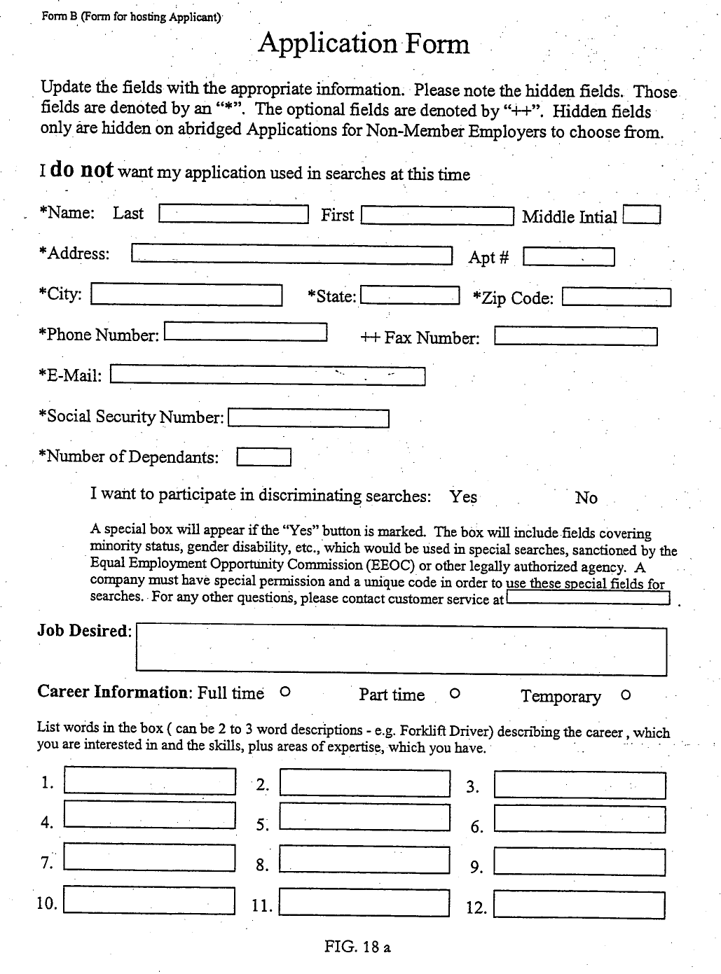

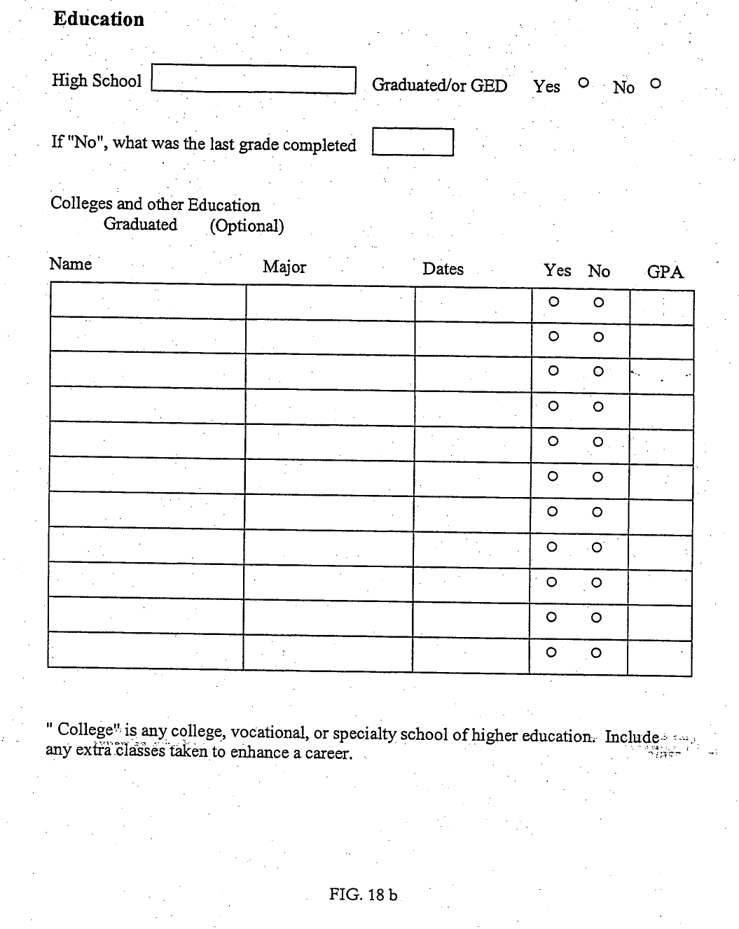

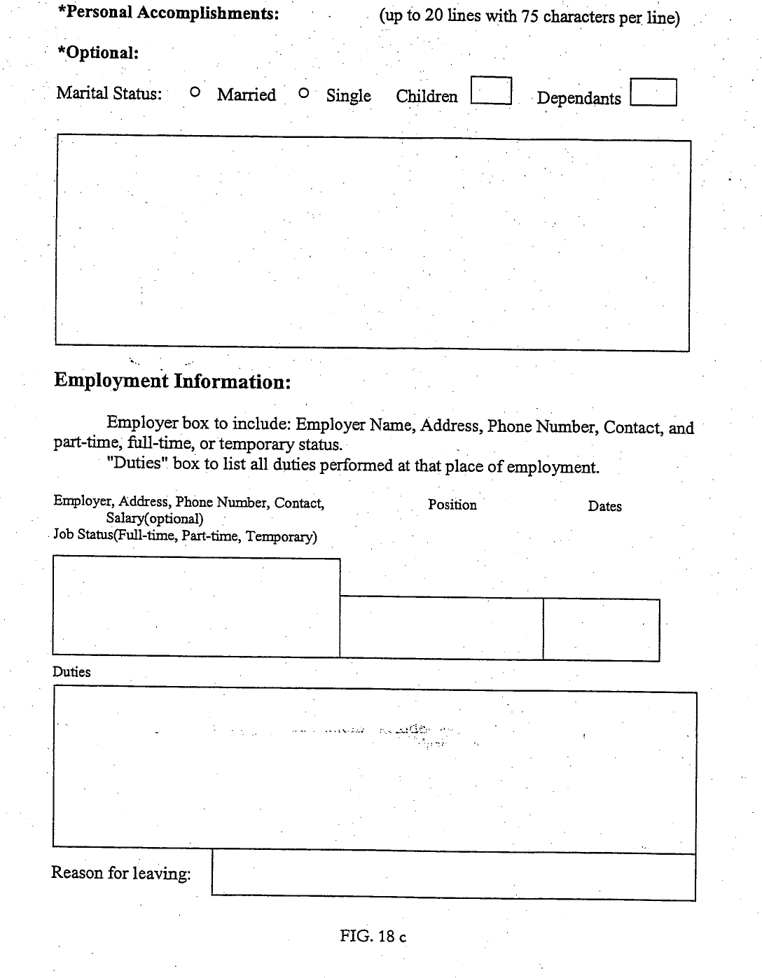

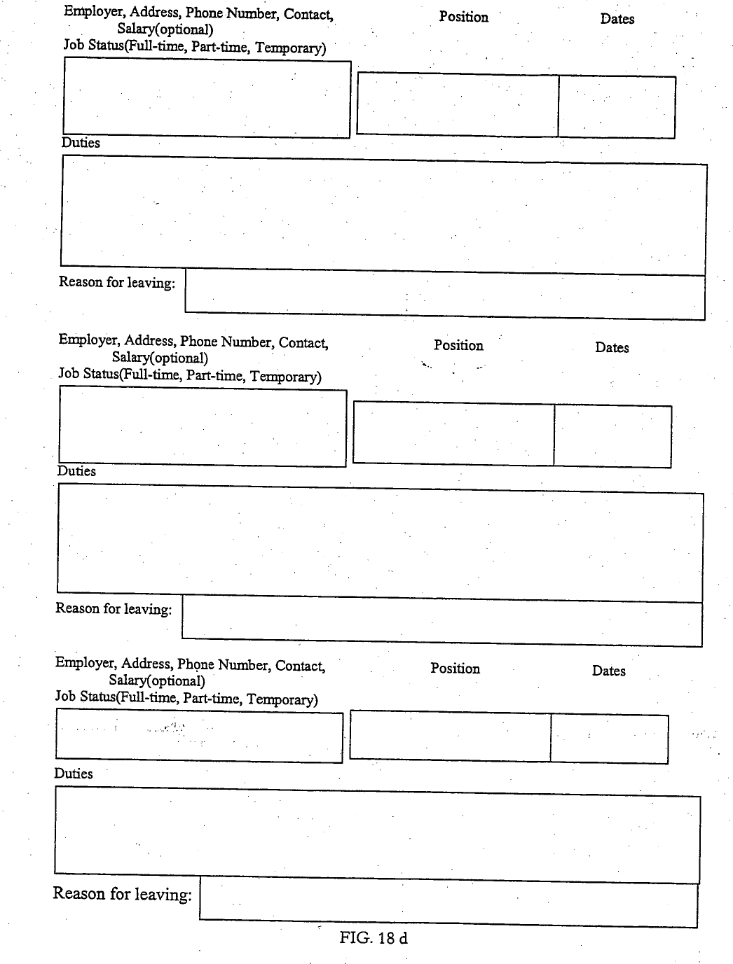

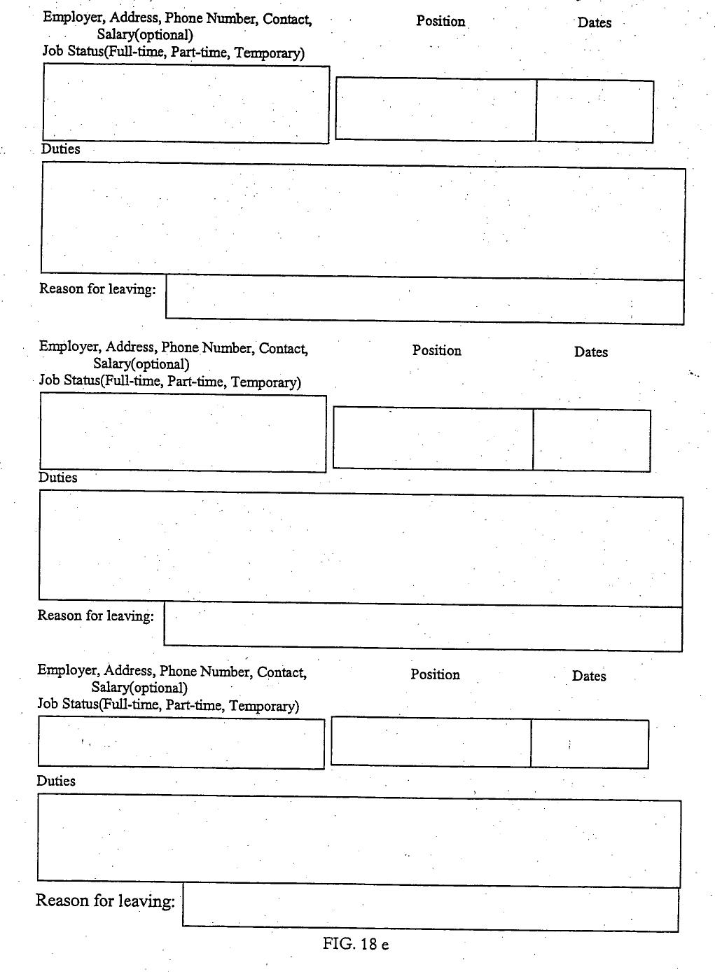

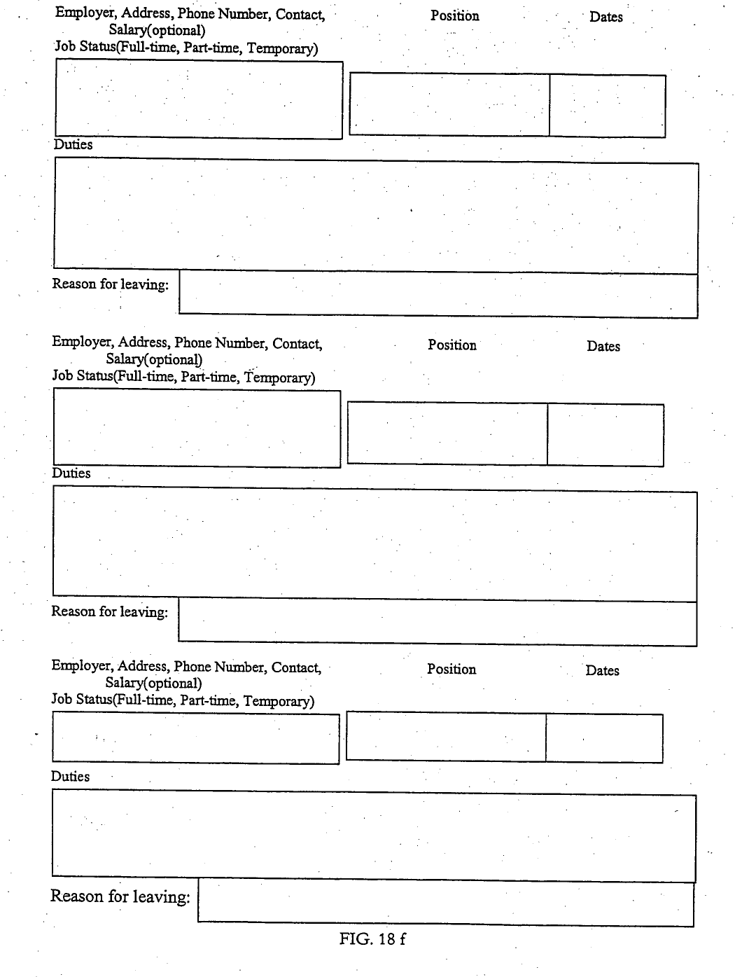

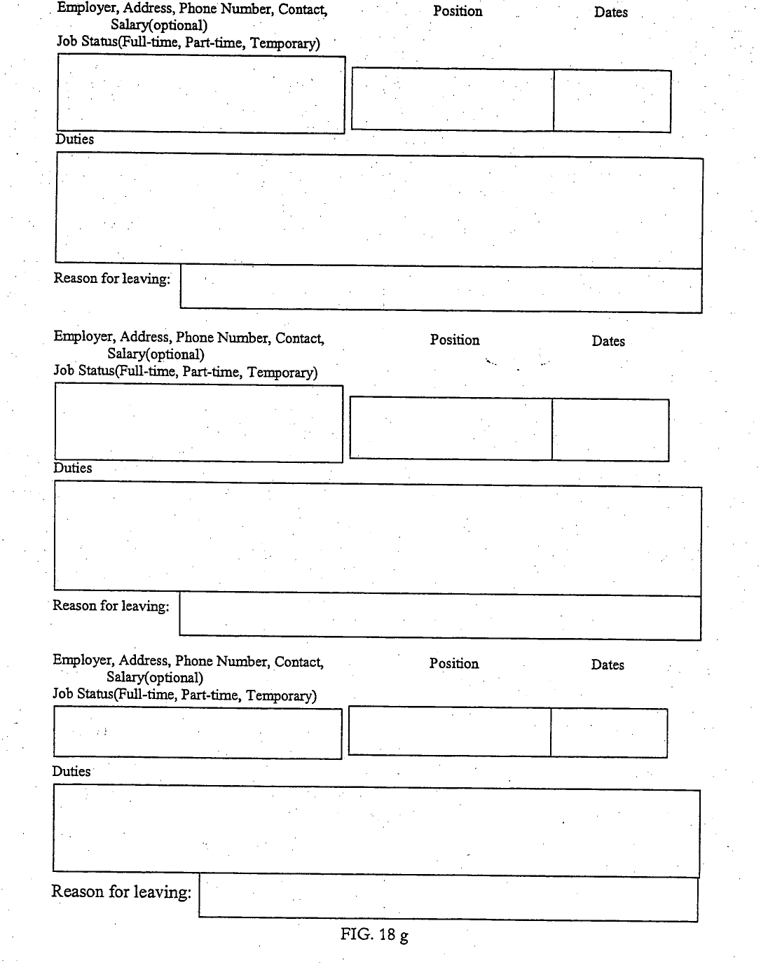

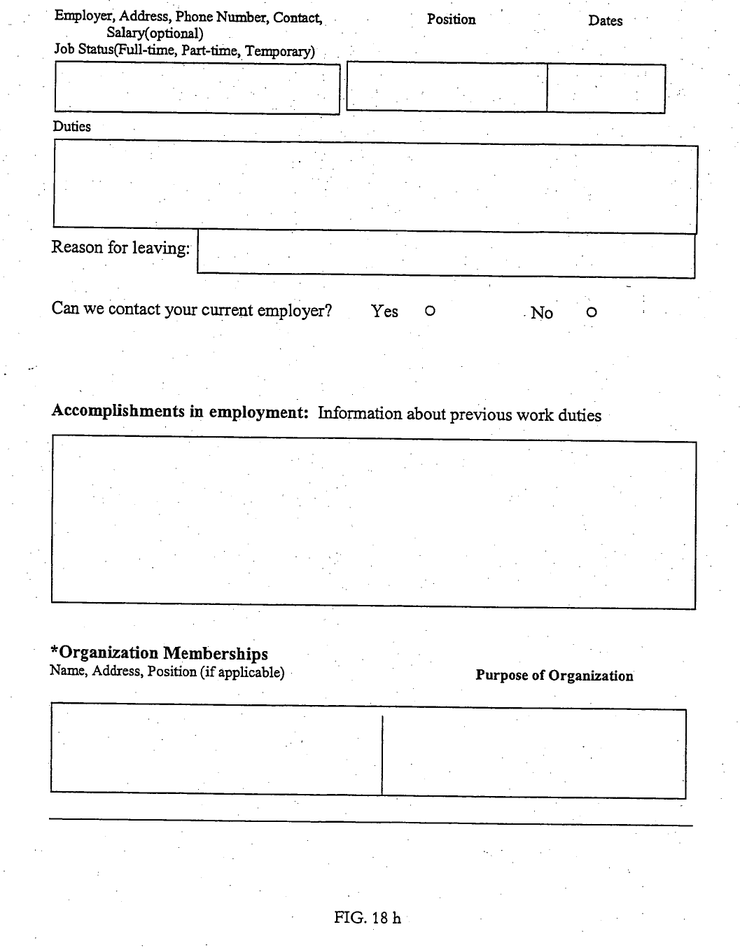

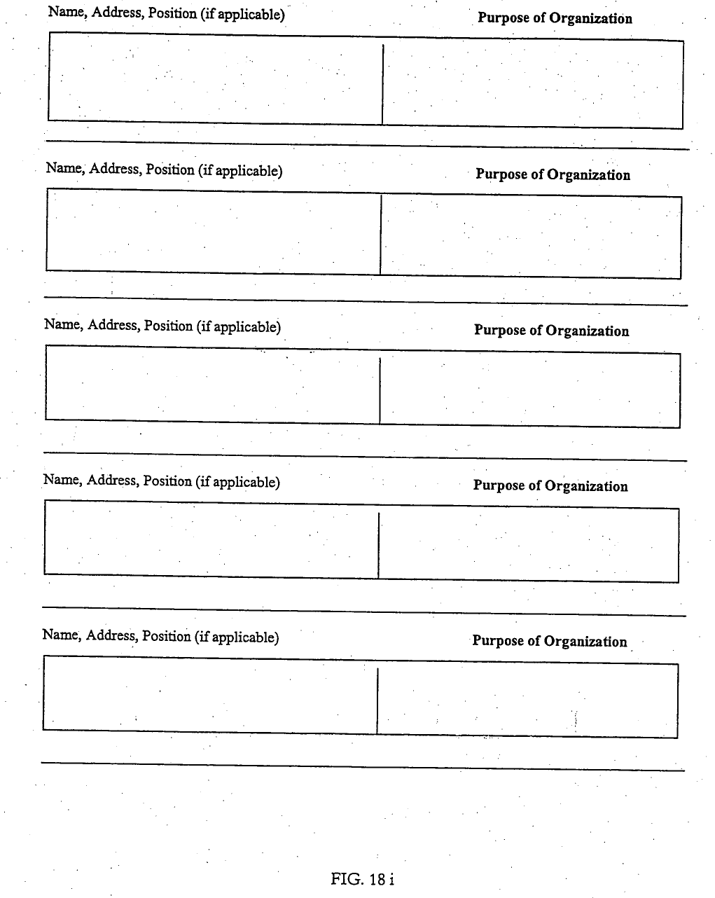

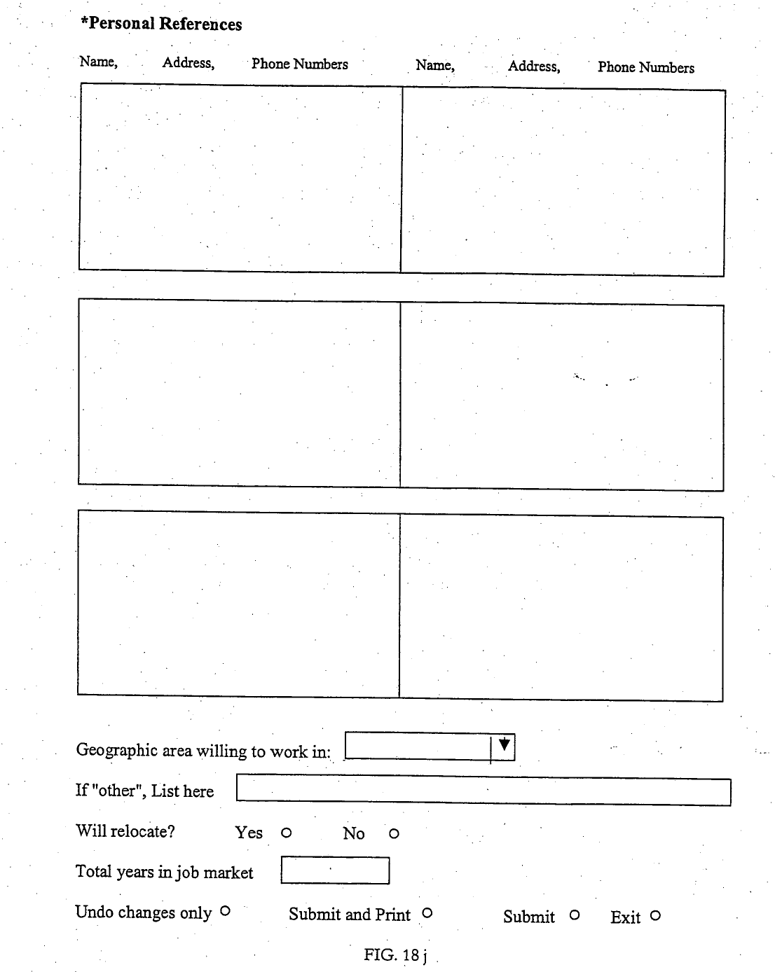

Hosting Applicants—See Application marked “Form B”, FIGS. 18a-18i:

Hosting applicants activate the “New User” or “Updating” button, depending on his/her situation. Hosting applicants will be able to enter their own ID number onto a member employer's application and have his/her information copied to the form without re-entering. Testing will then need to be completed before submitting if applicable.

New Users

New Users are sent to the Payment description page and then click on “Hosting Applicant”. The applicant is then directed to the E-Commerce pages to select the payment plan and to pay for the service. Option to include a picture of oneself can be chosen and paid for (extra Fee).

Once payment is completed, the applicant is sent to the form page. He/She creates a username, password, and special question with a unique answer for “forgotten password” access to his application. The user then completes the application form.

After completion of the form the option to “Clear Form”, “Submit and Print”, “Submit”, and “Exit” are offered. Clear Form, allows for complete clearing of the application and applicant is moved to the top of the form. Submit and Print allows for the form to be placed into the database and printed to the user's printer. The print procedure asks if the application printed “OK” before allowing the applicant to exit the program after going to the Thank You Page. The Submit button places the data into the database for the user without printing and sends user to a Thank You Page. The Exit button takes the user out of the program and to the Home Page.

Updating

The Updating button takes the applicant to the “Updating Instruction Page”. Here the applicant can enter his/her user name and password to access his application. The rest of the page lists the fields, which should be considered for updating on a regular basis. The applicant also has the opportunity to go to the lost Password Pages. The lost password pages allow the applicant to use the special question he/she set up and with the correct answer, change his/her password. Without a password or correct answer to the special question, the user will not be able to access his file. The user has 3 tries in a 24 hour period to give the correct username and password. Otherwise, the application file is locked for 24 hours. He/she must contact the owner of the program with the confirmation number or transaction number of the payment to be allowed to have a password or username reset.

Once access is verified, the application form appears and the application is available for editing. Bookmarks are listed at the top of the form to be shortcuts to specific sections of the application. After editing is completed the application can be submitted and printed again. From this location, the form can be printed without editing. After any submission of any new data, the applicant is sent to a Thank You Page.

Option to include a picture of oneself can be chosen and paid for (extra Fee). Applicant will be directed to the payment pages to pay for this option.

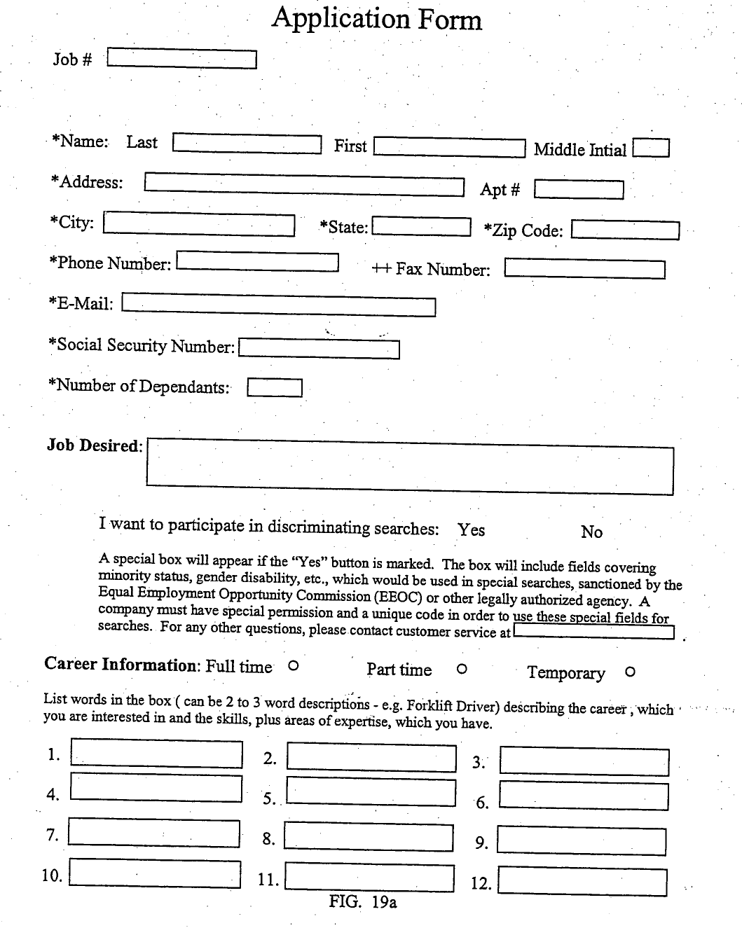

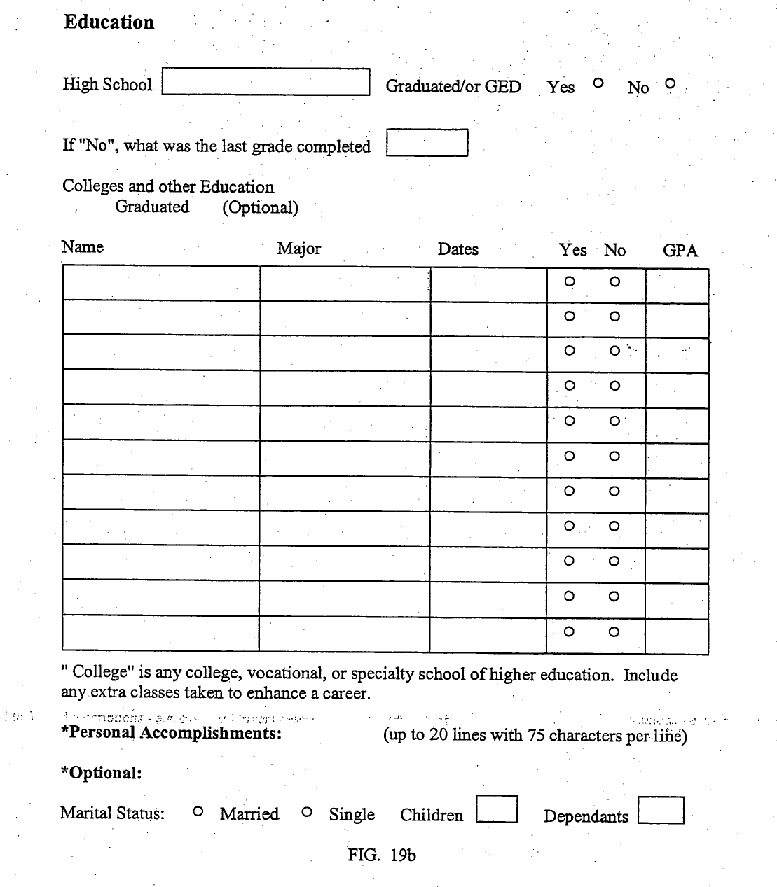

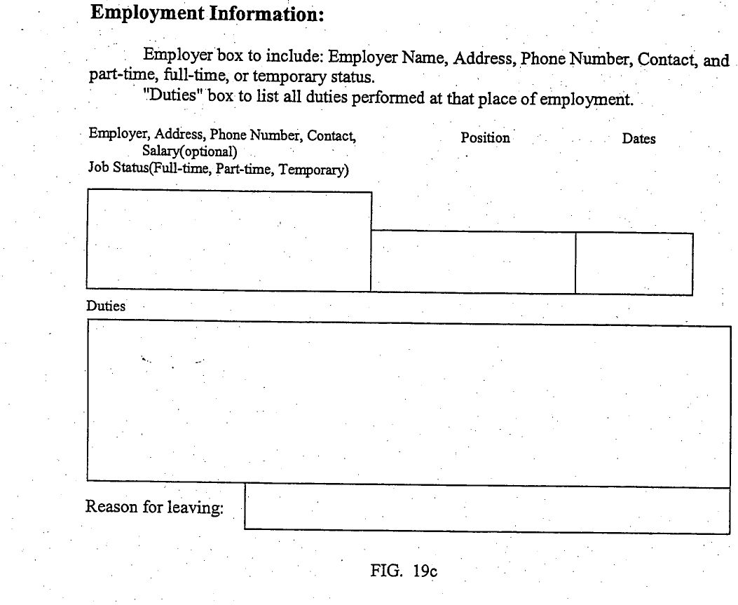

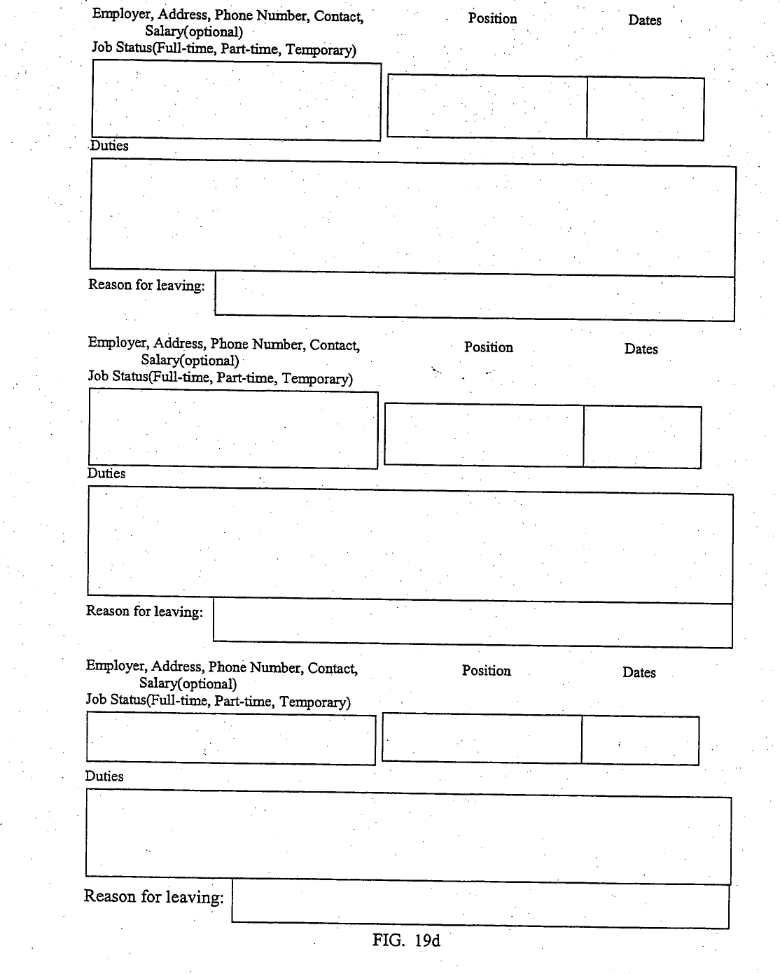

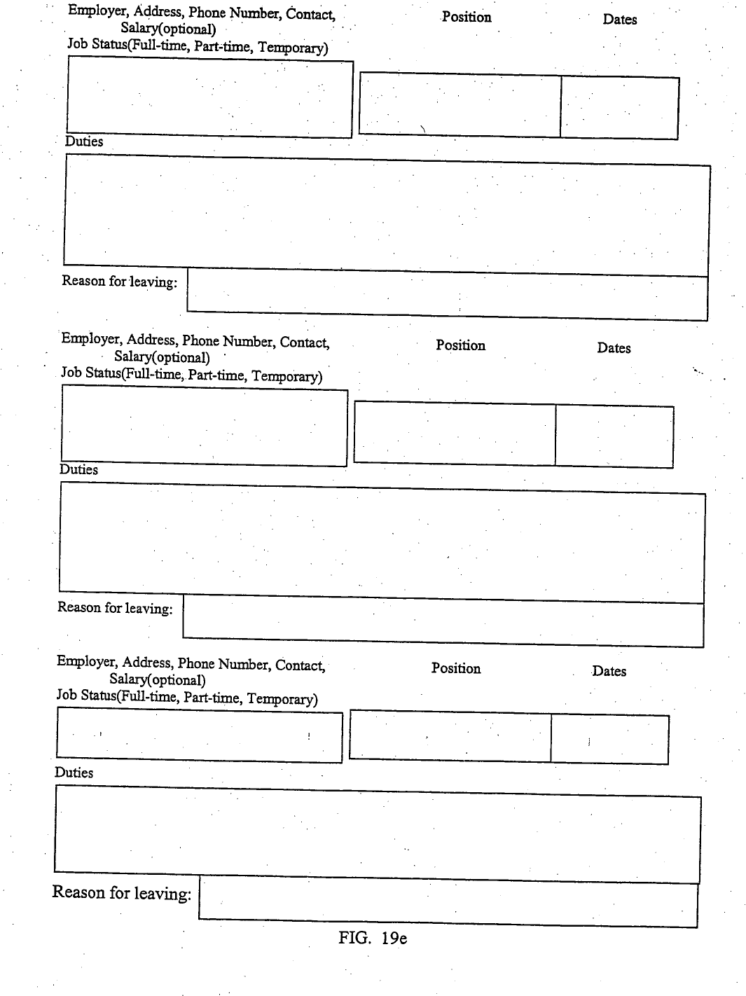

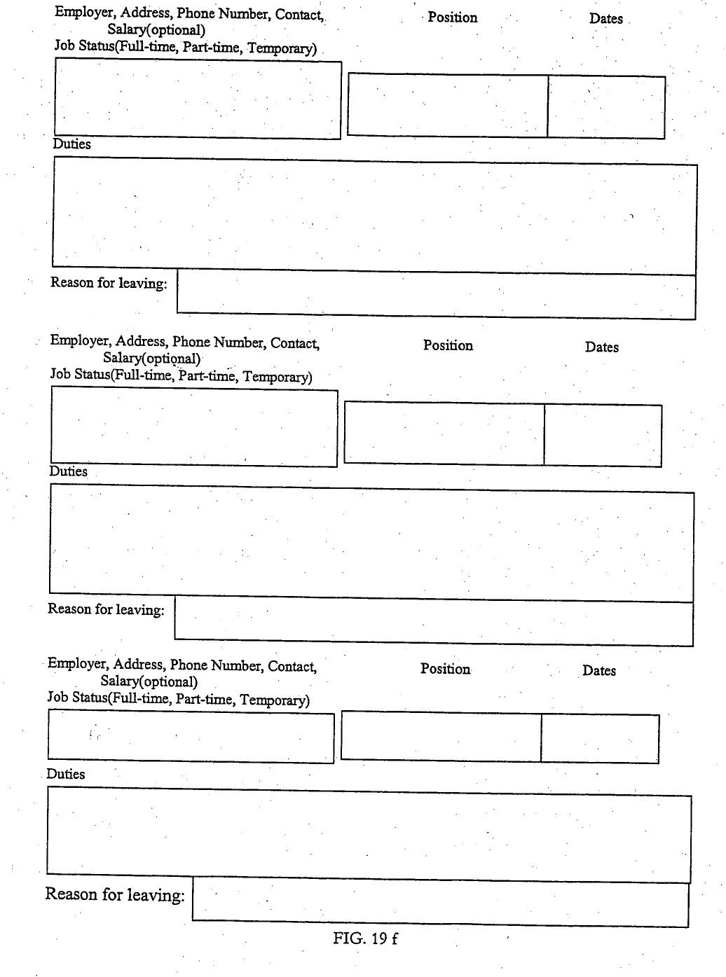

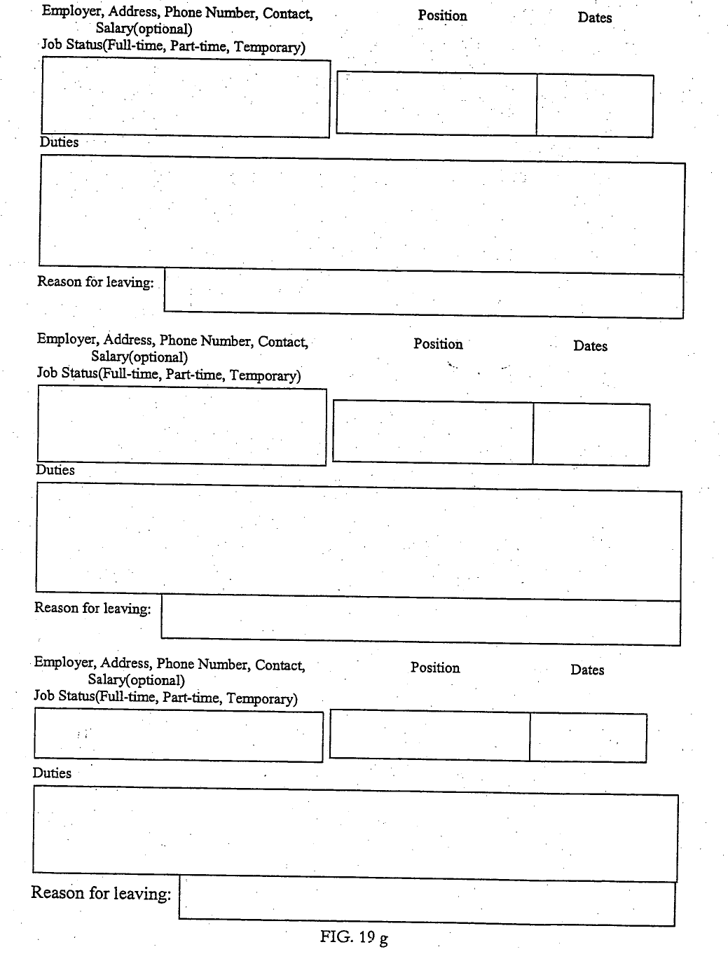

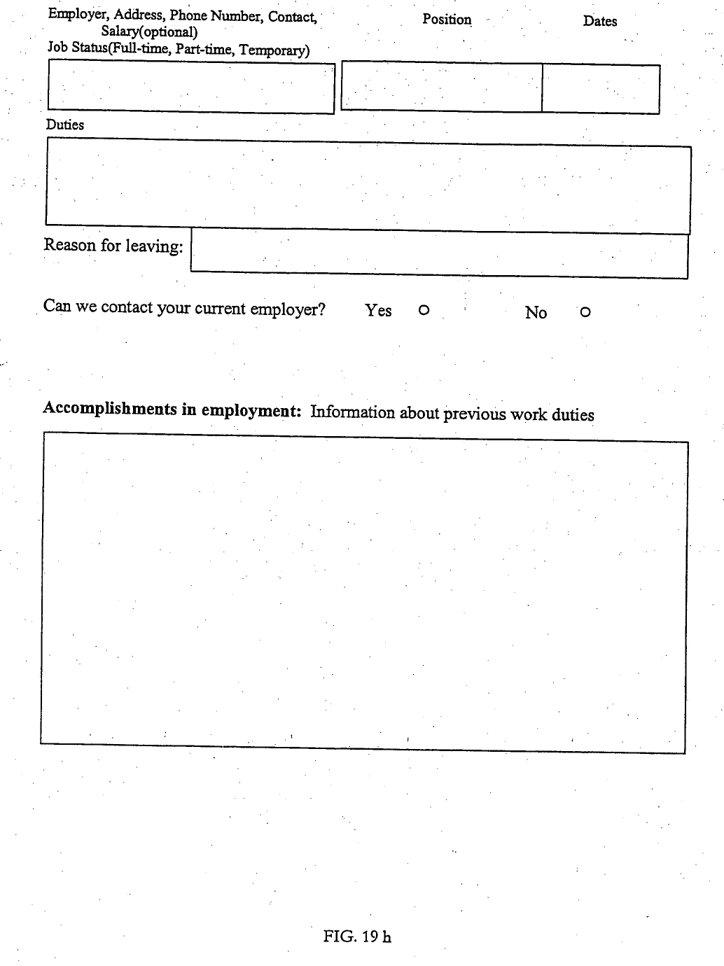

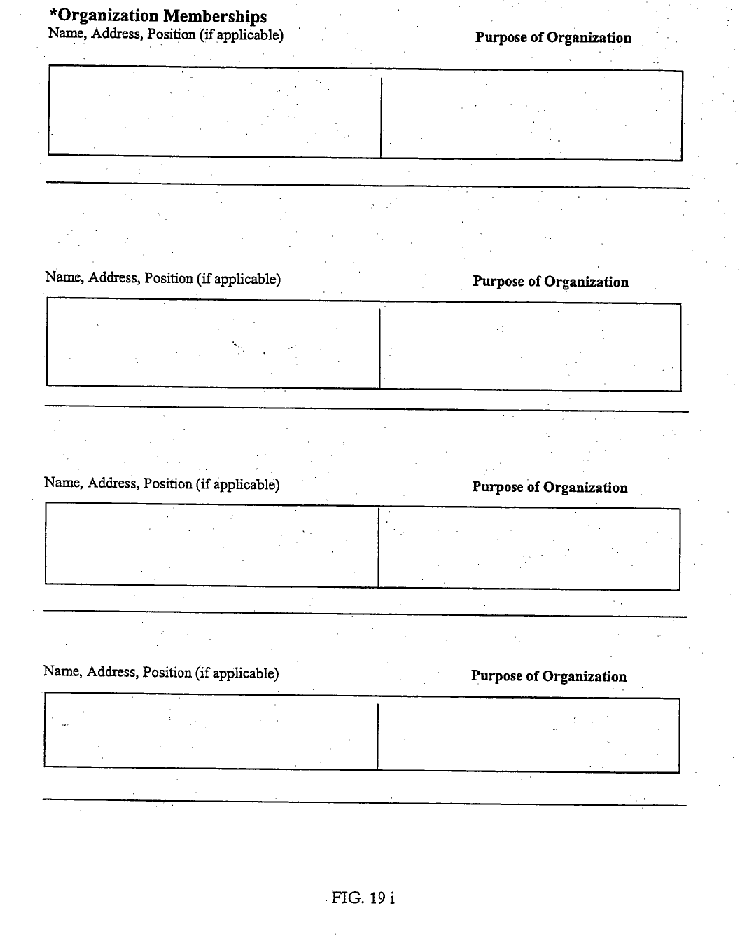

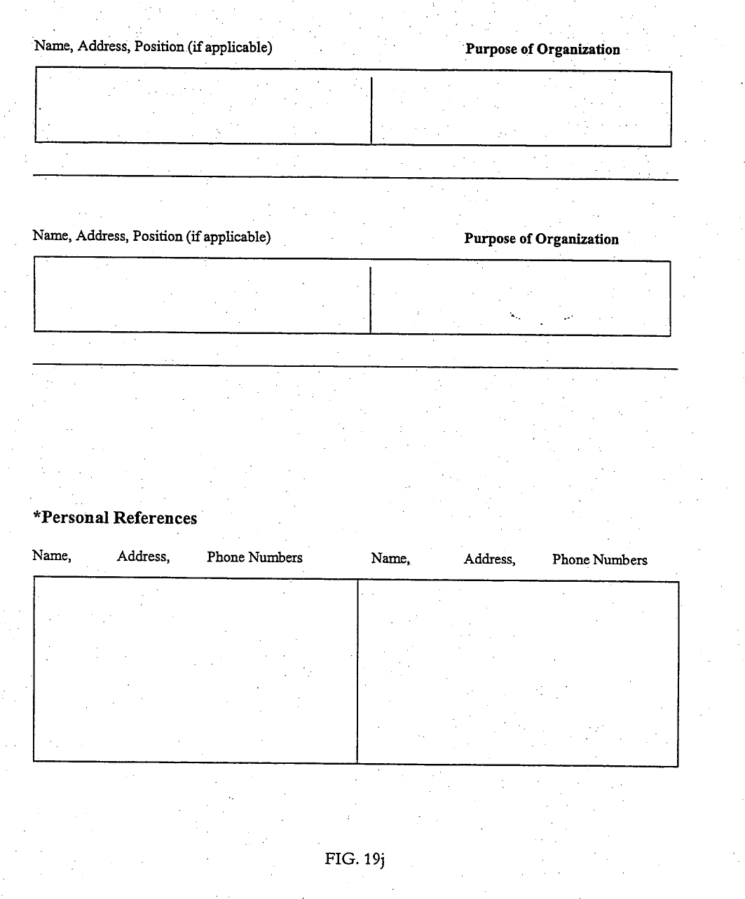

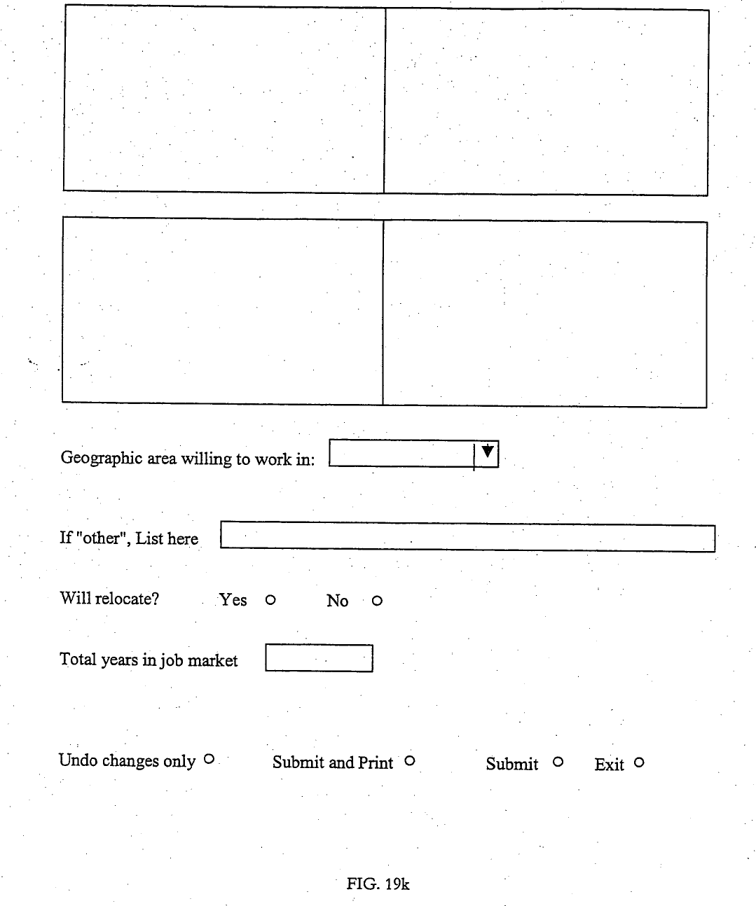

Special Posting—See Application marked “Form C”. FIGS. 19a-19k:

Special Posting is for situations where an access number from an employer or legal authority is given to an applicant for the ability to access the program. In this situation the employer or legal authority has the rights to decide how the application will be used. They may or may not allow the application to be used in searches outside the organization. The applicant will be able to make one copy of the application.

The authorized person will issue usernames and passwords and/or just an identification number to access the program. With just an identification number, a person can access the program and then set up his/her own username and password, or, the username and password can also be assigned. With the correct Username, Password, and Access Number, the applicant or employee will be allowed to access the program. The Applicant fills out the form.

After completion of the form the option to “Clear Form”, “Submit and Print”, “Submit”, and “Exit” are offered. Clear Form, allows for complete clearing of the application and applicant is moved to the top of the form. Submit and Print allows for the form to be placed into the database and printed to the user's printer. The print procedure asks if the application printed “OK” before allowing the applicant to exit the program after going to the Thank You Page. The Submit button places the data into the database for the user without printing and sends user to a Thank You Page. The Exit button takes the user out of the program and to the Home Page.

Employers' Procedure

Employers click on the “Employer” link on the home page and proceed to the Employer's section. The first page is an introduction page for Employers. If an employer has an applicant number, he may enter that number and retrieve the application. An employer can select the button to become a member and proceed to the sign up page. An employer can select the Continue button and proceed to the Search fields to try out the program. A member employer can click and directly enter his/her password and go to the management pages.

If an employer wants to test the program before making a commitment to become a member, he clicks the Continue button and goes to the search page. The employer fills out the form. The form contains mandatory and secondary skills. The mandatory skills are highlighted with an asterisk “*” or other indicator. The number of search skills will be directed by the owner. The current model has a total of ten skills (The number of skills used in the search can be changed by the owner) to be used in the search. The range for “years of experience” will be chosen (an option for exact choice or minimum experience can be chosen). Zip Code for the job location will need to be filled out to identify applicants willing to work in the area along with the State selection. The use of zip code can be used to choose applicants within the state or within a designated zip code area around the actual zip code. After the form is completed, the “Search” button is clicked and the search of the data begins.

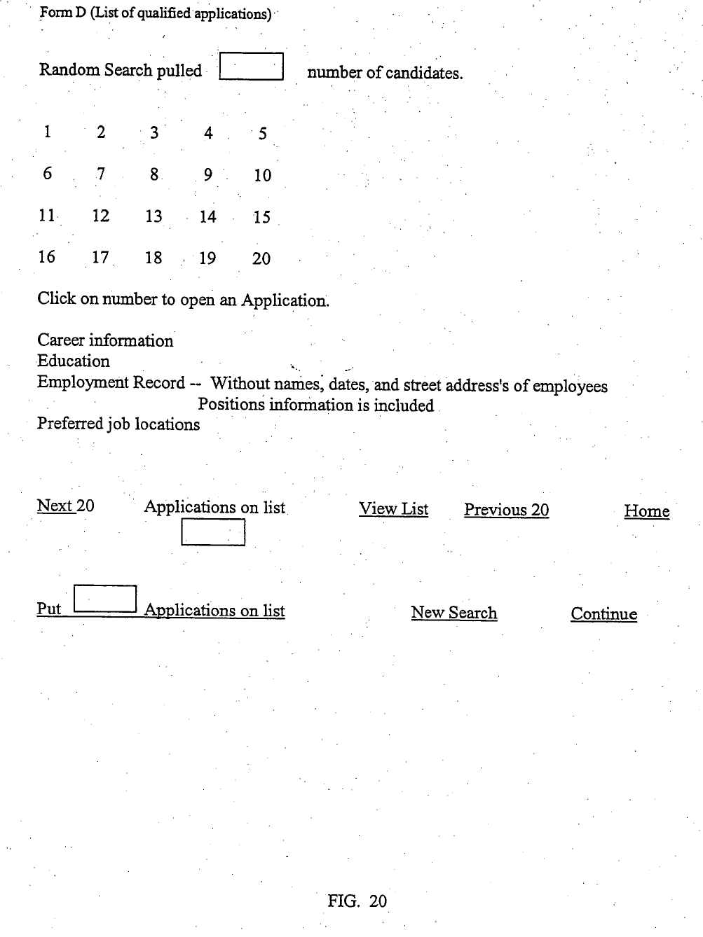

The search is preferably done as follows. The mandatory skills are found. The applicant with the most mandatory skills and then the most secondary skills is listed first. The one with no mandatory skills and the least amount of secondary skills is listed last. The list is a set of number from 1 to the last qualified application. The application ID number is assigned to the numeric number from the order of listing. The ID number preferably will never be shown, it is just a pointer to the application. (See form D, FIG. 20).

The employer can click on any number on the list (Form D) and see an abridged application of the applicant. (See form E, FIGS. 21a-21c).

The employer can choose to put the application on a list to purchase or go back to the previous page and select another to view. If the employer does not want to select from the qualified search, he/she may choose the option to select the number of applications to place on the purchasing list and the applications beginning with number 1 until the selected number is reached are placed on the list. At any point, the employer may choose to remove any application from the list, choose to restart the search, view the next application from the search results, view the list of chosen applications, and review the applications chosen (in the abridged format).

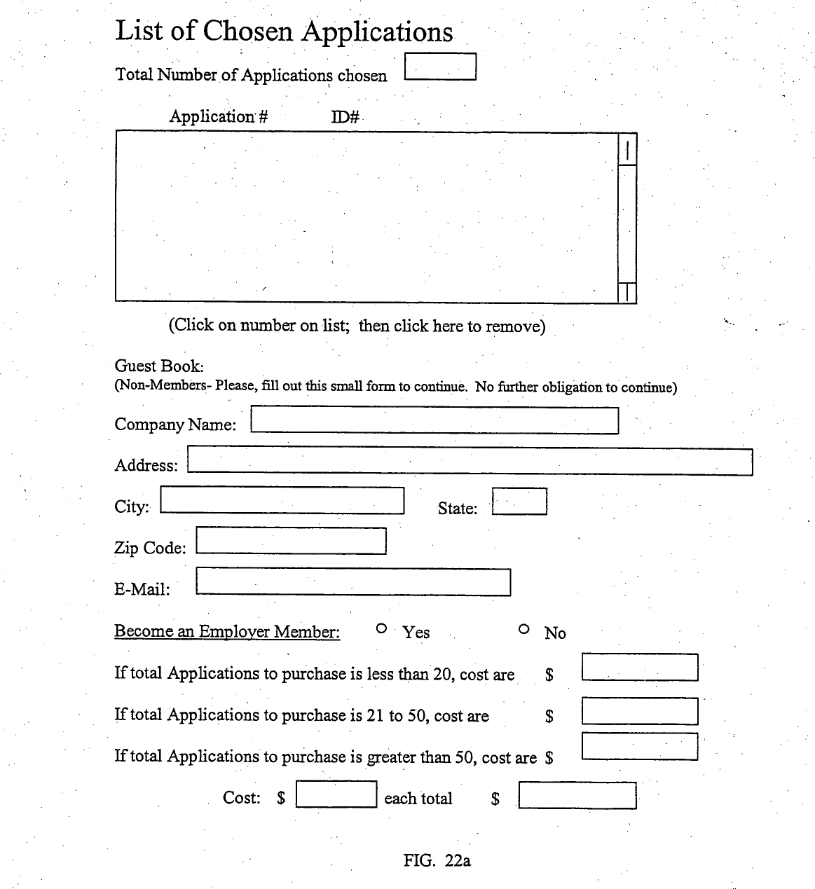

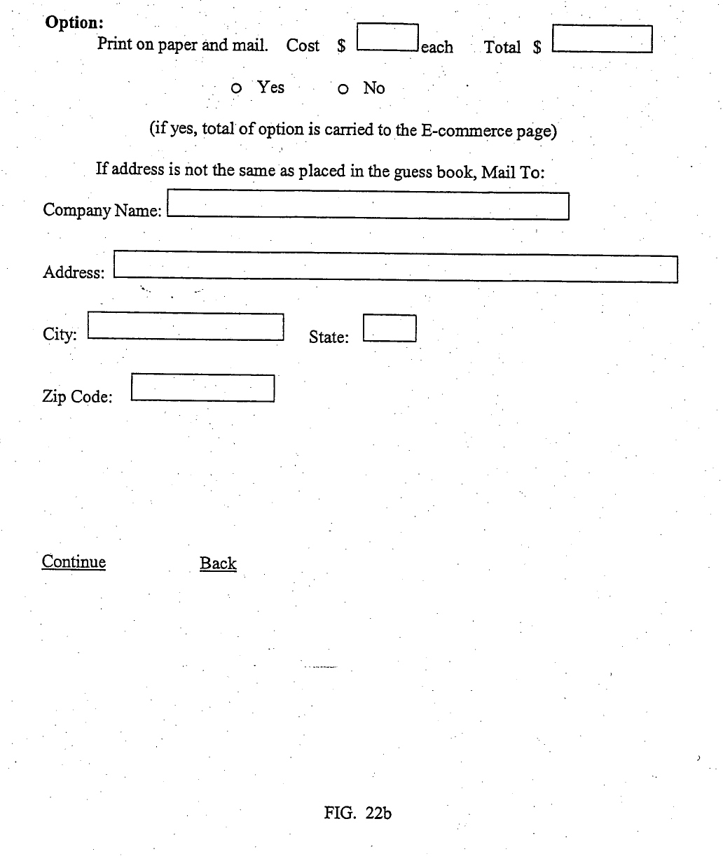

The employer then views his/her chosen list of qualified applications. The numbers of applications on the list, prices per application and total price to be paid are shown. At this point, the employer must fill out the guest book list and if the applications are to be e-mailed to another location, that address must be entered as shown on Form F (FIGS. 22a-22b). The option is listed here for the employer to decide if he/she wants to become an employer member rather than purchasing the applications “per application”. There is another option to have a hard copy printed at the program owner's location and have the applications sent to the employer by mail. That option preferably costs more and the total price for the applications chosen are carried to the e-commerce page which contains the additional costs for printing and mailing the applications. The continue button moves the employer to the e-commerce summary page.

The summary page gives the total price due, including any option chosen for the purchase of applications, “per application”. From here the employer is sent through the payment procedure. After payment the employer can access the print options. Applications can be directly printed to the user's printer, or e-mailed to the user or a specified recipient. If applications are to be printed, the print verification pages show. If applications are to be e-mailed, the e-mail address is entered and the file is sent with the file number. If any problems happen in the e-mail, customer service must be notified with the file number. The file number will be kept on file for 3 days before automatically being erased. After printing, the employer exits to the Thank You page. The thank you page has a button to allow the employer to option to become a member. The Exit button gets the employer to the Home page. The new search button starts the employer over at the Search page. All print requests are preferably logged with the username and date. The log is preferably emailed to the administrator at a specified time to be determined by the owner with the administrator.

Member Employers

From the Employers Instruction page, the employer options to become a member. By clicking on the “Become a Member” button, the employer goes to the Pay Summary page. This is for new members and Members needing to renew their membership. This page shows the payment options and the options to have tests associated with their job files. Existing Members who are renewing their membership stay on this page and fill out the appropriate information. The member chooses his membership payment plan and then chooses the test options, if desired. The fee is per group of 8 tests, or as set by the owner. The employer declares the number of tests to pay for and the total fee is placed in the box and then is carried to the e-commerce page. The E-commerce page will show: the membership fee chosen, the test fee (if any), and a grand total, and the member's Identification number. Then the employer is directed to the payment section. After payment, the employer is sent to the application search page. Where the employer can search, go to the Management files, or exit the program. Members can view a listing of all companies participating by clicking on the “Member's Application” button. This is for a listing only. Members have an added benefit by being able to link from their own web site to this service. They will be able to set up job file numbers on their site and by having an applicant click on the job file number, be sent over to the service with the job file number pre-entered onto the form. The application can then be filled out, any test taken, and the completed application and test sent to the administrator. Hosting applicants will be able to enter their ID number to have their application copied onto this form.

New Members:

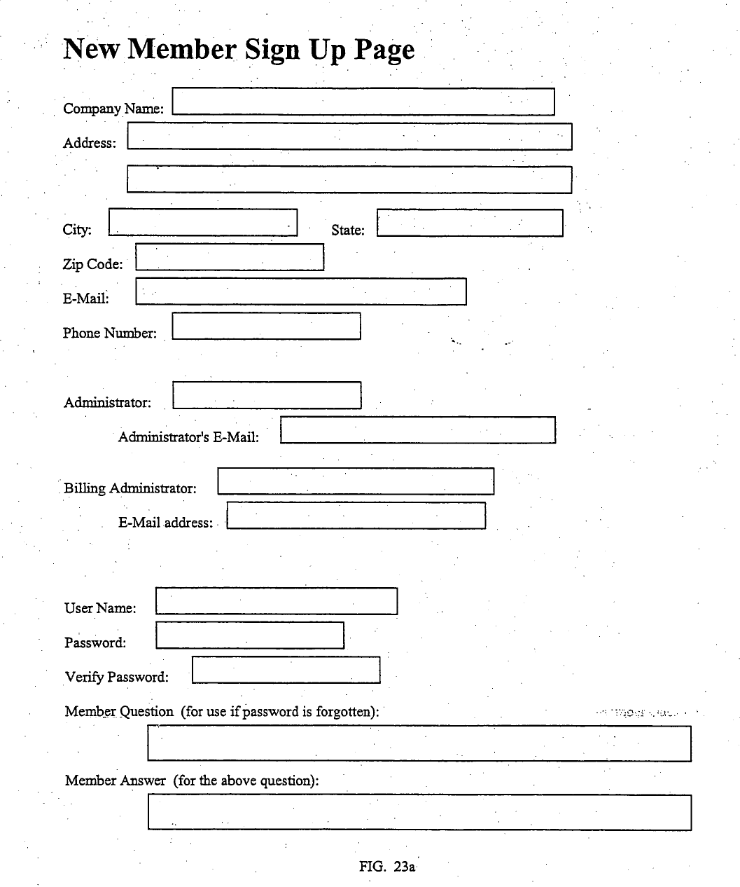

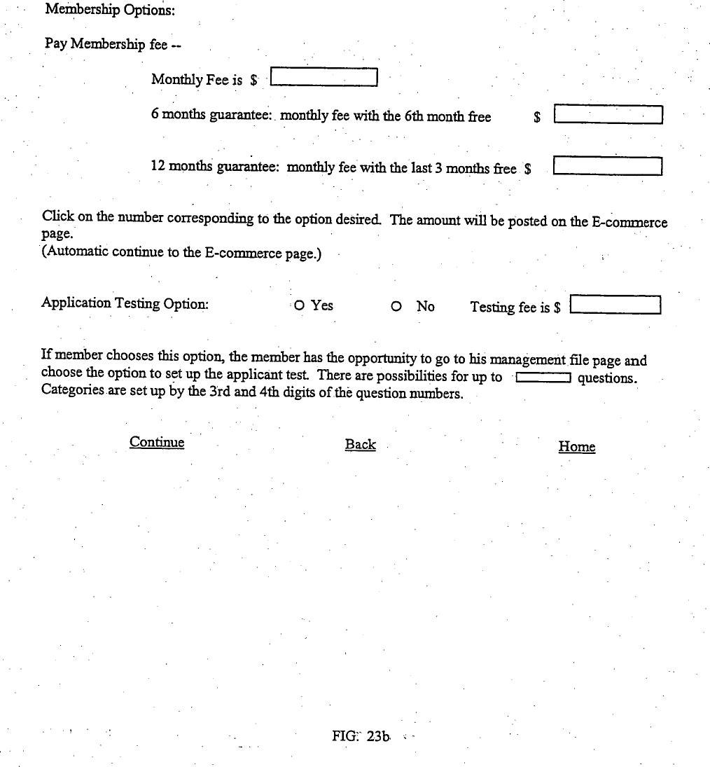

The New member clicks on the “New Member” button and continues to the New Member Sign Up Page (Form G, FIGS. 23a-23b). After completing the form, the member continues to the E-commerce page where the totals of the membership fee and any test fees are added up. It is here that the Identification number for the employer is assigned. After the payment is made, the employer is sent to the search page.

On this search page, the applicant can begin a search, or go to the management files. New members will not have any job files set up, so the only search that can be done is a standard search using the mandatory and secondary skills as the search mechanisms along with the same experience choices as described in the One-time Employer Search. Once the search or continue button is clicked, the search of the database is done and the qualified applications are listed on Form D, FIG. 20. This form assigns numbers to the qualified applications: from the applications with the most mandatory and secondary skills first to the application with only one secondary skill. The application can be viewed for selection in an abridged format (Form E, FIGS. 21a-21c). The application can be selected and sent to a designated administrator. If there are not enough applicants from the first screen, the employer will have the option to pull up the next group or previous group of applications until all, from the search, are selected.

The employer can view a complete listing of all the applications that were selected before printing or sending the application file to the designated administrator. Applications can still be deleted from this screen and the employer can go back to add more to the list. After accepting the list, the employer can send the applications to an administrator or print them immediately. While printing, the employer is able to view each or any application while the printing is being done. Print verification page appears after the last application prints. If all prints, the administrator can exit the program or search again. If not, options to reprint show. If the applications can't print, a file number is assigned, then the employer must contact a customer service person with the file number to have the problem dealt with. If the file is to be sent to an administrator, that option is selected and the e-mail address is entered and the file is sent. After sending, the administrator can exit the program or search again.

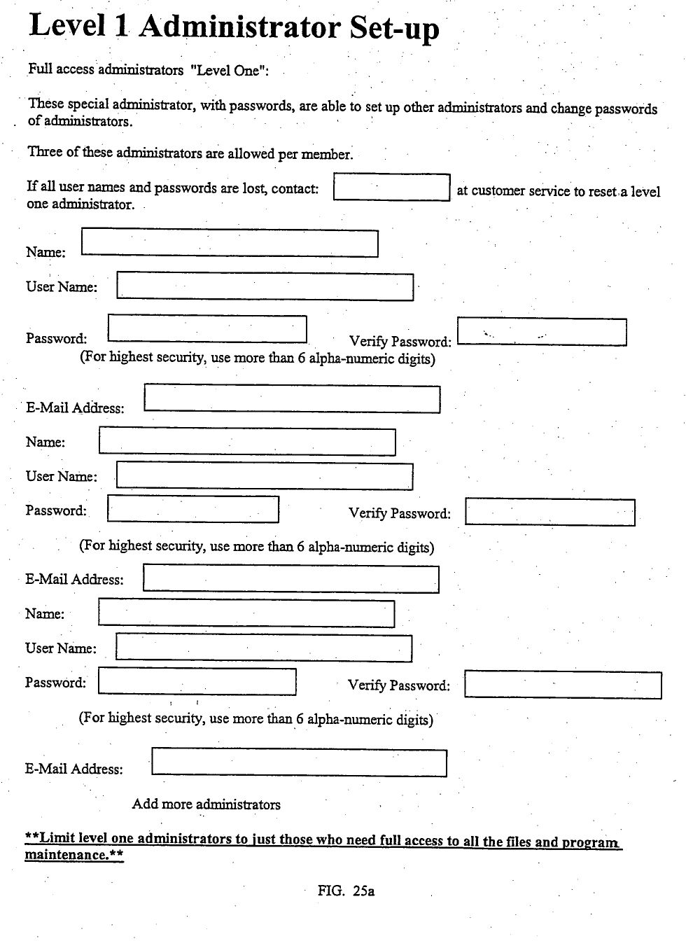

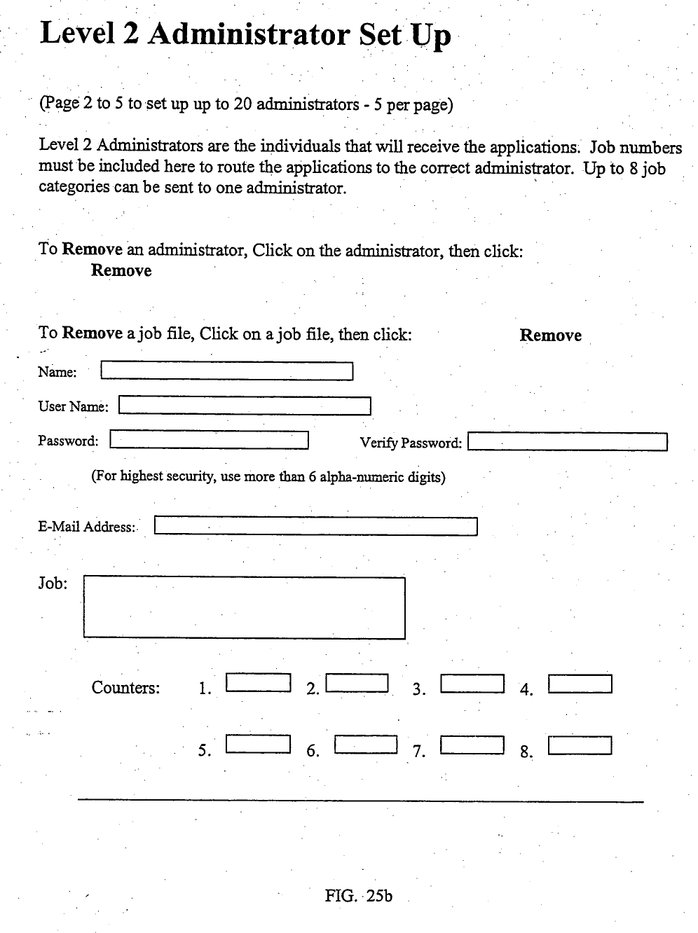

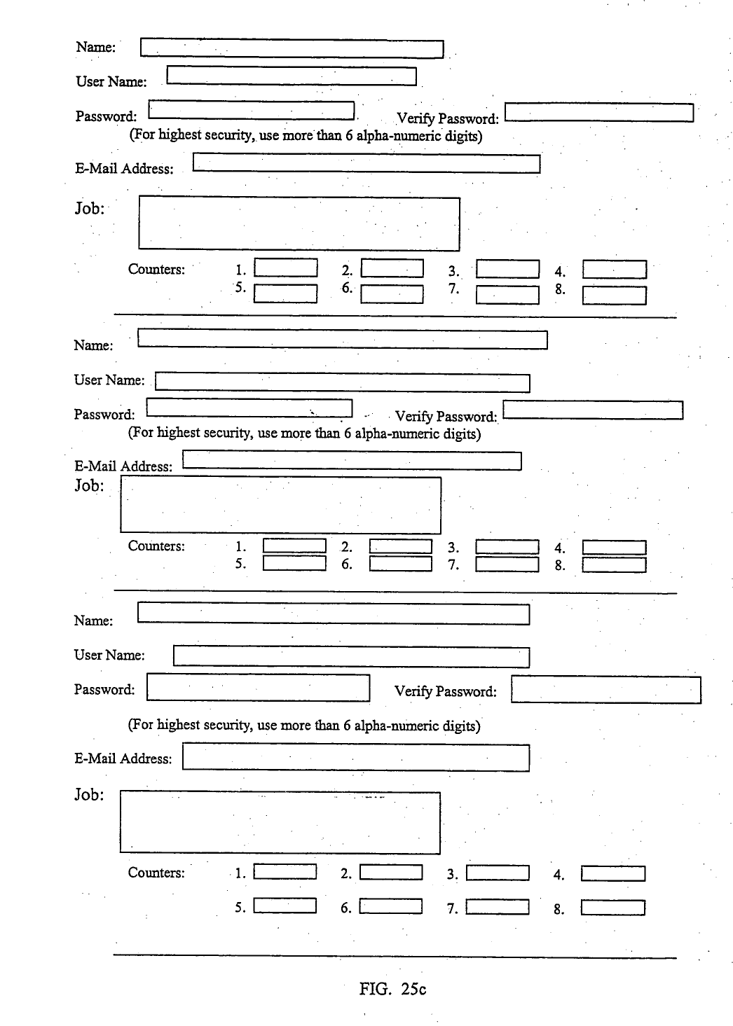

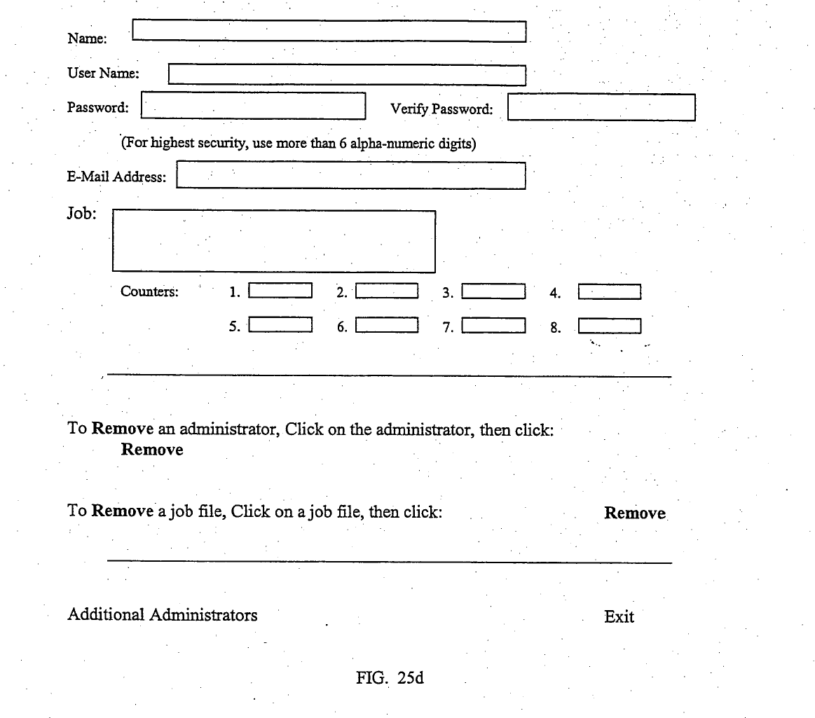

If the new member is ready to set up his management pages and job files, he/she goes to the “Management Page”. The first option is to set up administrators. By clicking on the “Set up Administrator” button, the member is sent to the set up page. Instructions describing the two types of administrators are made. When the selection to set up the First Level Administrators button is made, the administrator must re-enter his/her user name and password. If correct password and name are entered, the administrator can access the set up page. Form I, FIG. 25a allows for 3 first level administrators. If additional are needed the “Add more Administrators” button is activated and 3 more files will be opened. Suggestion to keep only a small number of first level administrators is explained on the page. Once completed, exit to Management Page or Home page.

The selection to “Set up Administrator” then “Second Level Administrator”, gets the administrator to a page to input user name and password of a first level administrator to set up the Second Level. Administrator. The correct entries get the administrator to the set up pages. The page appears with the ability to input 5 administrators with 8 possible job files per administrator. In this example, there is a maximum of 20 (or as set by the owner) administrators that can be set up. Administrators can remove a job file from an administrator without erasing the job file from the server as long as it is placed in another administrator's job file before closing out of the set up page. See Form Ia, FIGS. 25b-25d. Clicking on a job number will give a description of the job file and a counter as to how many applications for that job have been filled out and a marker if the job has a test associated with it.

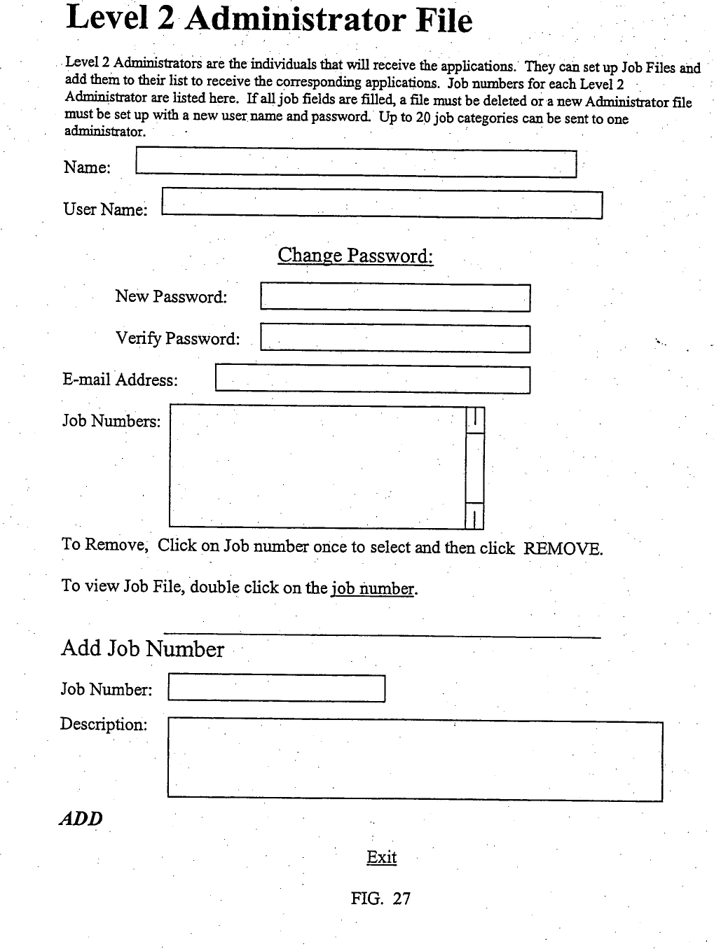

After the Second Level Administrators are set up, Job files can be set up. By clicking on the “Set Up Job File” any First Level Administrator can set up Job Files for any Second Level Administrator. Also the Second level Administrator can set up his own files. By entering a user name and password, the correct access is allowed. Second Level Administrators will get to their job file set up page. First Level Administrators will go to a page to select a Second Level Administrator to see the full file for set up and editing, or select a job file to review or edit the job file (Form J, FIG. 26a). The administrator then double clicks on the job file to get a summary of the job file including any applications not cleared by the administrator (Form Ja, FIG. 26b). The Job file for the administrator has the personal information of the administrator with password set up and the active job files listed (Form K, FIG. 27). On the bottom is the button to add a job file to the list. There must be an empty space available in order to add a job file. If not, one must be removed by clicking on the file, then clicking the remove button. Any active job file can be viewed and edited by double clicking on it. Form L, FIG. 28 shows the set up for the Job file which is accessible by double clicking on an active job file after setting it up on the Level 2 Administrator's Page. If the test button is activated, the file is placed in the test set up file. If an administrator needs to have an applicant fill out a test on the premises, copies of the test can be printed with a scoring key (on a separate page), associated with that test. This is accomplished by clicking on the Print Test button and entering a number in the box for the quantity of tests to be printed. A maximum number of tests, for example 10 tests, can be printed at one time. An identification code is placed at the top of the application and on the correct scoring key to insure that the correct key will be used to score the correct test.

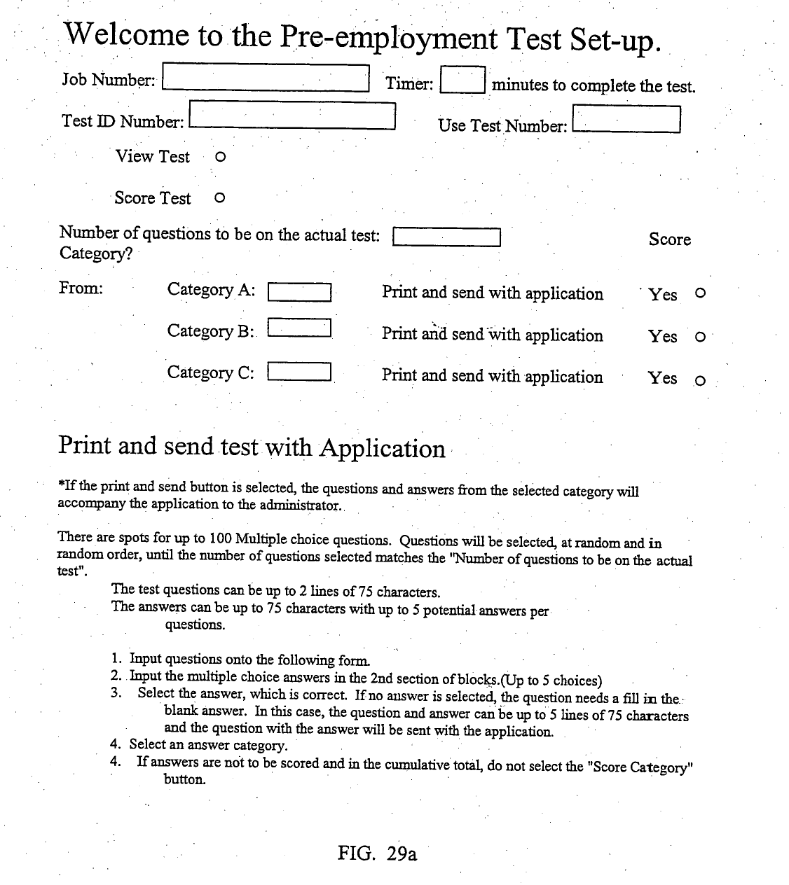

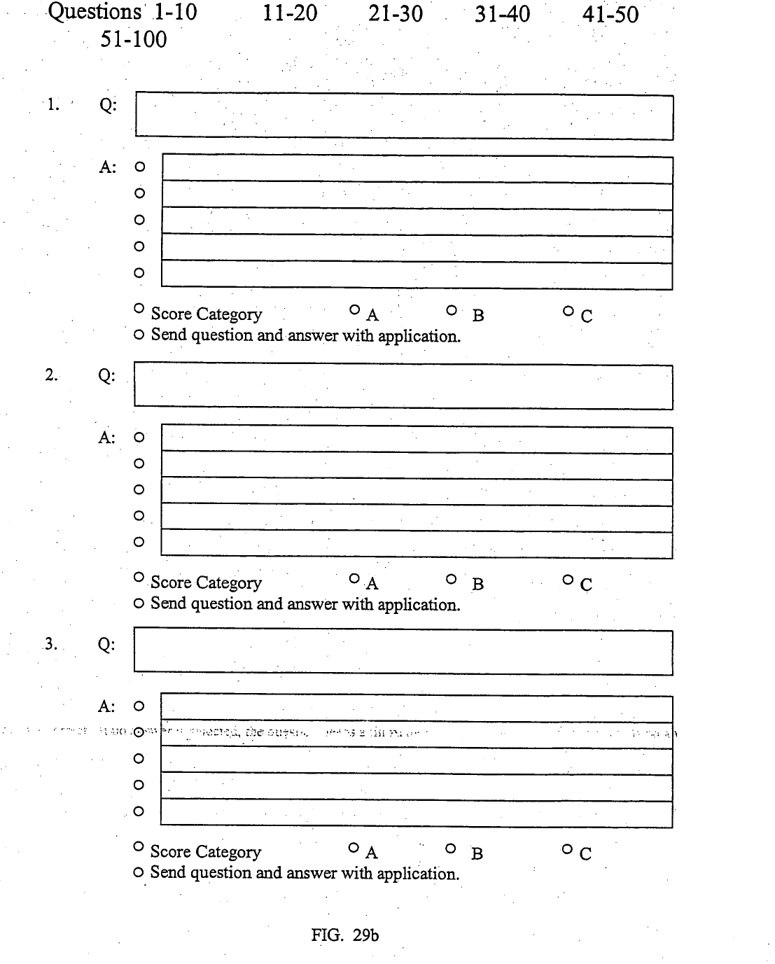

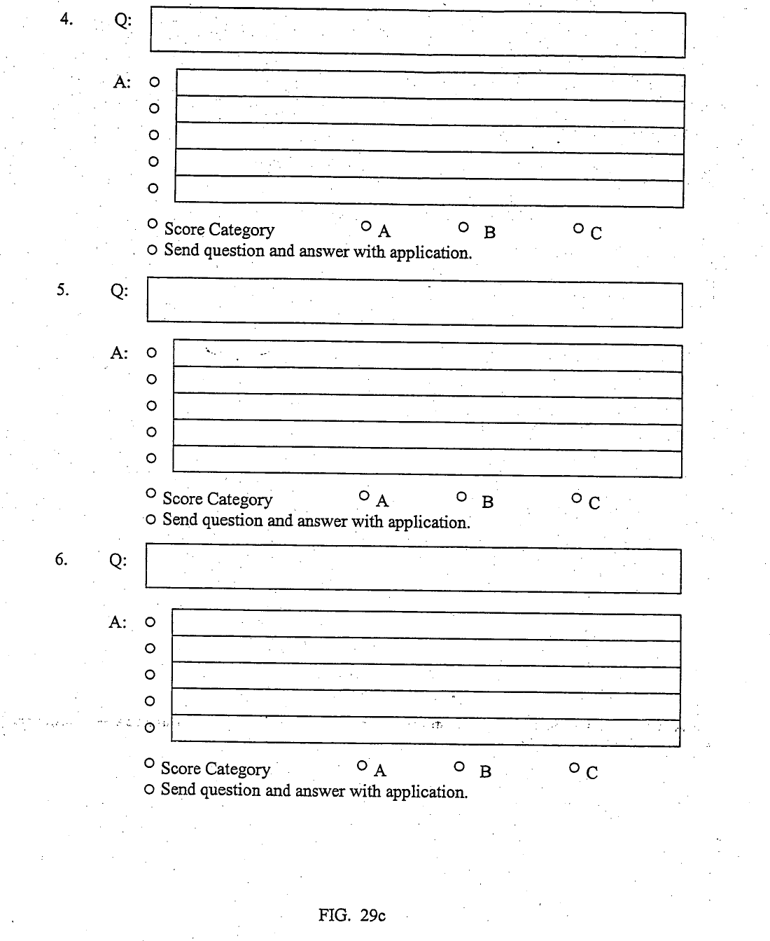

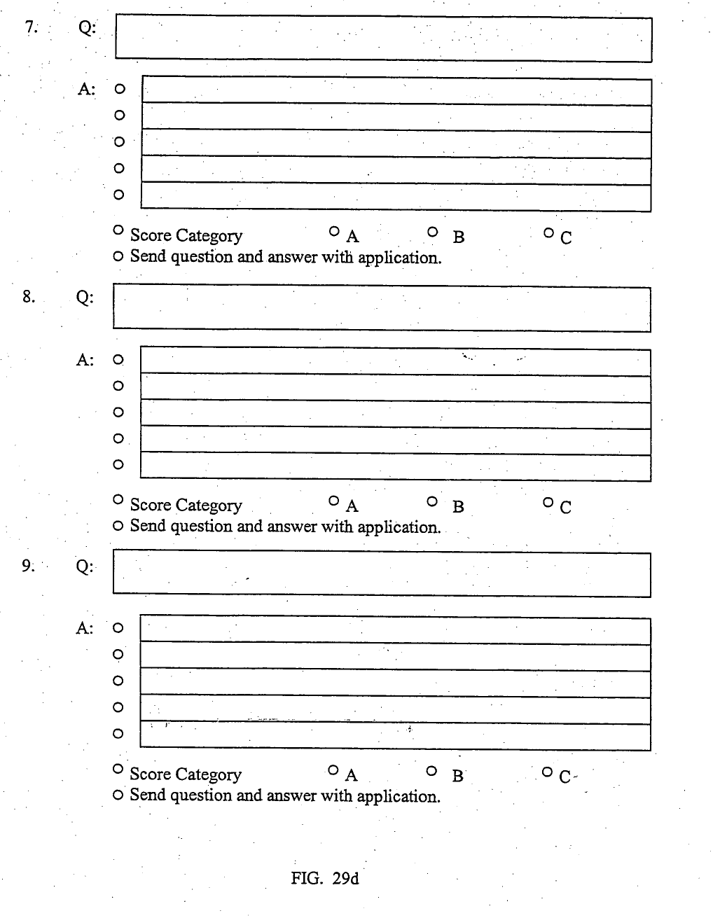

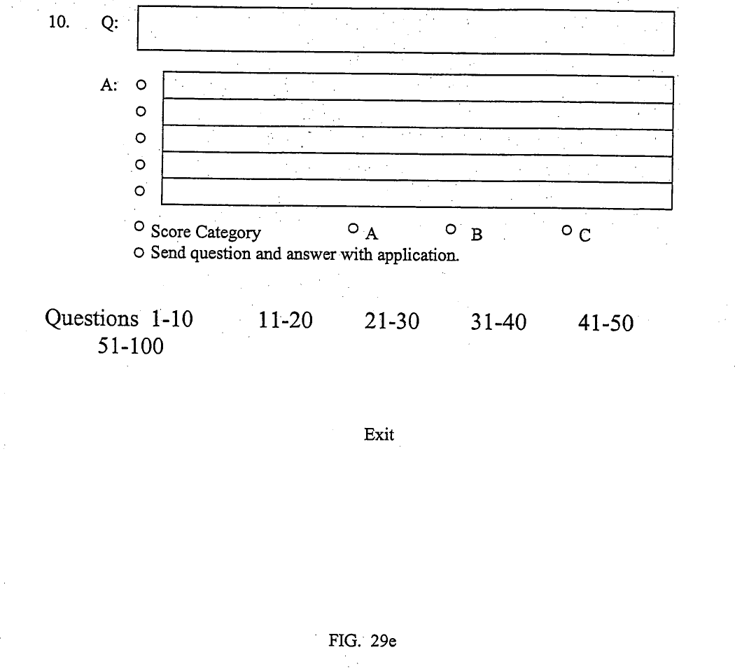

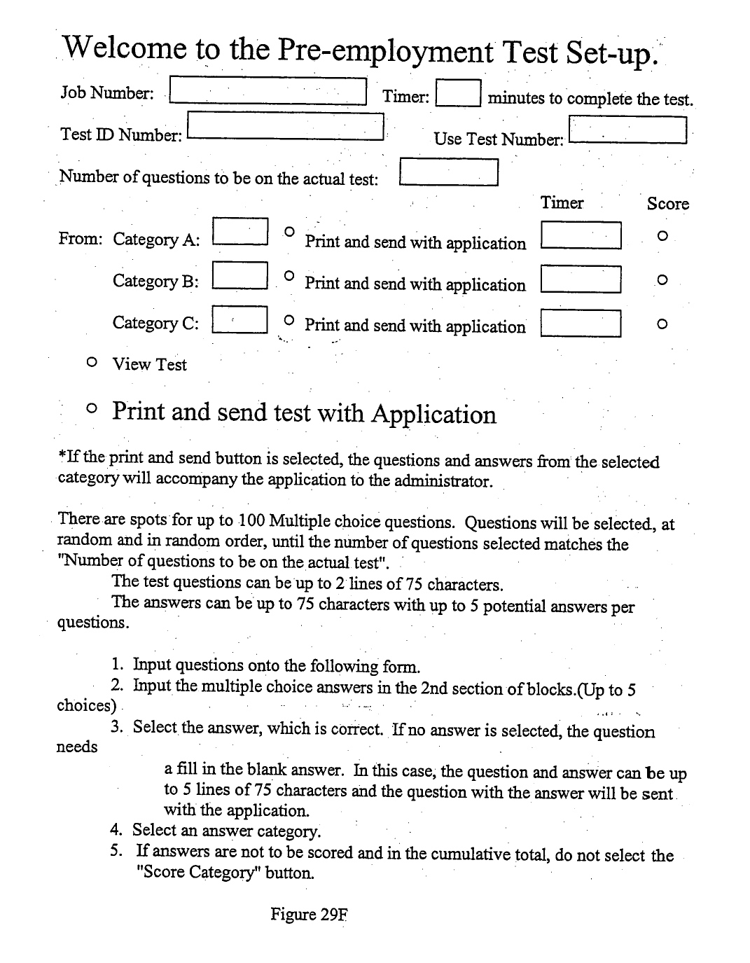

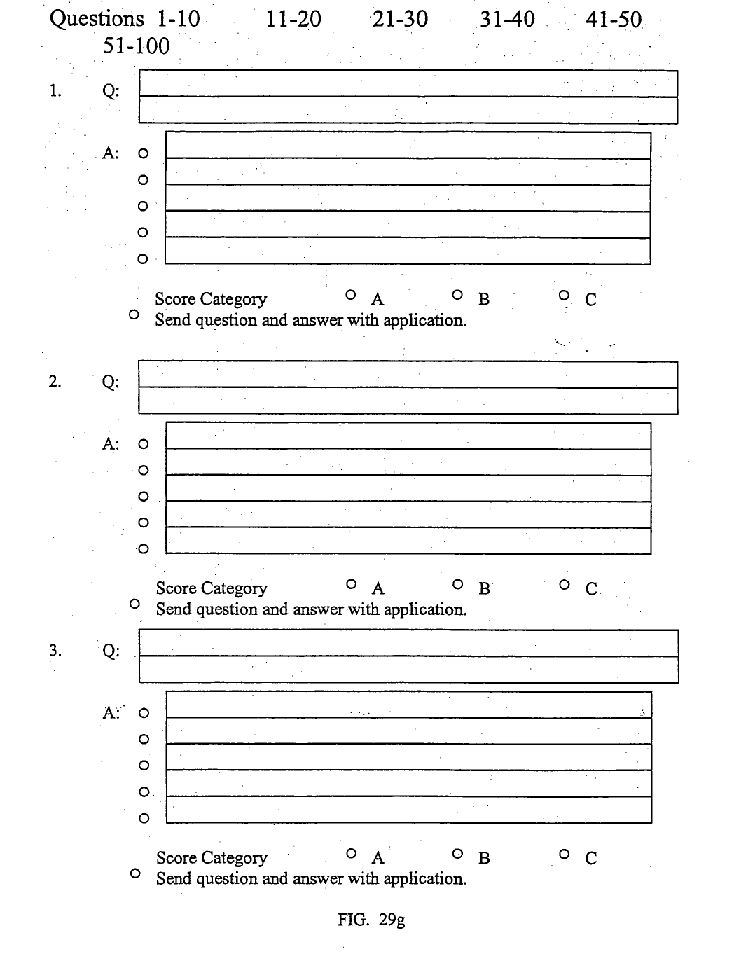

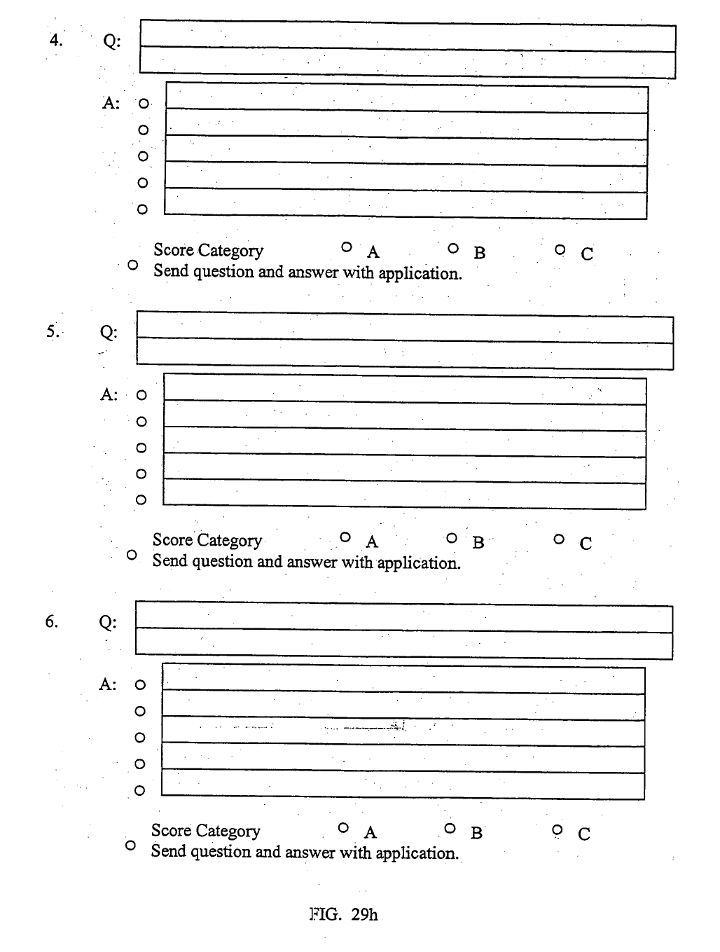

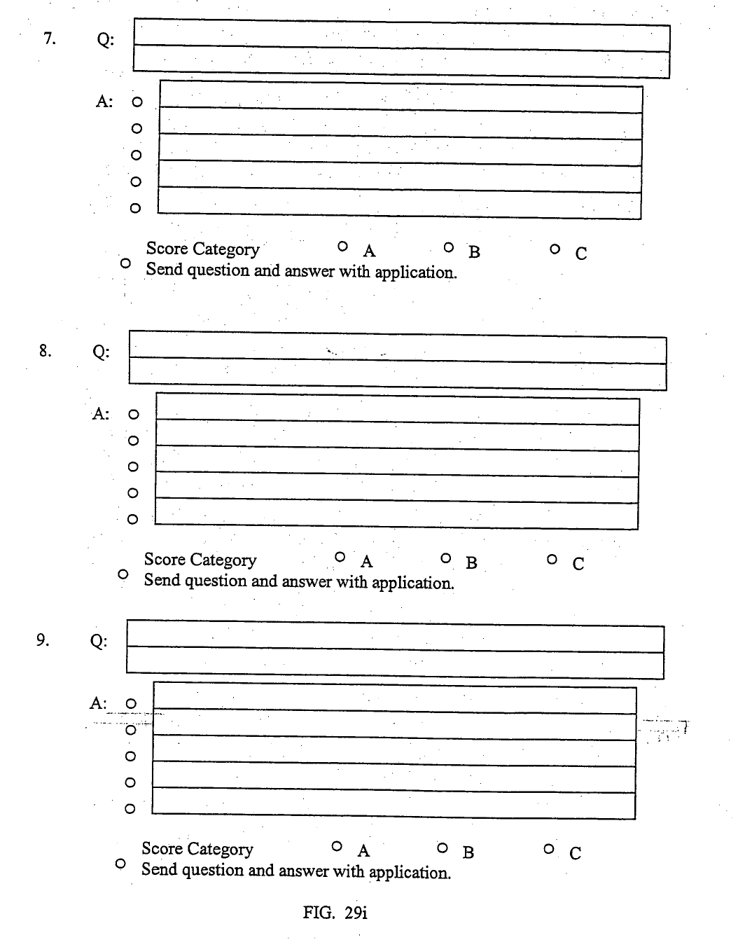

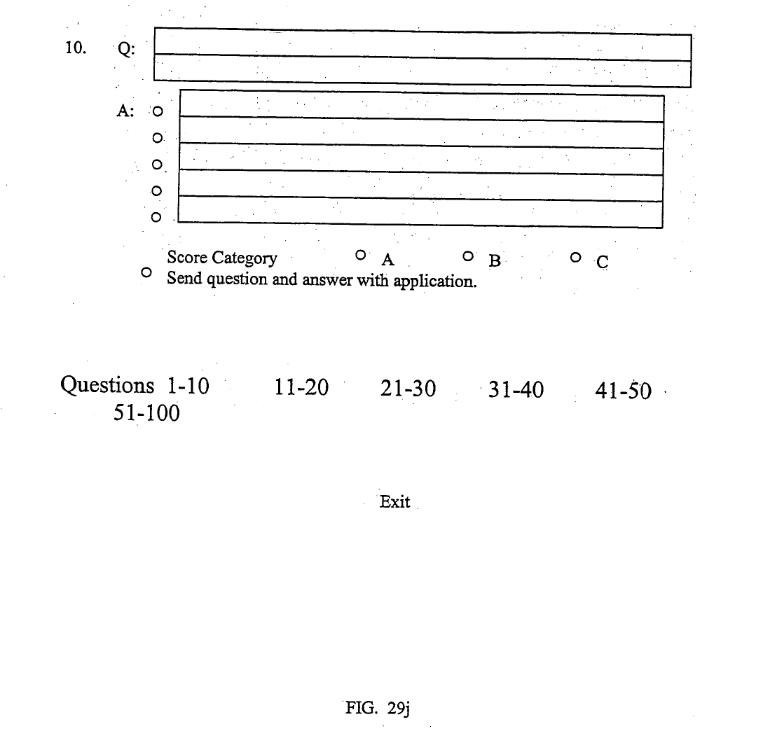

After setting up the job files, the administrator can set up the testing. From the Management File Page, the administrator clicks on “Set up Employment testing”. The job file associated with the test is entered and a test ID number is assigned. If one exists that will be used for this file also, the ID number must be entered on this form. There is an introduction and explanation of the types of questions that can be asked and scoring procedures. The total number of questions allowed in the bank is up to the owner. The question form is either set up from a form with just one question in the box or as a page with multiple questions on the page. The question form can, for example, be like Form M, FIGS. 29a-29e. The test can be set up with a timer that can be set by the administrator. After the timer counts down to zero, that test is over. The View Test button allows the employer to view and/or print all the test questions. The questions are listed by category and in the order entered on the form. The scoring of the test is done automatically when the submit button is pressed. The test score will be placed on the top of the application. If employer requests, each category can be scored separately and a total score of all categories is listed. The applications can be resorted before sending or printing with the applicants with the highest scores first. The maximum number of tests that can be printed at one time is determined by the owner, with consideration of the needs of the customer.

The test portion of the program can be made independently of this program for online testing. The timer set up will be allowed for each category of questions and the administrator of the test sets up the number of categories. The number of questions per category and the number of questions to be allowed from each category is also determined by the administrator with a maximum number of questions determined by the program owner. If a category of a test is timed separately from any other part of the test, only questions from that category are randomly picked for its time period. If a total test time is marked and a category has a time selection for it, the category time is subtracted from the total test time and the computer will select which part of the timed test will be done first, second, etc, until the total test time is used up. Any category which does not have a specific timer on it has its questions combined and randomly drawn with all other non-timer categories. See From Ma, FIGS. 29f-29j.

Test scoring is done automatically, once the “submit” or “finished” button is clicked. Options will be available to have the test scores by category shown and a total score for the test posted on the screen for viewing, written notification by regular mail, written notification by e-mail, or a combination of any options. The test can be sent completely, with the test questions and answers, to the administrator.

The test questions can be evaluated. Each time the question is used, a counter marks the number and with each correct answer, another counter is activated. The percentage of correct answers to the number of times the question appears can be retrieved by the administrator when he/she gets the list of the bank of questions for a test. The listing can be retrieved by selection of certain categories of questions or the full list in the question bank.

On the Member's Search Page, there is the option to search by job file. Any applicant who has filled out an application and used the file number can have his application found by the employer. By clicking on one of the boxes and entering the employer's number and job file number (all together), the proper applicants will be found. When posting a job number for applicants to use or searching for the applications with the job file number, the employer ID number is preferably placed in front of the job file number. The combination of the two permit the employer to be able to find the applications.

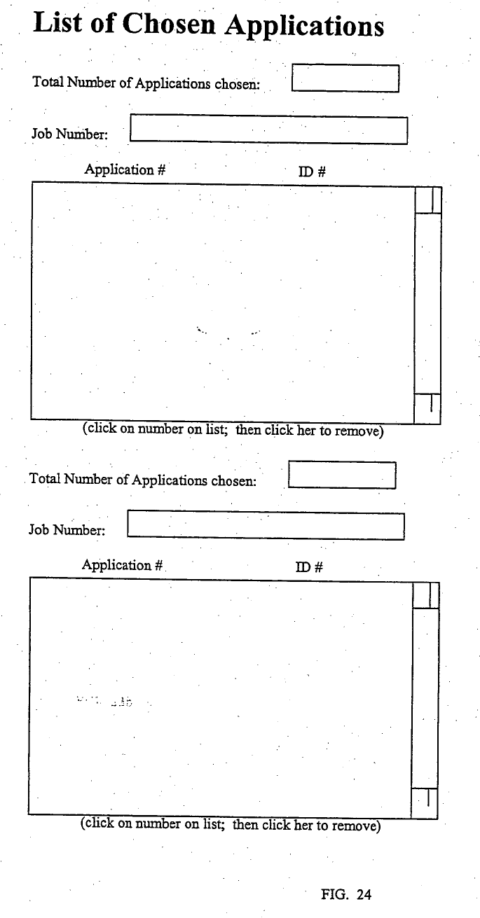

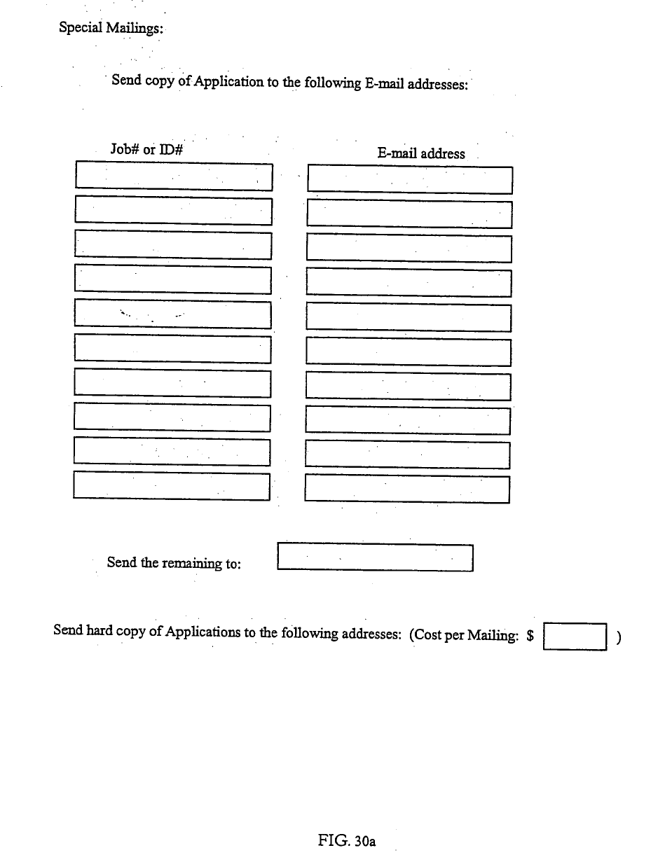

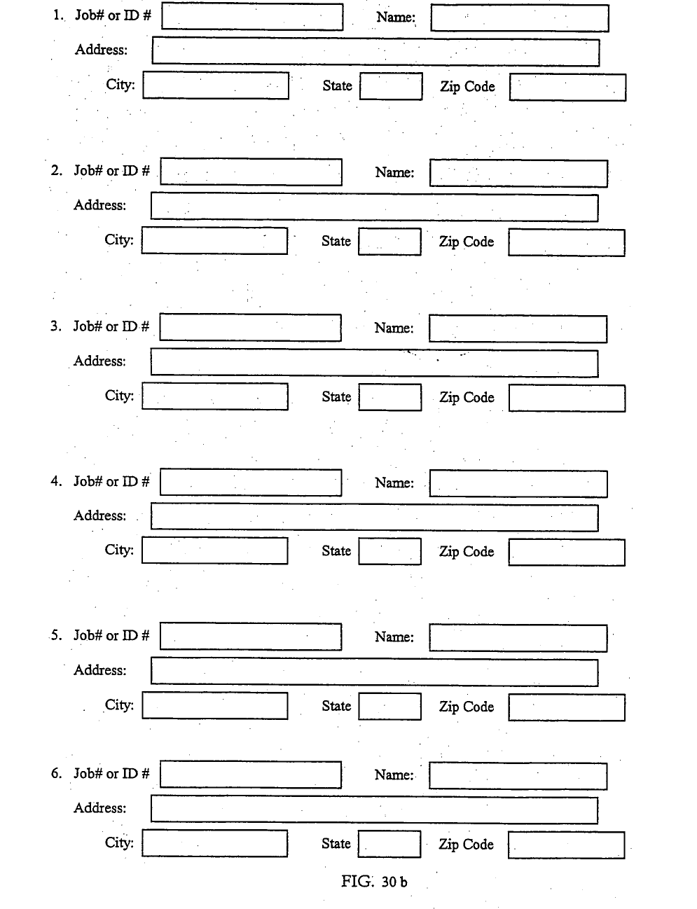

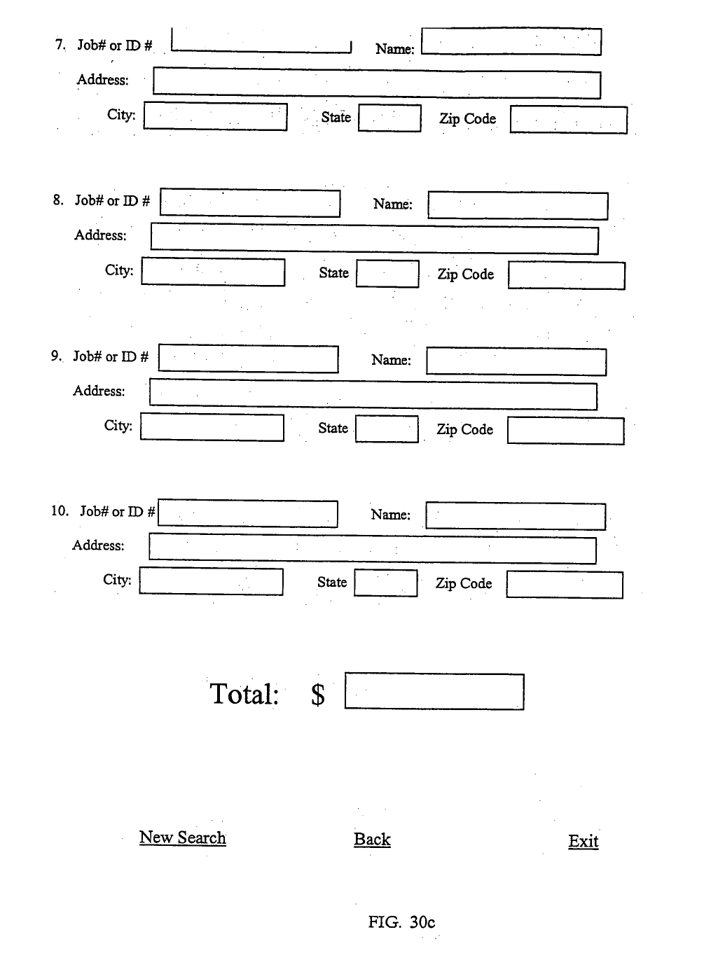

Form H, FIG. 24 is the summary form for this Job File Search. It shows a list of an application number beginning with 1 and going up. The identification number is a number assigned to the application to call it back up for printing. It will be associated with the applicant's ID number but never shown to the employer. By double clicking on an application, an abridged form of the application is shown as done in Form E, FIGS. 21a-21c. If printing a hard copy, the full application is shown or complete file can be e-mailed to designated addresses. If multiple job files were searched for, each file must be given an e-mail destination to be sent. An additional hard copy mailing service can be done (for a prepaid fee). Names and address plus the job file must be entered onto the form (Form N, FIGS. 30a-30c). Options after printing are “New Search”, “Back”, and “Exit”.

From the Employer's Search instructional page, an employer can enter the Applicant's ID number and have that application pulled out. The employer preferably must purchase the ability to print the application. This is the same fee, per application, as when an employer searches by using skills for an assortment of applications and chooses those he or she wants. The employer can also sign up to be a member.

The Owners Section:

The owner's section preferably allows the program owner/operator to do the following:
1. Create and edit the legal disclaimer.
2. Change owner's address, phone, and e-mail information.
3. Change pricing. The pricing form has a list of all pricing, including, price per application, volume pricing (field with the ability to change where the volume pricing is set as well as the price per field. Preferably up to at least 5 volume options), Membership pricing including basic fees and discounted fees for longer sign up times (preferably up to at least 5 options for membership periods and pricing), pricing for all options; such as hardcopy and mailing, picture file, etc. The ability to place price changes and date to have the changes automatically go into effect.
4. Hold and log onto specific search skills related to certain types of searches not allowed by the owner. (ex. Adult Entertainment searches, Military/Violent searches, etc.) Log will hold for review: Member employer company name, administrator's user name, the skills used in the search, the number of searches done. To qualify for this log, preferably at least 3 words or phrases from the list must be found in the Skills Search list for any search.
5. Access a log available to be sent and printed to member employers with a listing of all of their administrators, number of job files used (including those changed out), the number of applications pulled, the number of separate searches done, the number of censored searches, as described in “3” with the dates of the searches.
6. Access a list of all who signed the guest book: name, address, phone numbers, e-mail addresses.
7. Access a list of all members: name, address, phone numbers, e-mail addresses.
8. Access a list of all members, number of administrators, number of job files, number of test, number of applications selected or sent to administrators.
9. Set maximum size determinations for:
   a. Number of Level 1 administrators;
   b. Number of Level 2 administrators;
   c. Number of Job files per Level 2 administrator;
   d. Number of tests to be allowed per administrator or per company;
   e. Number of test questions allowed per category;
   f. Number of test questions allowed per test file;
   g. Number of test categories;
   h. Number of mandatory skills to be used in searches;
   i. Number of secondary skills to be used in searches;
   j. Number of job files that can be searched at one time;
   k. Number of e-mail addresses administrators can send applications to;
   l. Number of days applications can collect in job file before automatically being sent to the administrator and the file cleared of applications;
   m. Number of years to keep one-time applicants from reentering an application;
   n. Number of words allowed in phrases to describe skills or size of skills field;
   o. Number of censored searches allowed before automatic e-mail to Level 1 administrators with consequences of continuing the illegal searches;
   p. Number of months until files deleted from log for option chosen to have a hard copy and mailing of an application;
   q. Maximum number of job files per administrator;
   r. How the tests are purchased (by each test or by a block of tests); and/or
   s. Maximum number of tests that can be printed at one time.
10. Ability to change any limits set in a field. Ex. To change the experience number ranges for selection in the employer search (1-3 changes to 1-5).
11. Select the fields to be logged and saved to prevent access of one-time applicants from using the program more than once without becoming a member.
12. List all applicants:
   a. Sort by Name;
   b. Sort by Social Security Number; and/or
   c. Sort by any combination of fields.
13. E-mail:
   a. List of all types of automatic e-mail. E-mail notifications can be added easily.
   b. Click on e-mail and text of the e-mail appears for editing. Editing includes reference as when it will be sent. Ex. E-mail to be sent 30 days prior to membership expiration.
   c. When censored search violations occur, a list is forwarded to a customer service address for evaluation and personal contact with the administrator.
14. Accounting:
   a. Set up ID number range with breakdown of digits:
      i. Employer/organization Name ID;
      ii. Employer/organization location/department ID;
   b. Set up Job file ID Number: preferably is attached to employer's ID number to identify the right company to the right job and displayed in full on the job file forms.
   c. Number of Member companies
      i. Listed by pricing structure e.g., yearly membership, 5 year membership;
      ii. Contribution to Month to Date and current year's revenue;
      iii. New Members for Month to Date, current year, Last Year+Revenues involved;
      iv. Total Members for Month to Date, current year, Last Year+Revenues involved;
      v. Be able to list Month to Date, Last year's Month to Date, and previous year to that Month to Date. (3 years of information);
   d. Number of Hosting Applicants
      i. Listed by pricing structure eg. yearly membership, 5 year membership;
      ii. Contribution to Month to Date and current year's revenue;
      iii. New Applicants for Month to Date, current year, Last Year+Revenues involved;
      iv. Total Applicants for Month to Date, current year, Last Year+Revenues involve;
      v. Be able to list Month to Date, Last year's Month to Date, and previous year to that Month to Date. (3 years of information);
   e. Revenue from each optional feature chosen by applicants and employers;
   f. Number of One time Employer Usage;
   g. Number of One time Application Usage;
   h. All revenue and numbers associated with any options chosen by applicants or employers;
   i. Be able to list Month to Date, Last year's Month to Date, and previous year to that Month to Date. (3 years of information);
   j. History file to only include yearly totals in each category and the ability to make listings, which will include the selected number of years. They can be any group of years (from ______ to ______);
   k. Counters: Counters to show monthly totals and sum totals for 3 years history:
      i. Counters for Direct access organizations−Total usage number;
      ii. Counter for department usage from Direct access organizations;
      iii. Counters for total number of applicants in database;
      iv. Counter for total number of employer members in database;
      v. Counter for total number of one-time employer users;
      vi. Counter for total number of one-time applicant users;
      vii. Counter for total number of tests in database;
      viii. Counter for total number of tests taken;
      ix. Counter for total number of searches done by each employer member; include separate counter for number of censored searches;
      x. Counter for total number of job files created;
      xi. Counter for number of administrators to be sorted and tags with their employer company name. Using a separate listing for each level of administrator;
      xii. Counter for the number of each option for either applicant or employer;
      xiii. Counter on the hard copy printing and mailing by job and by number of applications sent out by mail;
      xiv. Counters to evaluate test questions. Questions are evaluated to see how many applicants get the question correct.
15. Activity File:
   a. Log with list of activity file numbers and administrator information for application files that did not print.
   b. Clicking on the activity file number will give listing of the applicants ID numbers which were suppose to print.
   c. A way to resend the file
16. Application File:
   a. Log with list of application file that did not print.
   b. Clicking on the application file number will give the application file number and applicant's contact information for the application that did not print.
   c. A way to resend the file
17. Test Questions:
   a. Need to be able to get a listing of all tests for any employer;
   b. Need to be able to print any test for any or all tests for an employer or all tests, including scoring key (all questions in all categories);
   c. Need to be able to print a listing of all questions with the evaluation of each question as to the percentage of correct answers by the applicants;
   d. Employer needs to be able to print out copies of the tests with an answer key to be taken by applicants and administered and scored manually. (Identification number needs to be on both the test and answer key to insure the correct scoring).

A log and a file to hold applications chosen with the Hard Copy print and Mail option. File to be kept for a selected number of months before automatic deletion from the file.

Advantages of the system and method of certain example embodiments of the invention include:
1) Search features include the use of mandatory and secondary skills to sort out the best candidates for a job. The applicants with the most mandatory skills matching the search will be arranged at the beginning of the search results, followed by the effect of the secondary skills.
2) This program allows for employers to examine applications before purchasing.
3) Ability to test search features prior to registrations.
4) This program shows the applications from the search results in an abridged format for the selection process. No identifying personal information about the applicant or previous employer, identification information is shown until the application is selected for consideration. Educational information and work experience information, without personal information or employer's names, addresses, and phone numbers are included.
5) This program allows hosting applicants to voluntarily participate in specially directed, discrimination searches or have employees and any specified applicants directed to participate by a legally authorized agency. In cases, where companies are not in compliance with EEOC or ADA guidelines, the authorized agency can direct a company to have their employees fill out applications with special fields dealing with discriminating factors to be used to find applicants to correct the situation. Although these fields are used in the search, the search results will not show these factors. The abridged format will insure that discriminating factors within the search will not taint the selection process.
6) Hosting applicants can decide to have or not to have their applications available for searches.
7) Hosting applicants can decide to have a picture file included with their application.
8) Employers can purchase this service for their employees. In this case, the employer can limit the ability of the application to be used for in-house searches or promotion evaluations only.
9) Employers can set up administrators with multiple job files to access applications for more than one job. The amount of files can be determined by the owner.
10) One-time users of the Application Program will have specified information reserved on file for a period of 2 years. Upon a second request for the service, an automatic request to host the application will appear and the applicant must pay for hosting for a year to gain access.
11) Hosting applicants can update their application at anytime.
12) Non-hosting applicants will be able to use the program if directed and linked to the program by an employer member.
13) Hosting applicants need to only input their identification number to have their application inputted onto the form from an employer member request to fill out an application, and then take any test or answer specified questions. The hosting applicant then answers any questions and submits the application and test.
14) Applicants can access a directory of all job files, and hosting applicants can forward their application to any employer by entering their own ID number into the form and submitting their application.
15) Employers can set up testing for pre-employment testing or for a promotion evaluation, including position promotions, performance evaluation, and/or continuing education. This Feature can also be used and set up independently for testing purposes in other industries.
   a. Employer administrators can set up question banks for testing.
   b. Multiple tests can be created and associated with different job files.
   c. The same test can be associated with different job files.
   d. Multiple categories can be set up for specific evaluation functions.
   e. The number of questions from each category is entered.
   f. Answers to questions are set up with the correct answer marked.
   g. Questions without answers require text type answers and are automatically sent with the application upon test completion. These questions are not counted in any scoring.
   h. Questions can be designated as mandatory and appear on all tests.
   i. Any question can be selected to accompany the application to the administrator. The whole test may also be chosen.
   j. The category banks of questions can have more questions than required on the test. Random selection of questions from each category is done to create a test for each applicant until the number of questions required from each category is reached with the inclusion of all mandatory questions. The randomly selected questions appear on the test in random order.
   k. Automatic scoring of the qualifying questions are done once the test is completed and submitted. The scores are posted on the application and sent to the directed administrator. Scoring shows the number of correct answers and a percentage correct for the category and an additional score showing an overall score for all questions included in the test. An option can be selected to allow test participant to see his or her score.
l. The test questions can be evaluated. Each time the question is used, a counter marks the number and with each correct answer, another counter is activated. The percentage of correct answers to the number of times the question appears can be retrieved by the administrator when he/she gets the list of the bank of questions for a test. The listing can be retrieved by selection of certain categories of questions or the full list in the question bank.
m. Timing feature option for employers to determine if a time limit should be set on any test.
n. Option will be included to allow opportunity to set time limits on categories. If this option is selected. The category questions will happen one category after another. Only the questions inside each category will be randomly selected for each test. The additional random selection between categories will not be possible with this option.
   Of course, a particular embodiment of the invention may or may not provide every listed advantage or any one particular advantage.

Testing administrators may option to have a test printed for manual or individual administration. In this case, an answer key will be printed, on a separate page, with the test. An identification number will be on both the test and answer key to insure that the correct answers are used to score the test.

Further embodiments of the invention include one or more computers and/or networks of computers programmed to carry out the system and method described herein, software for implementing the system and method described herein on a general purpose or other computer, and computer readable media comprising software for implementing the system and method described herein.

While the invention has been described with reference to preferred and example embodiments, it will be understood by those skilled in the art that a number of modifications, additions and deletions are within the scope of the invention, as defined by the following claims.

1. A method of matching an applicant to a job opening, said method comprising:
receiving information from an employer regarding a job opening, said information including identification of mandatory skills and secondary skills relevant to said job opening, and a numerical weighting of each mandatory skill and each secondary skill identified;
receiving data from an applicant including applicant qualifications;
comparing the mandatory and secondary skills relevant to said job opening with the applicant qualifications to determine a correlation therebetween; and
ranking the applicant based on the correlation of the mandatory and secondary skills with the applicant qualifications, said ranking being based on the numerical weighting of each mandatory skill and each secondary skill matched by an applicant qualification.

2. The method of claim 1, wherein the numerical weighting of each mandatory skill is between a mandatory skill minimum weighting and a mandatory skill maximum weighting, and wherein the numerical weighting of each secondary skill is between a secondary skill minimum weighting and a secondary skill maximum weighting, and wherein the mandatory skill minimum weighting is greater than the secondary skill maximum weighting.

3. The method of claim 2, wherein the mandatory skill minimum weighting is at least twice the secondary skill maximum weighting.

4. The method of claim 1, further comprising providing the employer access to a portion of the data from the applicant at no charge, said portion of the data not including identifying data of the applicant, and providing the employer access to identifying data of the applicant for a fee.

5. The method of claim 1, further comprising giving the applicant the option to become a hosting applicant, wherein only hosting applicants are permitted to update their data that is compared to the mandatory and secondary skills relevant to the job opening.

6. The method of claim 1, further comprising allowing an employer to conduct an internal application process, wherein current employees of said employer input data for comparison to the mandatory and secondary skills relevant to said job opening.

7. The method of claim 1, further comprising collecting at least one discriminating factor from the applicant and considering said at least one discriminating factor in ranking the applicant.

8. A website for implementing the method of claim 1.

9. Computer software for implementing the method of claim 1.

10. Computer readable media comprising the software of claim 9.

11. A system for matching an applicant for employment with an employer, said system comprising:
a first computer for receiving input from the applicant regarding at least one applicant qualification;
a second computer for comparing the at least one applicant qualification with at least one mandatory skill and at least one secondary skill identified by the employer, and ranking the applicant based on a correlation of the at least one applicant qualification with the at least one mandatory skill and the at least one secondary skill; and
a communication linkage for exchanging information between the first and second computers.

12. The system of claim 11, wherein the step of ranking the applicant includes weighting the at least one mandatory skill and the at least one secondary skill with a numerical weighting factor.

13. The system of claim 12, wherein the numerical weighting factor of each mandatory skill is between a mandatory skill minimum weighting factor and a mandatory skill maximum weighting factor, and wherein the numerical weighting factor of each secondary skill is between a secondary skill minimum weighting factor and a secondary skill maximum weighting factor, and wherein the mandatory skill minimum weighting factor is greater than the secondary skill maximum weighting factor.

14. The method of claim 13, wherein the mandatory skill minimum weighting factor is at least twice the secondary skill maximum weighting factor.

15. A computer storage medium storing computer readable code embodied therein for matching an applicant for employment with an employer, comprising code for comparing at least one applicant qualification with at least one mandatory skill identified by the employer and at least one secondary skill identified by the employer, and code for ranking the applicant based on a correlation of the at least one applicant qualification with the at least one mandatory skill and the at least one secondary skill.

16. The computer storage medium of claim 15, wherein the code for ranking the applicant includes code for weighting the at least one mandatory skill and the at least one secondary skill with a numerical weighting factor.

17. The computer storage medium of claim 16, wherein the numerical weighting factor of each mandatory skill is between a mandatory skill minimum weighting factor and a mandatory skill maximum weighting factor, and wherein the numerical weighting factor of each secondary skill is between a secondary skill minimum weighting factor and a secondary skill maximum weighting factor, and wherein the mandatory skill minimum weighting factor is greater than the secondary skill maximum weighting factor.

18. The computer storage medium of claim 17, wherein the mandatory skill minimum weighting factor is at least twice the secondary skill maximum weighting factor.
